(19) United States
(12) Patent Application Publication
(10) Pub. No.: US 2014/0004413 A1
(43) Pub. Date: Jan. 2, 2014

(54) ELECROLYTIC SOLUTION, SECONDARY BATTERY, BATTERY PACK, ELECTRIC VEHICLE, ELECTRIC POWER STORAGE SYSTEM, ELECTRIC POWER TOOL, AND ELECTRONIC APPARATUS

(71) Applicant: Sony Corporation, Tokyo (JP)

(72) Inventors: Masayuki Ihara, Fukushima (JP); Tadahiko Kubota, Kanagawa (JP)

(21) Appl. No.: 13/910,783

(22) Filed: Jun. 5, 2013

(30) Foreign Application Priority Data
Jun. 28, 2012 (JP) 2012-145773

(51) Int. Cl. H01M 10/0564; H01M 10/0525

(52) U.S. Cl. CPC H01M 10/0564; H01M 10/0525
USPC 429/200; 429/188; 429/199

(57) ABSTRACT

A secondary battery includes: a cathode; an anode; and an electrolytic solution, wherein the electrolytic solution includes an unsaturated cyclic carbamate compound represented by a following Formula (1),

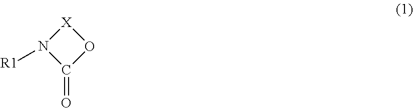

where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

### CROSS REFERENCES TO RELATED APPLICATIONS

The present application claims priority to Japanese Priority Patent Application JP 2012-145773 filed in the Japan Patent Office on Jun. 28, 2012, the entire content of which is hereby incorporated by reference.

### BACKGROUND

The present application relates to an electrolytic solution, to a secondary battery using the electrolytic solution, and to a battery pack, an electric vehicle, an electric power storage system, an electric power tool, and an electronic apparatus that use the secondary battery.

In recent years, various electronic apparatuses such as a mobile phone and a personal digital assistant (PDA) have been widely used, and it has been demanded to further reduce the size and the weight of the electronic apparatuses and to achieve their long life. Accordingly, as an electric power source for the electronic apparatuses, a battery, in particular, a small and light-weight secondary battery capable of providing high energy density has been developed. In these days, it has been considered to apply such a secondary battery to various other applications in addition to the foregoing electronic apparatuses. Representative examples of such other applications may include a battery pack attachably and detachably mounted on the electronic apparatuses or the like, an electric vehicle such as an electric automobile, an electric power storage system such as a home electric power server, and an electric power tool such as an electric drill.

Secondary batteries utilizing various charge and discharge principles to obtain a battery capacity have been proposed. In particular, a secondary battery utilizing insertion and extraction of an electrode reactant, a secondary battery utilizing precipitation and dissolution of an electrode reactant, and the like have attracted attention, since these secondary batteries provide higher energy density than lead batteries, nickel-cadmium batteries, and the like.

The secondary battery includes a cathode, an anode, and an electrolytic solution. The electrolytic solution contains a non-aqueous solvent and an electrolyte salt. The electrolytic solution functioning as a medium of a charge and discharge reaction largely affects performance of the secondary battery. Therefore, studies have been made on adding various additives to the electrolytic solution to improve battery characteristics.

Specifically, in order to obtain superior battery charge and discharge characteristic and/or the like, a cyclic carbamate compound has been used (for example, see Japanese Unexamined Patent Application Publication Nos. 2003-077536 and 2003-187866). Examples of the cyclic carbamate compound may include 3-methyl-2-oxazolidone and 3-ethyl-2-oxazolidone and so on.

### SUMMARY

In recent years, high performance and multi-functions of the electronic apparatuses and the like to which the secondary battery is applied are increasingly developed. Frequency in use of the electronic apparatuses and the like is increased as well. Therefore, further improvement of the battery characteristics of the secondary battery has been desired.

It is desirable to provide an electrolytic solution, a secondary battery, a battery pack, an electric vehicle, an electric power storage system, an electric power tool, and an electronic apparatus that are capable of obtaining superior battery characteristics.

According to an embodiment of the present application, there is provided an electrolytic solution including an unsaturated cyclic carbamate compound represented by a following Formula (1),

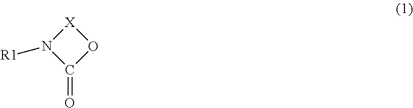

where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

According to an embodiment of the present application, there is provided a secondary battery including: a cathode; an anode; and an electrolytic solution, wherein the electrolytic solution includes an unsaturated cyclic carbamate compound represented by a following Formula (1),

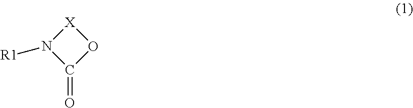

where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

According to an embodiment of the present application, there is provided a battery pack including: a secondary battery; a control section controlling a used state of the secondary battery; and a switch section switching the used state of the secondary battery according to an instruction of the control section, wherein the secondary battery includes a cathode, an anode, and an electrolytic solution, and the electrolytic solution includes an unsaturated cyclic carbamate compound represented by a following Formula (1),

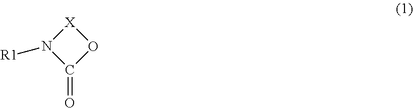

where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

According to an embodiment of the present application, there is provided an electric vehicle including: a secondary battery; a conversion section converting electric power supplied from the secondary battery into drive power; a drive section operating according to the drive power; and a control section controlling a used state of the secondary battery, wherein the secondary battery includes a cathode, an anode, and an electrolytic solution, and the electrolytic solution includes an unsaturated cyclic carbamate compound represented by a following Formula (1),

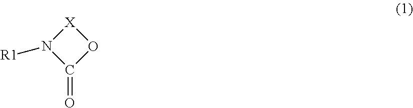

where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

According to an embodiment of the present application, there is provided an electric power storage system including: a secondary battery; one or more electric devices supplied with electric power from the secondary battery; and a control section controlling the supplying of the electric power from the secondary battery to the one or more electric devices, wherein the secondary battery includes a cathode, an anode, and an electrolytic solution, and the electrolytic solution includes an unsaturated cyclic carbamate compound represented by a following Formula (1),

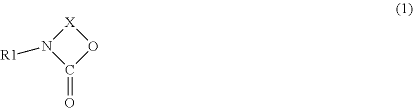

where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

According to an embodiment of the present application, there is provided an electric power tool including: a secondary battery; and a movable section being supplied with electric power from the secondary battery, wherein the secondary battery includes a cathode, an anode, and an electrolytic solution, and the electrolytic solution includes an unsaturated cyclic carbamate compound represented by a following Formula (1),

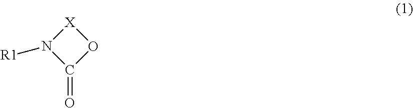

where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

According to an embodiment of the present application, there is provided an electronic apparatus including a secondary battery as an electric power supply source, wherein the secondary battery includes a cathode, an anode, and an electrolytic solution, and the electrolytic solution includes an unsaturated cyclic carbamate compound represented by a following Formula (1),

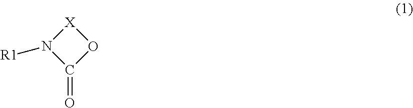

where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

As is clear from Formula (1), the foregoing term “unsaturated cyclic carbamate compound” refers to a cyclic compound having a carbamate bond (>N—C(═O)—O—) and one or more unsaturated bonds (>C═C< as carbon-carbon double bonds).

The foregoing term “halogenated group thereof” refers to a group obtained by substituting each of part or all of hydrogen groups out of the monovalent hydrocarbon group and the monovalent oxygen-containing hydrocarbon group by a halogen group. Further, the foregoing term “monovalent group obtained by bonding two or more thereof to one another” refers to a group obtained by bonding two or more of a monovalent hydrocarbon group, a monovalent oxygen-containing hydrocarbon group, and a halogenated group thereof to one another so that the valency becomes monovalent as a whole.

According to the electrolytic solution and the secondary battery according to the embodiments of the present application, the electrolytic solution contains the foregoing unsaturated cyclic carbamate compound. Therefore, superior battery characteristics are obtainable. Further, according to the battery pack, the electric vehicle, the electric power storage system, the electric power tool, and the electronic apparatus according to the embodiments of the present application, similar effects are obtainable.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional view illustrating a configuration of a secondary battery (cylindrical type) including an electrolytic solution according to an embodiment of the present application.

FIG. 2 is a cross-sectional view illustrating an enlarged part of a spirally wound electrode body illustrated in FIG. 1.

FIG. 3 is a perspective view illustrating a configuration of another secondary battery (laminated film type) including the electrolytic solution according to the embodiment of the present application.

FIG. 4 is a cross-sectional view taken along a line IV-IV of a spirally wound electrode body illustrated in FIG. 3.

FIG. 5 is a block diagram illustrating a configuration of an application example (battery pack) of the secondary battery.

FIG. 6 is a block diagram illustrating a configuration of an application example (electric vehicle) of the secondary battery.

FIG. 7 is a block diagram illustrating a configuration of an application example (electric power storage system) of the secondary battery.

FIG. 8 is a block diagram illustrating a configuration of an application example (electric power tool) of the secondary battery.

FIG. 9 is a diagram illustrating an analytical result of SnCoC by XPS.

### DETAILED DESCRIPTION

An embodiment of the present application will be described below in detail with reference to the drawings. The description will be given in the following order.

1. Electrolytic solution and Secondary battery

1-1. Lithium Ion Secondary Battery (Cylindrical Type)

1-2. Lithium Ion Secondary Battery (Laminated Film Type)

1-3. Lithium Metal Secondary Battery (Cylindrical Type and Laminated Film Type)

2. Applications of Secondary battery

2-1. Battery Pack

2-2. Electric Vehicle

2-3. Electric Power Storage System

2-4. Electric Power Tool

[1. Electrolytic Solution and Secondary Battery]

[1-1. Lithium Ion Secondary Battery (Cylindrical Type)]

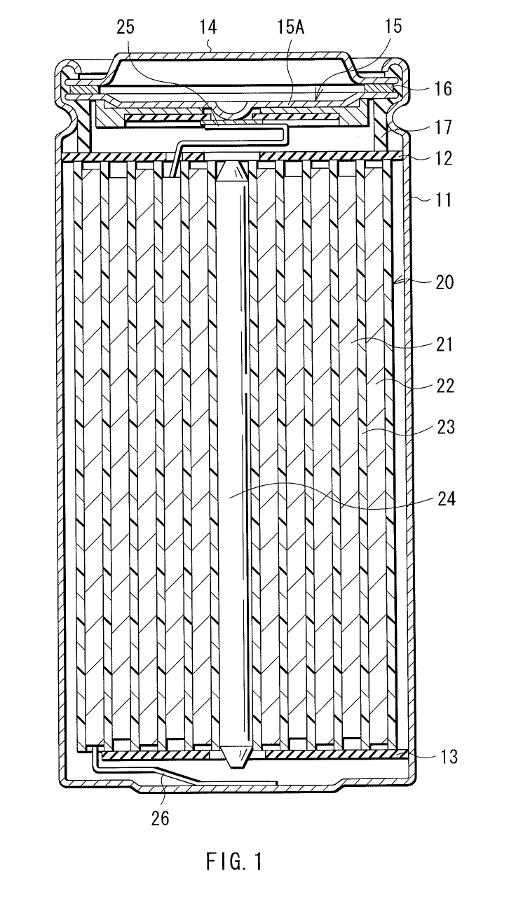

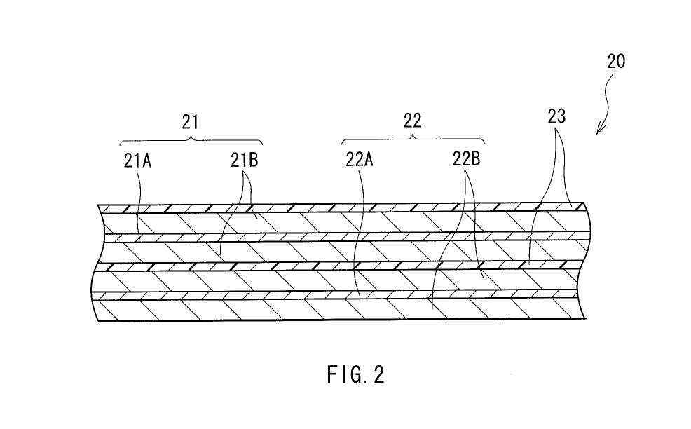

FIG. 1 and FIG. 2 illustrate cross-sectional configurations of a secondary battery (simply referred to as “secondary battery” below as well) using an electrolytic solution according to an embodiment of the present application (simply referred to as “electrolytic solution” below as well). FIG. 2 illustrates enlarged part of a spirally wound electrode body 20 illustrated in FIG. 1.

[Whole Configuration of Secondary Battery]

The secondary battery described here is a lithium secondary battery (lithium ion secondary battery) in which the capacity of an anode 22 is obtained by insertion and extraction of Li as an electrode reactant, and is a so-called cylindrical-type secondary battery.

The secondary battery may contain, for example. the spirally wound electrode body 20 and a pair of insulating plates 12 and 13 inside a battery can 11 in the shape of a hollow cylinder. The spirally wound electrode body 20 may be formed by, for example, laminating a cathode 21 and the anode 22 with a separator 23 in between, and subsequently spirally winding the resultant laminated body.

The battery can 11 may have, for example, a hollow structure in which one end of the battery can 11 is closed and the other end of the battery can 11 is opened. The battery can 11 may be made of iron, aluminum, an alloy thereof, or the like. The surface of the battery can 11 may be plated with nickel or the like. The pair of insulating plates 12 and 13 is arranged to sandwich the spirally wound electrode body 20 in between, and to extend perpendicularly to the spirally wound periphery surface of the spirally wound electrode body 20.

At the open end of the battery can 11, a battery cover 14, a safety valve mechanism 15, and a positive temperature coefficient device (PTC device) 16 are attached by being swaged with a gasket 17. Thereby, the battery can 11 is hermetically sealed. The battery cover 14 may be made of, for example, a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating, or the like, a disk plate 15A inverts to cut electric connection between the battery cover 14 and the spirally wound electrode body 20. The PTC device 16 prevents abnormal heat generation resulting from a large current. As temperature rises, resistance of the PTC device 16 is increased accordingly. The gasket 17 may be made of, for example, an insulating material. The surface of the gasket 17 may be coated with asphalt.

In the center of the spirally wound electrode body 20, a center pin 24 is inserted. However, the center pin 24 is not necessarily included therein. For example, a cathode lead 25 made of a conductive material such as aluminum may be connected to the cathode 21. For example, an anode lead 26 made of a conductive material such as nickel may be connected to the anode 22. For example, the cathode lead 25 may be welded to the safety valve mechanism 15, and may be electrically connected to the battery cover 14. For example, the anode lead 26 may be welded to the battery can 11, and may be electrically connected to the battery can 11 thereby.

[Cathode]

The cathode 21 has a cathode active material layer 21B on a single surface or both surfaces of a cathode current collector 21A. The cathode current collector 21A may be made of, for example, a conductive material such as aluminum, nickel, and stainless steel.

The cathode active material layer 21B contains, as cathode active materials, one or more of cathode materials capable of inserting and extracting lithium ions. The cathode active material layer 21B may further contain other materials such as a cathode binder and a cathode electric conductor as necessary.

The cathode material may be preferably a lithium-containing compound, since high energy density is thereby obtained. Examples of the lithium-containing compound may include a lithium-transition-metal composite oxide and a lithium-transition-metal-phosphate compound. The lithium-transition-metal composite oxide is an oxide containing Li and one or more transition metal elements as constituent elements. The lithium-transition-metal-phosphate compound is a phosphate compound containing Li and one or more transition metal elements as constituent elements. In particular, it is preferable that the transition metal element be one or more of Co, Ni, Mn, Fe, and the like, since a higher voltage is obtained thereby. The chemical formula thereof may be expressed by, for example, LiₓM1O₂ or Li_{y}M2PO₄. In the formulas, M1 and M2 represent one or more transition metal elements. Values of x and y vary according to the charge and discharge state, and are generally in the range of 0.05≦x≦1.10 and 0.05≦y≦1.10.

Examples of the lithium-transition-metal composite oxide may include LiCoO₂, LiNiO₂, and a lithium-nickel-based composite oxide represented by the following Formula (20). Examples of the lithium-transition-metal-phosphate compound may include LiFePO₄ and LiFe₁₋ᵤMnᵤPO₄ (u<1), since thereby, a high battery capacity is obtained and superior cycle characteristics and the like are obtained.

LiNi_{1-z}M_{z}O₂ (20)

In Formula (20), M is one or more of Co, Mn, Fe, Al, V, Sn, Mg, Ti, Sr, Ca, Zr, Mo, Tc, Ru, Ta, W, Re, Yb, Cu, Zn, Ba, B, Cr, Si, Ga, P, Sb, and Nb. z satisfies 0.005<z<0.5.

In addition thereto, the cathode material may be, for example, an oxide, a disulfide, a chalcogenide, a conductive polymer, or the like. Examples of the oxide may include titanium oxide, vanadium oxide, and manganese dioxide. Examples of the disulfide may include titanium disulfide and molybdenum sulfide. Examples of the chalcogenide may include niobium selenide. Examples of the conductive polymer may include sulfur, polyaniline, and polythiophene. However, the cathode material is not limited to one of the foregoing materials, and may be other material.

Examples of the cathode binder may include one or more of synthetic rubbers, polymer materials, and the like. Examples of the synthetic rubber may include a styrene-butadiene-based rubber, a fluorine-based rubber, and ethylene propylene diene. Examples of the polymer material may include polyvinylidene fluoride and polyimide.

Examples of the cathode electric conductor may include one or more of carbon materials and the like. Examples of the carbon materials may include graphite, carbon black, acetylene black, and Ketjen black. The cathode electric conductor may be a metal material, a conductive polymer, or the like as long as the material has electric conductivity.

[Anode]

The anode 22 has an anode active material layer 22B on a single surface or both surfaces of an anode current collector 22A.

The anode current collector 22A may be made of, for example, a conductive material such as copper, nickel, and stainless steel. The surface of the anode current collector 22A may be preferably roughened. Thereby, due to a so-called anchor effect, adhesion characteristics of the anode active material layer 22B with respect to the anode current collector 22A are improved. In this case, it is enough that the surface of the anode current collector 22A in a region opposed to the anode active material layer 22B is roughened at minimum. Examples of roughening methods may include a method of forming fine particles by utilizing electrolytic treatment. The electrolytic treatment is a method of providing concavity and convexity on the surface of the anode current collector 22A by forming fine particles on the surface of the anode current collector 22A with the use of an electrolytic method in an electrolytic bath. A copper foil fabricated by an electrolytic method is generally called “electrolytic copper foil.”

The anode active material layer 22B contains one or more of anode materials capable of inserting and extracting lithium ions as anode active materials, and may also contain other materials such as an anode binder and an anode electric conductor as necessary. Details of the anode binder and the anode electric conductor are, for example, similar to those of the cathode binder and the cathode electric conductor, respectively. However, the chargeable capacity of the anode material may be preferably larger than the discharge capacity of the cathode 21 in order to prevent lithium metal from being unintentionally precipitated on the anode 22 in the middle of charge. That is, the electrochemical equivalent of the anode material capable of inserting and extracting lithium ions may be preferably larger than the electrochemical equivalent of the cathode 21.

The anode material may be, for example, a carbon material. In the carbon material, its crystal structure change at the time of insertion and extraction of lithium ions is extremely small. Therefore, the carbon material provides high energy density and superior cycle characteristics. Further, the carbon material functions as an anode electric conductor as well. Examples of the carbon material may include graphitizable carbon, non-graphitizable carbon in which the spacing of (002) plane is equal to or greater than 0.37 nm, and graphite in which the spacing of (002) plane is equal to or smaller than 0.34 nm. More specifically, examples of the carbon material may include pyrolytic carbons, cokes, glassy carbon fiber, an organic polymer compound fired body, activated carbon, and carbon blacks. Of the foregoing, examples of the cokes may include pitch coke, needle coke, and petroleum coke. The organic polymer compound fired body is obtained by firing (carbonizing) a polymer compound such as a phenol resin and a furan resin at appropriate temperature. In addition thereto, the carbon material may be low crystalline carbon or amorphous carbon heat-treated at temperature of about 1000 deg C. or less. It is to be noted that the shape of the carbon material may be any of a fibrous shape, a spherical shape, a granular shape, and a scale-like shape.

Further, the anode material may be, for example, a material (metal-based material) containing one or more of metal elements and metalloid elements as constituent elements, since higher energy density is thereby obtained. Such a metal-based material may be a simple substance, an alloy, or a compound, may be two or more thereof, or may be a material having one or more phases thereof in part or all thereof “Alloy” includes a material containing one or more metal elements and one or more metalloid elements, in addition to a material configured of two or more metal elements. Further, the “alloy” may contain a nonmetallic element. Examples of the structure thereof may include a solid solution, a eutectic crystal (eutectic mixture), an intermetallic compound, and a structure in which two or more thereof coexist.

Examples of the foregoing metal elements and the foregoing metalloid elements may include one or more of metal elements and metalloid elements capable of forming an alloy with Li. Specific examples thereof may include Mg, B, Al, Ga, In, Si, Ge, Sn, Pb, Bi, Cd, Ag, Zn, Hf, Zr, Y, Pd, and Pt. In particular, Si, Sn, or both are preferable. Si and Sn have a superior ability of inserting and extracting lithium ions, and therefore, provide high energy density.

A material containing Si, Sn, or both as constituent elements may be a simple substance, an alloy, or a compound of Si or Sn, may be two or more thereof, or may be a material having one or more phases thereof in part or all thereof. However, the term “simple substance” merely refers to a general simple substance (a small amount of impurity may be therein contained), and does not necessarily refer to a purity 100% simple substance.

The alloys of Si may contain, for example, one or more of elements such as Sn, Ni, Cu, Fe, Co, Mn, Zn, In, Ag, Ti, Ge, Bi, Sb, and Cr as constituent elements other than Si. The compounds of Si may contain, for example, one or more of C, O, and the like as constituent elements other than Si. It is to be noted that, for example, the compounds of Si may contain one or more of the elements described for the alloys of Si as constituent elements other than Si.

Specific examples of the alloys of Si and the compounds of Si may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v<2), and LiSiO. v in SiOᵥ may be in the range of 0.2<v<1.4.

The alloys of Sn may contain, for example, one or more of elements such as Si, Ni, Cu, Fe, Co, Mn, Zn, In, Ag, Ti, Ge, Bi, Sb, and Cr as constituent elements other than Sn. The compounds of Sn may contain, for example, one or more of elements such as C and O as constituent elements other than Sn. It is to be noted that the compounds of Sn may contain, for example, one or more of elements described for the alloys of Sn as constituent elements other than Sn. Specific examples of the alloys of Sn and the compounds of Sn may include SnO_{w} (0<w≦2), SnSiO₃, LiSnO, and Mg₂Sn.

Further, as a material containing Sn as a constituent element, for example, a material containing a second constituent element and a third constituent element in addition to Sn as a first constituent element may be preferable. Examples of the second constituent element may include one or more of elements such as Co, Fe, Mg, Ti, V, Cr, Mn, Ni, Cu, Zn, Ga, Zr, Nb, Mo, Ag, In, Ce, Hf, Ta, W, Bi, and Si. Examples of the third constituent element may include one or more of B, C, Al, P, and the like. In the case where the second constituent element and the third constituent element are contained, a high battery capacity, superior cycle characteristics, and the like are obtained.

In particular, a material containing Sn, Co, and C as constituent elements (SnCoC-containing material) may be preferable. In the SnCoC-containing material, for example, the C content may be from 9.9 mass % to 29.7 mass % both inclusive, and the ratio of Sn and Co contents (Co/(Sn+Co)) may be from 20 mass % to 70 mass % both inclusive, since high energy density is obtained thereby.

It is preferable that the SnCoC-containing material have a phase containing Sn, Co, and C. Such a phase may be preferably low-crystalline or amorphous. The phase is a reaction phase capable of reacting with Li. Therefore, due to existence of the reaction phase, superior characteristics are obtained. The half bandwidth of the diffraction peak obtained by X-ray diffraction of the phase may be preferably equal to or greater than 1 deg based on diffraction angle of 2θ in the case where CuKα ray is used as a specific X ray, and the insertion rate is 1 deg/min. Thereby, lithium ions are more smoothly inserted and extracted, and reactivity with the electrolytic solution is decreased. It is to be noted that, in some cases, the SnCoC-containing material includes a phase containing a simple substance or part of the respective constituent elements in addition to the low-crystalline phase or the amorphous phase.

Whether or not the diffraction peak obtained by the X-ray diffraction corresponds to the reaction phase capable of reacting with Li is allowed to be easily determined by comparison between X-ray diffraction charts before and after electrochemical reaction with Li. For example, if the position of the diffraction peak after electrochemical reaction with Li is changed from the position of the diffraction peak before the electrochemical reaction with Li, the obtained diffraction peak corresponds to the reaction phase capable of reacting with Li. In this case, for example, the diffraction peak of the low crystalline reaction phase or the amorphous reaction phase is seen in the range of 2θ=from 20 deg to 50 deg both inclusive. Such a reaction phase may have, for example, the foregoing respective constituent elements, and the low crystalline or amorphous structure thereof possibly results from existence of C mainly.

In the SnCoC-containing material, part or all of C as a constituent element may be preferably bonded to a metal element or a metalloid element as other constituent element, since cohesion or crystallization of Sn and/or the like is suppressed thereby. The bonding state of elements is allowed to be checked with the use of, for example, X-ray photoelectron spectroscopy (XPS). In a commercially available device, for example, as a soft X ray, Al—Kα ray, Mg—Kα ray, or the like may be used. In the case where part or all of C are bonded to a metal element, a metalloid element, or the like, the peak of a synthetic wave of is orbit of C(C1s) is shown in a region lower than 284.5 eV. It is to be noted that the device, energy calibration is made so that the peak of 4f orbit of Au atom (Au4f) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of carbon in the SnCoC-containing material. Therefore, for example, analysis may be made by using commercially available software to isolate both peaks from each other. In the waveform analysis, the position of the main peak existing on the lowest bound energy side is the energy standard (284.8 eV).

It is to be noted that the SnCoC-containing material is not limited to the material configured of only Sn, Co, and C (SnCoC) as constituent elements. The SnCoC-containing material may further contain, for example, one or more of Si, Fe, Ni, Cr, In, Nb, Ge, Ti, Mo, Al, P, Ga, Bi, and the like as constituent elements in addition to Sn, Co, and C.

In addition to the SnCoC-containing material, a material containing Sn, Co, Fe, and C as constituent elements (SnCoFeC-containing material) may be also preferable. The composition of the SnCoFeC-containing material may be arbitrarily set. For example, the composition in which the Fe content may be set small is as follows. That is, the C content may be from 9.9 mass % to 29.7 mass % both inclusive, the Fe content may be from 0.3 mass % to 5.9 mass % both inclusive, and the ratio of contents of Sn and Co (Co/(Sn+ Co)) may be from 30 mass % to 70 mass % both inclusive. Further, the composition in which the Fe content is set large is as follows. That is, the C content may be from 11.9 mass % to 29.7 mass % both inclusive, the ratio of contents of Sn, Co, and Fe ((Co+Fe)/(Sn+Co+Fe)) may be from 26.4 mass % to 48.5 mass % both inclusive, and the ratio of contents of Co and Fe (Co/(Co+Fe)) may be from 9.9 mass % to 79.5 mass % both inclusive. In such a composition range, high energy density is obtained. The physical properties (such as half bandwidth) of the SnCoFeC-containing material are similar to those of the foregoing SnCoC-containing material.

In addition thereto, the anode material may be, for example, a metal oxide, a polymer compound, or the like. Examples of the metal oxide may include iron oxide, ruthenium oxide, and molybdenum oxide. Examples of the polymer compound may include polyacetylene, polyaniline, and polypyrrole.

The anode active material layer 22B may be formed by, for example, a coating method, a vapor-phase deposition method, a liquid-phase deposition method, a spraying method, a firing method (sintering method), or a combination of two or more of these methods. The coating method is a method in which, for example, after a particulate (powder) anode active material is mixed with an anode binder and/or the like, the mixture is dispersed in a solvent such as an organic solvent, and the anode current collector 22A is coated with the resultant. Examples of the vapor-phase deposition method may include a physical deposition method and a chemical deposition method. More specifically, examples thereof may include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase deposition method may include an electrolytic plating method and an electroless plating method. The spraying method is a method in which an anode active material in a fused state or a semi-fused state is sprayed to the anode current collector 22A. The firing method is, for example, a method in which after the anode current collector 22A is coated with the use of a coating method, heat treatment is performed at temperature higher than the melting point of the anode binder and/or the like. Examples of the firing method may include an atmosphere firing method, a reactive firing method, and a hot press firing method.

In the secondary battery, as described above, in order to prevent lithium metal from being unintentionally precipitated on the anode 22 in the middle of charge, the electrochemical equivalent of the anode material capable of inserting and extracting lithium ions is larger than the electrochemical equivalent of the cathode. Further, in the case where the open circuit voltage (that is, a battery voltage) at the time of completely-charged state is equal to or greater than 4.25 V, the extraction amount of lithium ions per unit mass is larger than that in the case where the open circuit voltage is 4.20 V even if the same cathode active material is used. Therefore, amounts of the cathode active material and the anode active material are adjusted accordingly. Thereby, high energy density is obtainable.

[Separator]

The separator 23 separates the cathode 21 from the anode 22, and passes lithium ions while preventing current short circuit resulting from contact of both electrodes. The separator 23 may be, for example, a porous film made of a synthetic resin, ceramics, or the like. The separator 23 may be a laminated film in which two or more types of porous films are laminated. Examples of the synthetic resin may include polytetrafluoroethylene, polypropylene, and polyethylene.

In particular, the separator 23 may include, for example, a polymer compound layer on one surface or both surfaces of the foregoing porous film (base material layer). Thereby, adhesion characteristics of the separator 23 with respect to the cathode 21 and the anode 22 are improved, and therefore, skewness of the spirally wound electrode body 20 is suppressed. Thereby, a decomposition reaction of the electrolytic solution is suppressed, and liquid leakage of the electrolytic solution with which the base material layer is impregnated is suppressed. Accordingly, even if charge and discharge are repeated, the resistance of the secondary battery is less likely to be increased, and battery swollenness is suppressed.

The polymer compound layer may contain, for example, a polymer material such as polyvinylidene fluoride, since such a polymer material has a superior physical strength and is electrochemically stable. However, the polymer material is not limited to polyvinylidene fluoride. The polymer compound layer may be formed as follows, for example. That is, after a solution in which the polymer material is dissolved is prepared, the base material layer is coated with the solution, and the resultant is subsequently dried. Alternatively, the base material layer may be soaked in the solution and may be subsequently dried.

[Electrolytic Solution]

The separator 23 is impregnated with an electrolytic solution as a liquid electrolyte. The electrolytic solution contains one or more of unsaturated cyclic carbamate compounds, which are represented by the following Formula (1). However, the electrolytic solution may contain other material such as a solvent and an electrolyte salt.

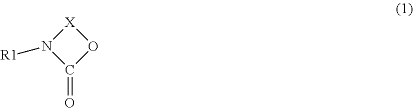

In Formula (1), X is a divalent group in which m-number of >C═CR2R3 and n-number of >CR4R5 are bonded in any order. m and n satisfy m≧1 and n≧0. Each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group. Any two or more of R1 to R5 may be bonded to one another.

As is clear from Formula (1), the unsaturated cyclic carbamate compound refers to a cyclic compound having a carbamate bond (>N—C(═O)—O—) and one or more unsaturated bonds (>C═C< as carbon-carbon double bonds). One reason why the electrolytic solution contains the unsaturated cyclic carbamate compound is that, in this case, chemical stability is improved compared to in the case where the electrolytic solution does not contain the unsaturated cyclic carbamate compound, and therefore, a decomposition reaction is suppressed. More specifically, since a rigid film due to the unsaturated cyclic carbamate compound is formed on the surfaces of the cathode 21 and the anode 22 at the time of charge and discharge, a decomposition reaction of the electrolytic solution that may occur on the surfaces of the electrodes is suppressed. Thereby, even if the secondary battery is repeatedly charged, discharged, and stored, lowering of the discharge capacity is suppressed. Such a tendency is particularly significant in the case where the secondary battery is charged, discharged, and stored under strict temperature environment such as high temperature.

X in Formula (1) is a group obtained by bonding m-number of >C═CR2R3 to n-number of >CR4R5 so that the valency becomes divalent as a whole (one bonding hand exists on each of both ends). Since bonding order of >C═CR2R3 and >CR4R5 is arbitrary, adjacent groups (groups bonded to each other) may be the same type of group such as >C═CR2R3 and >C═CR2R3, and >CR4R5 and >CR4R5, or may be different from each other such as >C═CR2R3 and >CR4R5. Further, since the number (m) of >C═CR2R3 used for forming the divalent group and the number (n) of >CR4R5 used for forming the divalent group may be any number, m and n may be the same value or values different from each other.

While >C═CR2R3 is a divalent group (unsaturated group) having the foregoing unsaturated bonds (>C═C<), >CR4R5 is a divalent group (saturated group) not having an unsaturated bond. Since n satisfies n≧0, >CR4R5 as a saturated group may be included in X, and may not be necessarily included in X. On the other hand, since m satisfies m≧1, it may be necessary to include one or more >C═CR2R3 as unsaturated groups in X typically. Therefore, X may be configured of only >C═CR2R3, or may be configured of both >C═CR2R3 and >CR4R5. One reason for this is that it may be necessary to include one or more unsaturated groups in the unsaturated cyclic carbamate compound in order to easily form a film due to the unsaturated cyclic carbamate compound.

Values of m and n are not particularly limited as long as the conditions of m≧1 and n≧0 are satisfied. In particular, in the case where >C═CR2R3 is >C═CH₂ and >CR4R5 is >CH₂ (m>1 and n>1), (m+n)≦5 may be preferably satisfied. One reason for this is that, in this case, the carbon number of X is not excessively large, and therefore, the solubility and the compatibility of the unsaturated cyclic carbamate compound are secured.

Details of R1 to R5 are described below. However, R1 to R5 may be the same type of group, or may be groups different from one another. Any two or more of R1 to R5 may be the same type of group.

Each type of R1 to R5 is not particularly limited as long as each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group. One reason for this is that, since, in this case, the unsaturated cyclic carbamate compound has a carbamate bond and an unsaturated bond, the foregoing advantage is obtainable without depending on the types of R1 to R5.

The term “monovalent hydrocarbon group” is a generic term used to refer to monovalent groups configured of carbon (C) and hydrogen (H). The monovalent hydrocarbon group may have a straight-chain structure or a branched structure having one or more side chains. Further, the monovalent hydrocarbon group may be an unsaturated hydrocarbon group having a carbon-carbon multiple bond (a carbon-carbon double bond or a carbon-carbon triple bond), and may be a saturated hydrocarbon group not having a carbon-carbon multiple bond.

Examples of the monovalent hydrocarbon group may include an alkyl group, an alkenyl group, an alkynyl group, an aryl group, and a cycloalkyl group. The carbon numbers thereof are not particularly limited, since the foregoing advantage is obtainable without depending on the carbon numbers.

In particular, it is preferable that the carbon number of an alkyl group be from 1 to 12 both inclusive, the carbon numbers of an alkenyl group and an alkynyl group be from 2 to 12 both inclusive, the carbon number of an aryl group be from 6 to 18 both inclusive, and the carbon number of a cycloalkyl group be from 3 to 18 both inclusive. One reason for this is that, in this case, the solubility, the compatibility, and the like of the unsaturated cyclic carbamate compound are secured.

Examples of the alkyl group may include a methyl group (—CH₃), an ethyl group (—C₂H₅), and a propyl group (—C₃H₇). Examples of the alkenyl group may include a vinyl group (—CH═CH₂) and an allyl group (—CH₂—CH═CH₂). Examples of the alkynyl group may include an ethynyl group (—C≡CH). Examples of the aryl group may include a phenyl group and a naphtyl group. Examples of the cycloalkyl group may include a cyclopropyl group, a cyclobutyl group, a cyclopentyl group, a cyclohexyl group, a cycloheptyl group, and a cyclooctyl group.

The term “monovalent oxygen-containing hydrocarbon group” is a generic term used to refer to monovalent groups configured of oxygen (O) together with C and H. The monovalent oxygen-containing hydrocarbon group may have a straight-chain structure or a branched structure, and does not necessarily have a carbon-carbon multiple bond as the monovalent hydrocarbon group does.

Examples of the monovalent oxygen-containing hydrocarbon group may include an alkoxy group. The carbon number thereof is not particularly limited, since the foregoing advantage is obtainable without depending on the carbon numbers. In particular, the carbon number of the alkoxy group may be preferably from 1 to 12 both inclusive. One reason for this is that the solubility, the compatibility, and the like of the unsaturated cyclic carbamate compound are secured. Examples of the alkoxy group may include a methoxy group (—OCH₃) and an ethoxy group (—OC₂H₅).

The term “halogenated group thereof” refers to a group obtained by substituting (halogenating) each of part or all of hydrogen groups out of the monovalent hydrocarbon group and the monovalent oxygen-containing hydrocarbon group by a halogen group. Types of the halogen group are not particularly limited, and may be, for example, one or more of a fluorine group, a chlorine group, a bromine group, and an iodine group. In particular, the fluorine group may be preferable, since a film due to the unsaturated cyclic carbamate compound is easily formed thereby.

Examples of the group obtained by halogenating a monovalent hydrocarbon group may include a trifluoromethyl group (—CF₃) and a pentafluoroethyl group (—C₂F₅). Further, examples of the group obtained by halogenating a monovalent oxygen-containing hydrocarbon group may include a trifluoromethoxy group (—OCF₃) and a pentafluoroethoxy group (—OC₂F₅).

The term “monovalent group obtained by bonding two or more thereof to one another” refers to a group obtained by bonding two or more of a monovalent hydrocarbon group, a monovalent oxygen-containing hydrocarbon group, and a halogenated group thereof so that the valency becomes monovalent as a whole. More specific examples thereof may include a group obtained by substituting one or more hydrogen groups of an aryl group by an alkyl group (benzyl group), a group obtained by substituting one or more hydrogen groups of a cycloalkyl group by an alkyl group, and a group obtained by substituting one or more hydrogen groups of an aryl group by an alkoxy group.

Examples of the halogen group may include a fluorine group, a chlorine group, a bromine group, an iodine group, and the like as the foregoing halogenated group. In particular, the fluorine group may be preferable, since a film due to the unsaturated cyclic carbamate compound is easily formed thereby.

In addition thereto, each of R1 to R5 may be a group other than the foregoing groups, since the advantage is obtainable without depending on the types of R1 to R5 as described above. More specifically, each of R1 to R5 may be, for example, a derivative of each of the foregoing groups. The derivative is obtained by introducing one or more substituent groups to each of the foregoing groups. Substituent group types may be any type.

In addition thereto, any two or more of R1 to R5 may be bonded to one another, and a ring may be formed of the bonded groups. As an example, R2 may be bonded to R3, R4 may be bonded to R5, or R3 may be bonded to R4 or R5.

In particular, the unsaturated cyclic carbamate compound may be preferably represented by the following Formula (2-1) or the following Formula (2-1). One reason for this is that such compounds are easily synthesized.

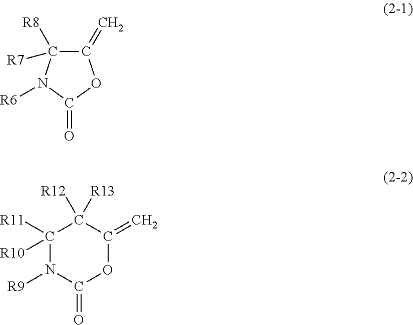

In Formulas (2-1) and (2-2), each of R6 to R13 is one of a monovalent hydrocarbon group, a monovalent oxygen-containing hydrocarbon group, a halogenated group thereof, a monovalent group obtained by bonding two or more thereof to one another, a hydrogen group, and a halogen group. Any two or more of R6 to R8 may be bonded to one another, and any two or more of R9 to R13 may be bonded to one another.

Focusing attention on a relation between Formula (1) and Formula (2-1), the unsaturated cyclic carbamate compound represented by Formula (2-1) has, as X in Formula (1), one unsaturated group (>C═CH₂) and one saturated group (>CR7R8). On the other hand, focusing attention on a relation between Formula (1) and Formula (2-2), the unsaturated cyclic carbamate compound represented by Formula (2-2) has, as X, one unsaturated group (>C═CH₂) and two saturated groups (>CR10R11 and >CR12R13). However, the foregoing one unsaturated group and the foregoing two saturated groups are bonded in order of >CR9R10, >CR11R12, and >C═CH₂.

Details of R6 to R8 in Formula (2-1) and R9 to R13 in Formula (2-2) are similar to those of R1 to R5 in Formula (1), and therefore, descriptions thereof will be omitted.

Specific examples of the unsaturated cyclic carbamate compound may include compounds represented by the following Formula (1-1) to the following Formula (1-74). Such unsaturated cyclic carbamate compounds include a geometric isomer. —C₄H₉ of Formula (1-28) and Formula (1-55) represents an n-butyl group, —C₃H₇ of Formula (1-34) and Formula (1-56) represents an n-propyl group, and —C₆H₁₃ of Formula (1-45) represents an n-hexyl group. However, the unsaturated cyclic carbamate compound may be other compounds satisfying the conditions shown in Formula (1). As an example, in Formula (1-18), Formula (1-22), and the like, a fluorine group may be changed to other halogen group such as a chlorine group.

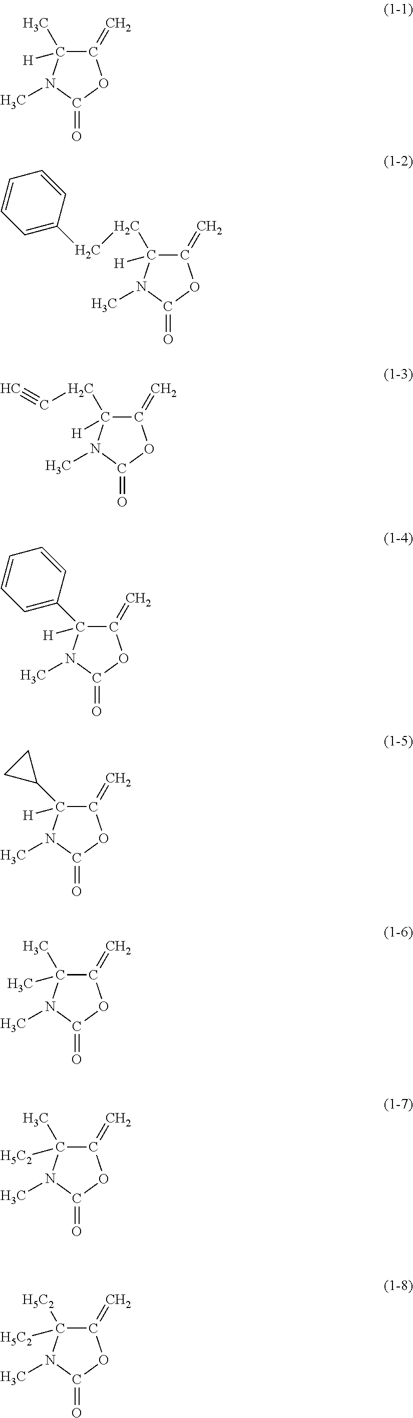

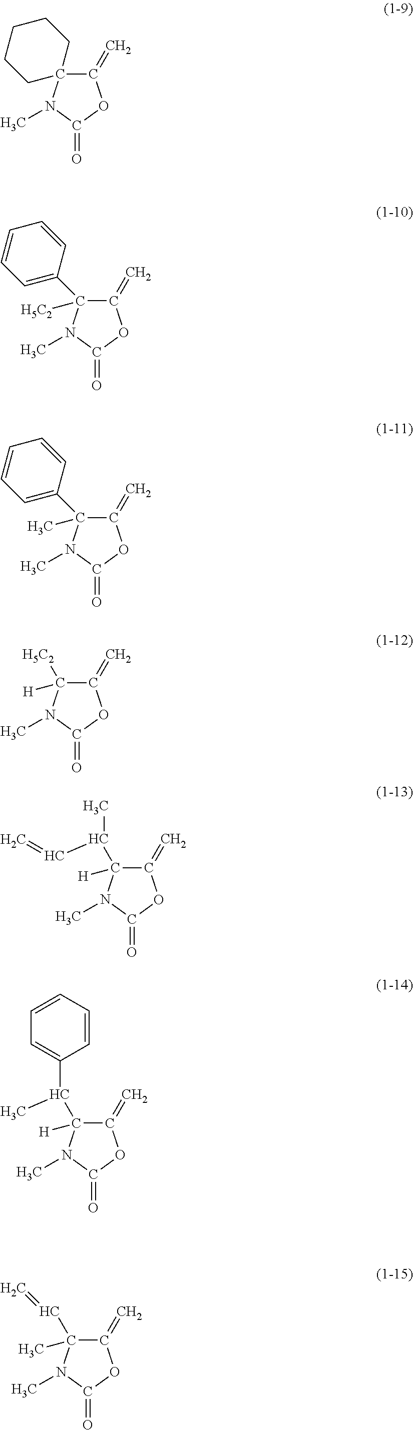

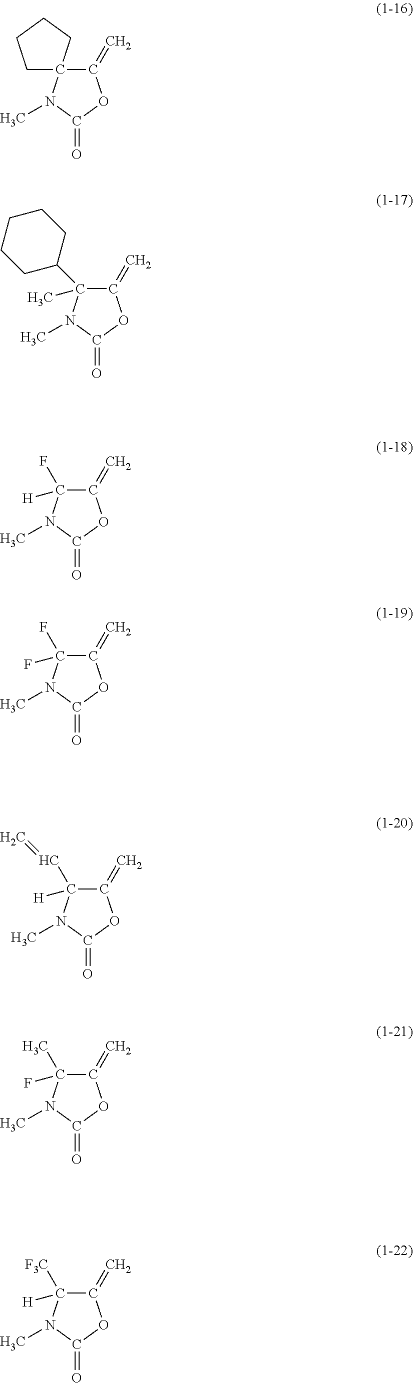

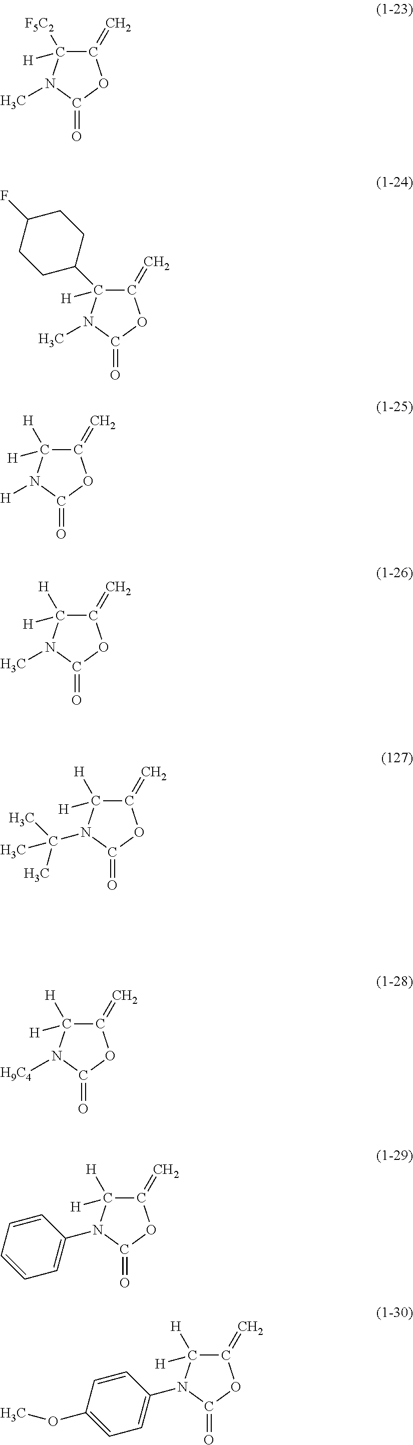

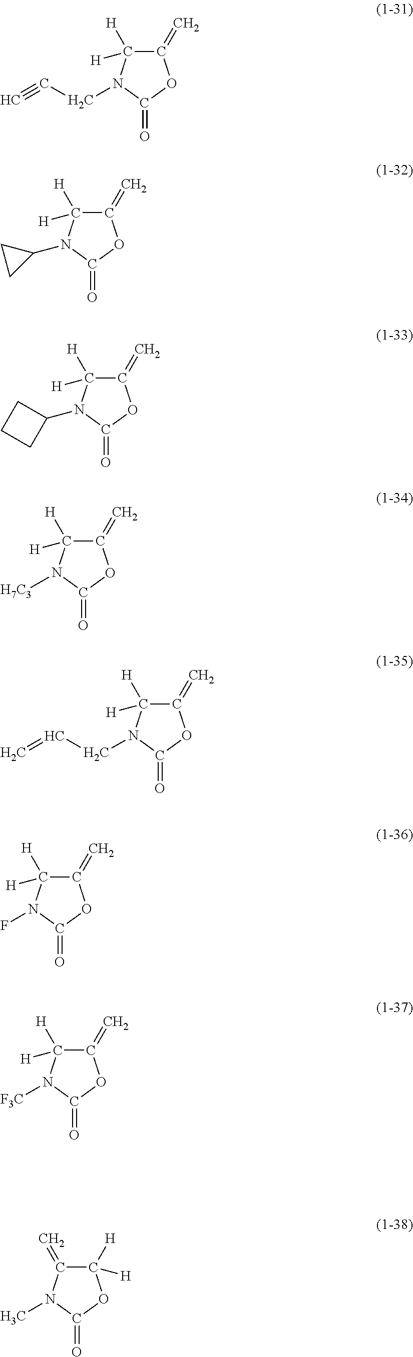

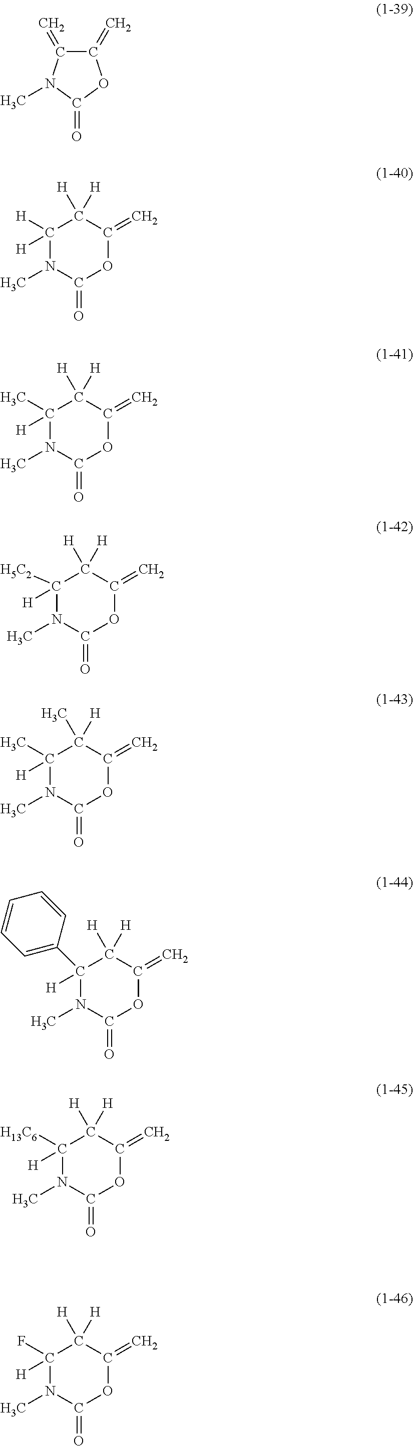

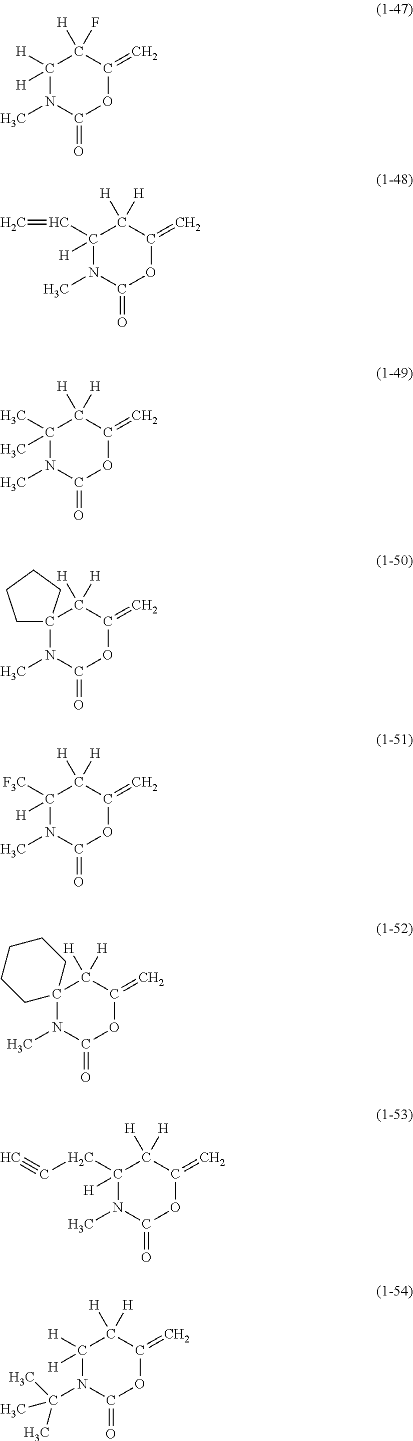

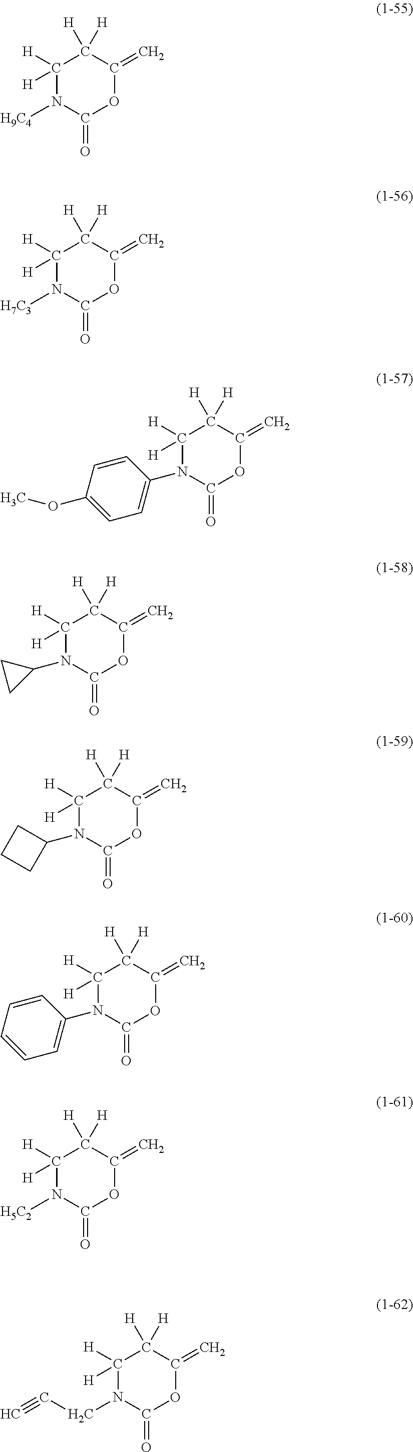

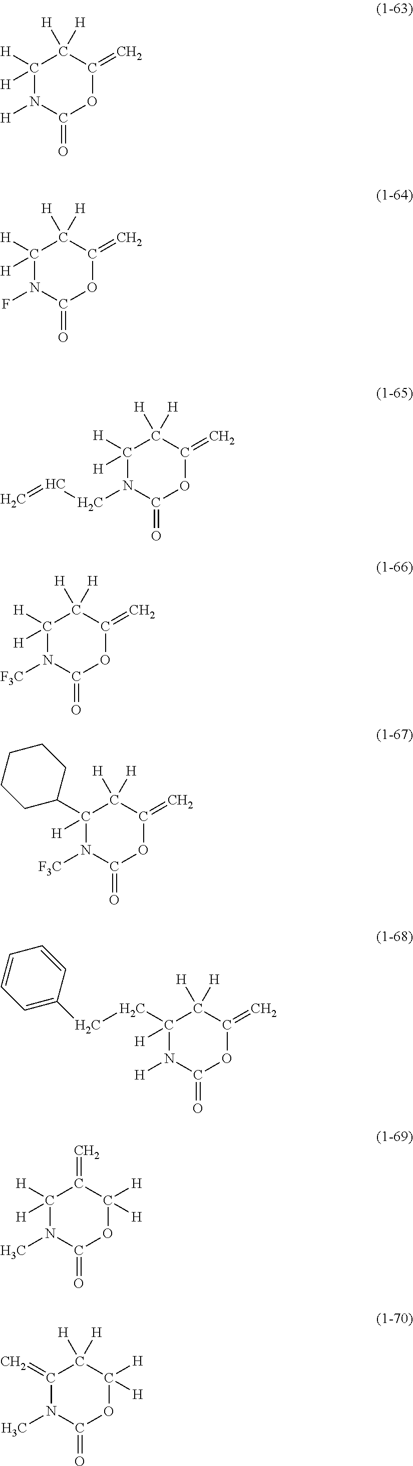

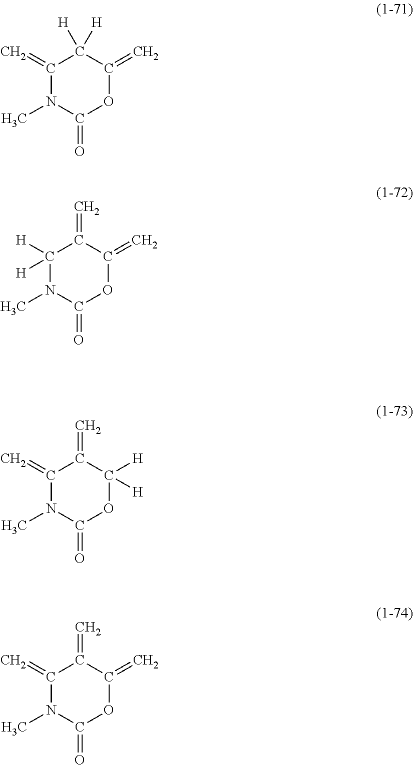

In particular, the unsaturated cyclic carbamate compounds represented by Formula (1-1) to Formula (1-39) are five-membered ring compounds, and the unsaturated cyclic carbamate compounds represented by Formula (1-40) to Formula (1-74) are six-membered ring compounds. In particular, as a five-membered ring compound, Formula (1-1) to Formula (1-37) corresponding to Formula (2-1) may be preferable, and as a six-membered ring compound, Formula (1-40) to Formula (1-68) corresponding to Formula (2-2) may be preferable, since a higher effect is thereby obtainable.

Although the content of the unsaturated cyclic carbamate compound in the electrolytic solution is not particularly limited, in particular, the content thereof may be preferably from 0.01 wt % to 20 wt % both inclusive, and more preferably from 0.1 wt % to 10 wt % both inclusive, since a higher effect is thereby obtainable.

[Non-Carbamate Compound]

The electrolytic solution may preferably contain a non-carbamate compound together with the unsaturated cyclic carbamate compound. The non-carbamate compound may contain, for example, one or more of a dicarbonic ester compound represented by the following Formula (3), a dicarboxylic acid compound represented by Formula (4), a disulfonic acid compound represented by Formula (5), a lithium salt represented by Formula (6), and a lithium salt represented by Formula (7). One reason for this is that, in this case, chemical stability of the electrolytic solution is further improved, and therefore, a decomposition reaction of the electrolytic solution is further suppressed.

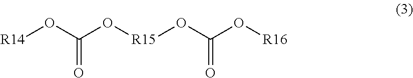

In Formula (3), each of R14 and R16 is one of a monovalent hydrocarbon group, a monovalent oxygen-containing hydrocarbon group, a halogenated group thereof, and a group obtained by bonding two or more thereof to one another. R15 is one of a divalent hydrocarbon group, a halogenated group thereof, a group obtained by bonding two or more thereof to one another, and a group including one or more of the foregoing groups and one of more ether bond (—O—).

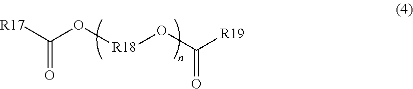

In Formula (4), each of R17 and R19 is one of a monovalent hydrocarbon group, a monovalent oxygen-containing hydrocarbon group, a halogenated group thereof, and a group obtained by bonding two or more thereof to one another. R18 is one of a divalent hydrocarbon group, a halogenated group thereof, a group obtained by bonding two or more thereof to one another, and a group including one or more of the foregoing groups and one of more ether bond. n is an integer number equal to or more than 1.

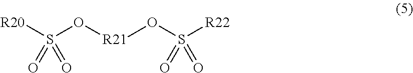

In Formula (5), each of R20 and R22 is one of a monovalent hydrocarbon group, a monovalent oxygen-containing hydrocarbon group, a halogenated group thereof, and a group obtained by bonding two or more thereof to one another. R21 is one of a divalent hydrocarbon group, a halogenated group thereof, a group obtained by bonding two or more thereof to one another, and a group including one or more of the foregoing groups and one of more ether bond.

LiPF₂O₂ (6)

Li₂PFO₃ (7)

The dicarbonic ester compound has, as shown in Formula (3), carbonic ester groups (—O—C(═O)—O—R14 and —O—C(═O)—O—R16) on both ends thereof. R14 and R16 may be the same group, or may be a group different from each other.

As described above, types of R14 and R16 are not particularly limited, as long as each of R14 and R16 is one of a monovalent hydrocarbon group, a monovalent oxygen-containing hydrocarbon group, a halogenated group thereof, and a group obtained by bonding two or more thereof to one another. The terms “hydrocarbon group,” “oxygen-containing hydrocarbon group,” “halogenated group thereof,” and “group obtained by bonding two or more thereof to one another” refer to groups similar to those described for the unsaturated cyclic carbamate compound. One reason for this is that, since the dicarbonic ester compound has the foregoing carbonic ester group, the foregoing advantage is obtainable without depending on the types of R14 to R16.

Examples of the monovalent hydrocarbon group and the monovalent oxygen-containing hydrocarbon group may include an alkyl group, an alkenyl group, an alkynyl group, an aryl group, a cycloalkyl group, an alkoxy group, and a group obtained by bonding two or more thereof to one another. One reason for this is that, in this case, the solubility, the compatibility, and the like of the dicarbonic ester compound are secured. It is to be noted that details of the foregoing alkyl group and the like are similar to those described for the unsaturated cyclic carbamate compound.

In particular, it is preferable that the carbon numbers of an alkyl group and an alkoxy group be from 1 to 12 both inclusive, the carbon numbers of an alkenyl group and an alkynyl group be from 2 to 12 both inclusive, the carbon number of an aryl group be from 6 to 18 both inclusive, and the carbon number of a cycloalkyl group be from 3 to 18 both inclusive. One reason for this is that, in this case, the solubility, the compatibility, and the like are obtainable.

Type of R15 is not particularly limited as long as R15 is one of a divalent hydrocarbon group, a halogenated group thereof, a group obtained by bonding two or more thereof to one another, and a group including one or more of the foregoing groups and one of more ether bond. The term “halogenated group thereof” refers to a group similar to that described for the unsaturated cyclic carbamate compound. One reason for this is that, in this case, the foregoing advantage is obtainable without depending on the types of R15 for the reason similar to that of R14 and R16 described above.

Examples of the divalent hydrocarbon group may include an alkylene group, an alkenylene group, an alkynylene group, an arylene group, and a cycloalkylene group. One reason for this is that, in this case, the solubility, the compatibility, and the like of the dicarbonic ester compound are secured.

In particular, it is preferable that the carbon number of an alkylene group be from 1 to 12 both inclusive, the carbon numbers of an alkenylene group and an alkynylene group be from 2 to 12 both inclusive, the carbon number of an arylene group be from 6 to 18 both inclusive, and the carbon number of a cycloalkylene group be from 3 to 18 both inclusive. One reason for this is that, in this case, the solubility, the compatibility, and the like are obtainable.

The term “group obtained by bonding two or more thereof to one another” is a group obtained by bonding two or more of a divalent hydrocarbon group, a halogenated group thereof, and the like so that the valency becomes divalent as a whole. More specific examples thereof may include a group obtained by bonding an alkylene group to an arylene group. The group obtained by bonding an alkylene group to an arylene group may be a group obtained by bonding one arylene group to one alkylene group, or may be a group obtained by bonding two alkylene groups to each other through an arylene group.

The term “group including one or more of the foregoing groups and one of more ether bond” refers to a group obtained by bonding one or more of a divalent hydrocarbon group, a halogenated group thereof, a group obtained by bonding two or more thereof to one another, and the like to one or more ether bonds so that the valency becomes divalent as a whole. Specific examples thereof may include a group obtained by bonding an alkylene group to an ether bond. The group obtained by bonding an alkylene group to one of more ether bond may be a group obtained by bonding one alkylene group to one ether bond, may be a group obtained by bonding two alkylene groups to each other through one ether group, or may be a group configured of a plurality of alkylene groups, each thereof being alternately bonded through an ether bond.

Specific examples of R15 may include straight-chain alkylene groups represented by the following Formula (3-13) to the following Formula (3-19), branched alkylene groups represented by Formula (3-20) to Formula (3-28), arylene groups represented by Formula (3-29) to Formula (3-31), and groups represented by Formula (3-32) to Formula (3-34).

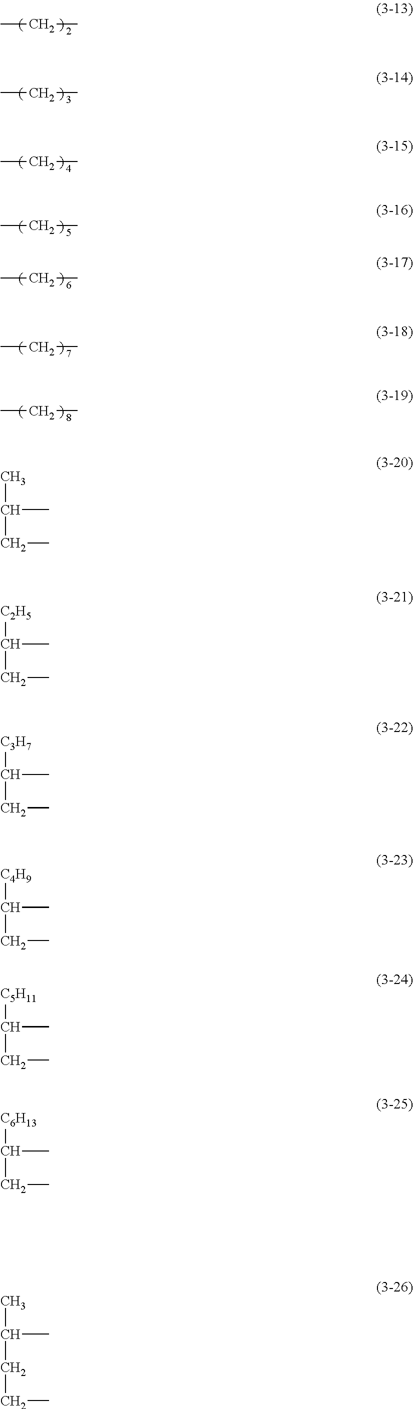

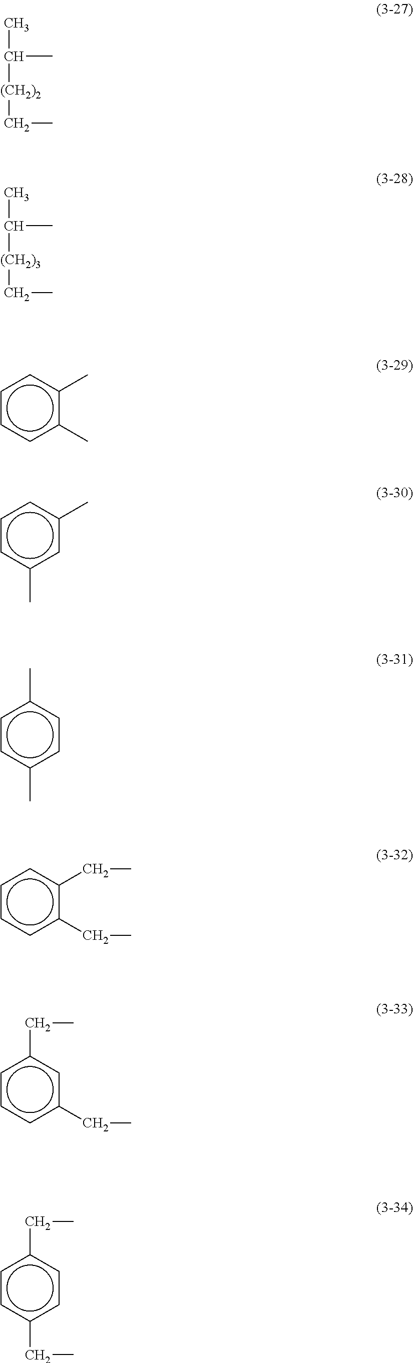

It is to be noted that, as the divalent group obtained by bonding an alkylene group to an ether bond, a group in which two or more alkylene groups are linked through an ether bond, and both ends thereof are carbon atoms may be preferable. The carbon number of such a group may be preferably from 4 to 12 both inclusive. One reason for this is, in this case, superior solubility and superior compatibility are obtained. However, the number of ether bonds and the like are arbitrarily set.

In this case, specific examples of R15 may include divalent groups represented by the following Formula (3-35) to the following Formula (3-47). Further, in the case where the divalent groups shown in Formula (3-35) to Formula (3-47) are fluorinated, examples thereof may include groups represented by Formula (3-48) to Formula (3-56). In particular, the groups shown in Formula (3-40) to Formula (3-42) may be preferable.

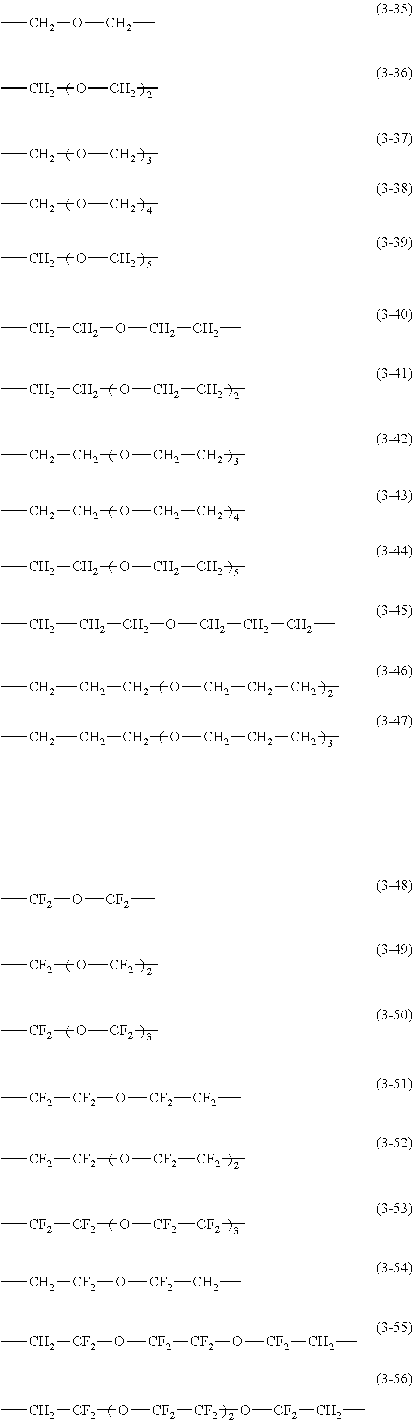

Although the molecular weight of the dicarbonic ester compound is not particularly limited, in particular, the molecular weight of the dicarbonic ester compound may be preferably from 200 to 800 both inclusive, may be more preferably from 200 to 600 both inclusive, and may be further more preferably from 200 to 450 both inclusive. One reason for this is that, in this case, superior solubility and superior compatibility are obtained.

Specific examples of the dicarbonic ester compound may include compounds represented by the following Formula (3-1) to the following Formula (3-12). One reason for this is that, in this case, sufficient solubility and sufficient compatibility are obtained, and chemical stability of the electrolytic solution is sufficiently improved. However, as the dicarbonic ester compound, other compound satisfying the conditions of the chemical formula shown in Formula (3) may be used.

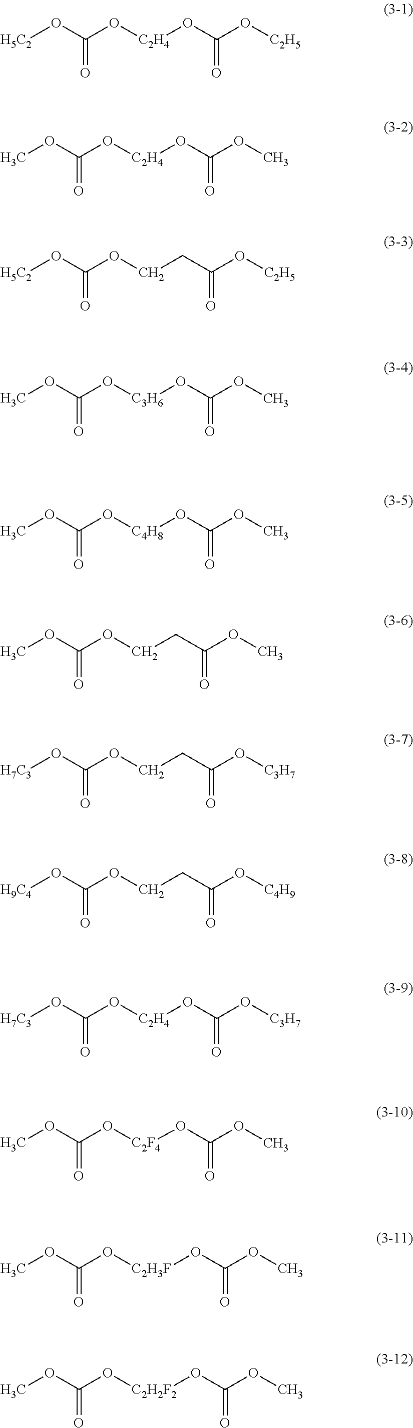

As shown in Formula (4), the dicarboxylic acid compound has carboxylic acid groups (—O—C(═O)—R17 and —O—C(═O)—R19) on both ends thereof. The value of n is not particularly limited, as long as n is an integer number equal to or larger than 1. R17 and R19 may be the same group, or may be groups different from each other. Details of R17 and R19 are respectively similar to those of R14 to R16 described above.

Though the molecular weight of the dicarboxylic acid compound is not particularly limited, in particular, the molecular weight of the dicarboxylic acid compound may be preferably from 162 to 1000 both inclusive, may be more preferably from 162 to 500 both inclusive, and may be further more preferably from 162 to 300 both inclusive. One reason for this is that, in this case, superior solubility and superior compatibility are obtained.

Specific examples of the dicarboxylic acid compound may include compounds represented by the following Formula (4-1) to the following Formula (4-17). One reason for this is that, in this case, sufficient solubility and sufficient compatibility are obtained, and chemical stability of the electrolytic solution is sufficiently improved. However, as the dicarbonic ester compound, other compound satisfying the conditions of the chemical formula shown in Formula (4) may be used.

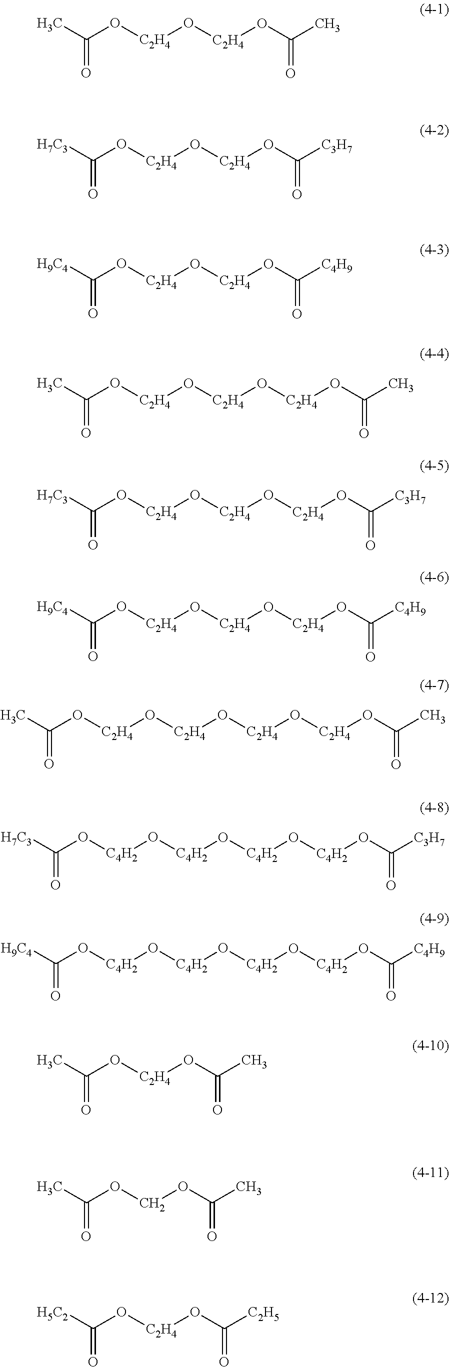

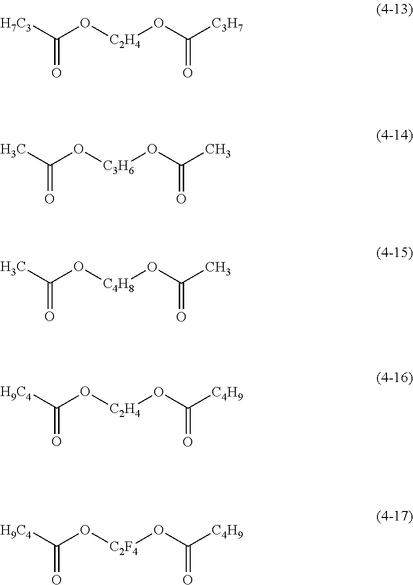

As shown in Formula (5), the disulfonic acid compound has sulfonic acid groups (—O—S(═O)₂—R20 and —O—S(═O)₂—R22) on both ends thereof. R20 and R22 may be the same group, or may be groups different from each other. Details of R20 to R22 are, for example, similar to those of R14 to R16 respectively.

Though the molecular weight of the disulfonic compound is not particularly limited, in particular, the molecular weight of the disulfonic compound may be preferably from 200 to 800 both inclusive, may be more preferably from 200 to 600 both inclusive, and may be further more preferably from 200 to 450 both inclusive. One reason for this is that, in this case, superior solubility and superior compatibility are obtained.

Specific examples of the disulfonic compound may include compounds represented by the following Formula (5-1) to the following Formula (5-9). One reason for this is that, in this case, sufficient solubility and sufficient compatibility are obtained, and chemical stability of the electrolytic solution is sufficiently improved. However, as the dicarbonic ester compound, other compound satisfying the conditions of the chemical formula shown in Formula (5) may be used.

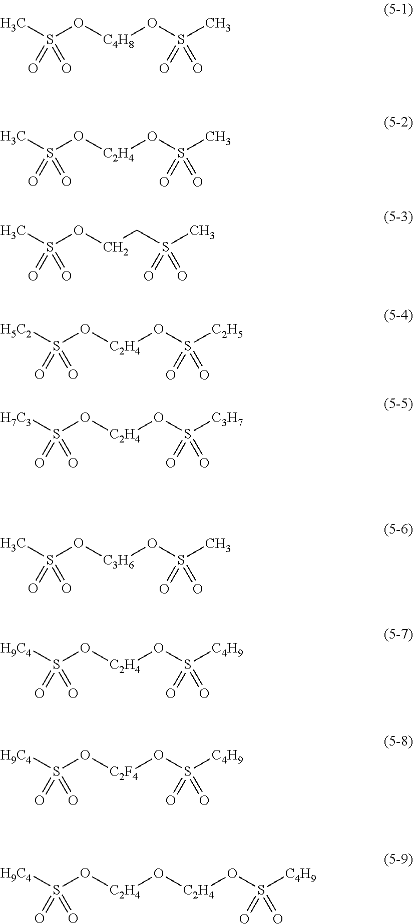

The lithium salt shown in Formula (6) is difluoro lithium phosphate, and the lithium salt shown in Formula (7) is monofluoro lithium phosphate.

Although the content of the non-carbamate compound in the electrolytic solution is not particularly limited, in particular, the content thereof may be preferably from 0.001 wt % to 2 wt % both inclusive, since a higher effect is thereby obtainable.

[Solvent]

The solvent contains one or more of nonaqueous solvents such as an organic solvent (excluding the foregoing unsaturated cyclic carbamate compound and the foregoing non-carbamate compound).

Examples of the nonaqueous solvents may include a cyclic ester carbonate, a chain ester carbonate, lactone, a chain carboxylic ester, and nitrile, since thereby, a superior battery capacity, superior cycle characteristics, superior conservation characteristics, and the like are obtained. Examples of the cyclic ester carbonate may include ethylene carbonate, propylene carbonate, and butylene carbonate. Examples of the chain ester carbonate may include dimethyl carbonate, diethyl carbonate, ethyl methyl carbonate, and methylpropyl carbonate. Examples of the lactone may include γ-butyrolactone and γ-valerolactone. Examples of the carboxylic ester may include methyl acetate, ethyl acetate, methyl propionate, ethyl propionate, methyl butyrate, methyl isobutyrate, methyl trimethylacetate, and ethyl trimethylacetate. Examples of the nitrile may include acetonitrile, glutaronitrile, adiponitrile, methoxyacetonitrile, and 3-methoxypropionitrile.

In addition thereto, examples of the nonaqueous solvent may include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. Thereby, a similar advantage is obtained.

In particular, one or more of ethylene carbonate, propylene carbonate, dimethyl carbonate, diethyl carbonate, and ethyl methyl carbonate may be preferable, since thereby, a superior battery capacity, superior cycle characteristics, superior conservation characteristics, and the like are obtained. In this case, a combination of a high viscosity (high dielectric constant) solvent (for example, specific dielectric constant ∈≧30) such as ethylene carbonate and propylene carbonate and a low viscosity solvent (for example, viscosity≦1 mPa·s) such as dimethyl carbonate, ethylmethyl carbonate, and diethyl carbonate may be more preferable. One reason for this is that the dissociation property of the electrolyte salt and ion mobility are improved.

In particular, the solvent may preferably contain one or more of unsaturated cyclic ester carbonates. One reason for this is that a stable protective film is formed mainly on the surface of the anode 22 at the time of charge and discharge, and therefore, a decomposition reaction of the electrolytic solution is suppressed. The unsaturated cyclic ester carbonate is a cyclic ester carbonate having one or more unsaturated bonds (carbon-carbon double bonds). More specifically, the unsaturated cyclic ester carbonate is one or more of a vinylene-carbonate-based compound represented by the following Formula (8), a vinylethylene-carbonate-based compound represented by Formula (9), and a methyleneethylene-carbonate-based compound represented by Formula (10). R23 and R24 may be the same type of group, or may be groups different from each other. The same is applied to R25 to R28. The content of the unsaturated cyclic ester carbonate in the solvent is not particularly limited, and may be, for example, from 0.01 wt % to 10 wt % both inclusive. It is to be noted that, specific examples of the unsaturated cyclic ester carbonate are not limited to the after-mentioned compounds.

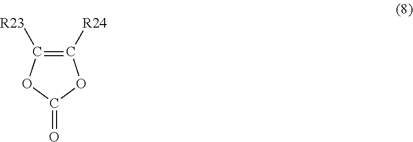

In Formula (8), each of R23 and R24 is one of a hydrogen group and an alkyl group.

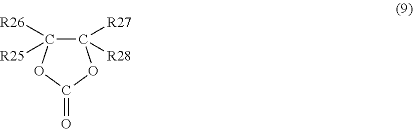

In Formula (9), each of R25 to R28 is one of a hydrogen group, an alkyl group, a vinyl group, and an allyl group. One or more of R25 to R28 each are a vinyl group or an allyl group.

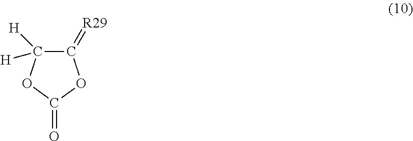

In Formula (10), R29 is an alkylene group.

Examples of the vinylene-carbonate-based compounds may include vinylene carbonate (1,3-dioxole-2-one), methylvinylene carbonate (4-methyl-1,3-dioxole-2-one), ethylvinylene carbonate (4-ethyl-1,3-dioxole-2-one), 4,5-dimethyl-1,3-dioxole-2-one, 4,5-diethyl-1,3-dioxole-2-one, 4-fluoro-1,3-dioxole-2-one and 4-trifluoromethyl-1,3-dioxole-2-one. In particular, vinylene carbonate may be preferable, since vinylene carbonate is easily available and provides a high effect.

Examples of the vinylethylene-carbonate-based compounds may include vinylethylene carbonate (4-vinyl-1,3-dioxolane-2-one), 4-methyl-4-vinyl-1,3-dioxolane-2-one, 4-ethyl-4-vinyl-1,3-dioxolane-2-one, 4-n-propyl-4-vinyl-1,3-dioxolane-2-one, 5-methyl-4-vinyl-1,3-dioxolane-2-one, 4,4-divinyl-1,3-dioxolane-2-one, and 4,5-divinyl-1,3-dioxolane-2-one. In particular, vinylethylene carbonate may be preferable, since vinylethylene carbonate is easily available, and provides a high effect. It goes without saying that all of R32 to R35 may be vinyl groups or allyl groups. Alternatively, some of R32 to R35 may be vinyl groups, and the others thereof may be allyl groups.

Examples of the methyleneethylene-carbonate-based compounds may include methyleneethylene carbonate (4-methylene-1,3-dioxolane-2-one), 4,4-dimethyl-5-methylene-1,3-dioxolane-2-one, and 4,4-diethyl-5-methylene-1,3-dioxolane-2-one. The methyleneethylene-carbonate-based compound may be a compound having one methylene group as illustrated in Formula (8), or may be a compound having two methylene groups. It is to be noted that R29 may be a divalent group represented by >CR₂ (R is an alkyl group).

In addition thereto, the unsaturated cyclic ester carbonate may be catechol carbonate having a benzene ring.

Further, the solvent may preferably contain one or more of halogenated ester carbonates. One reason for this is that a stable protective film is formed mainly on the surface of the anode 22 at the time of charge and discharge, and therefore, a decomposition reaction of the electrolytic solution is suppressed. The halogenated ester carbonate is a cyclic ester carbonate having one or more halogens as constituent elements or a chain ester carbonate having one or more halogens as constituent elements. More specifically, a cyclic halogenated ester carbonate is represented by the following Formula (11), and a chain halogenated ester carbonate is represented by Formula (12). R30 to R33 may be the same type of group, or may be groups different from one another. Alternatively, part of R30 to R33 may be the same type of group. The same is applied to R34 to R39. Although the content of the halogenated ester carbonate in the solvent is not particularly limited, the content thereof may be, for example, from 0.01 wt % to 50 wt % both inclusive. It is to be noted that, specific examples of the halogenated ester carbonate are not limited to the compounds described below.

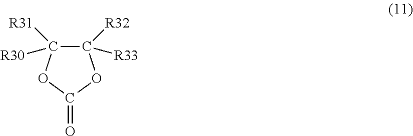

In Formula (11), each of R30 to R33 is one of a hydrogen group, a halogen group, an alkyl group, and a halogenated alkyl group. One or more of R30 to R33 are each one of a halogen group and a halogenated alkyl group.

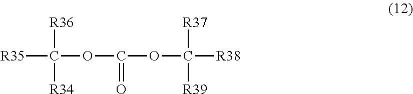

In Formula (12), each of R34 to R39 is one of a hydrogen group, a halogen group, an alkyl group, and a halogenated alkyl group. One or more of R34 to R39 are each a halogen group or a halogenated alkyl group.

Although halogen type is not particularly limited, in particular, one or more of fluorine, chlorine, bromine, and iodine may be preferable, and fluorine may be more preferable since thereby, a higher effect is obtained than other halogens. However, the number of halogens may be more preferably two than one, and further may be three or more. One reason for this is that, since thereby, an ability of forming a protective film is improved, a more rigid and stable protective film is formed, and accordingly, a decomposition reaction of the electrolytic solution is further suppressed.

Examples of the cyclic halogenated ester carbonate may include compounds represented by the following Formula (11-1) to the following Formula (11-21). Such cyclic halogenated ester carbonates include a geometric isomer. In particular, 4-fluoro-1,3-dioxolane-2-one represented by Formula (11-1) or 4,5-difluoro-1,3-dioxolane-2-one represented by Formula (11-3) may be preferable, and the latter may be more preferable. Further, as 4,5-difluoro-1,3-dioxolane-2-one, a trans isomer may be more preferable than a cis isomer, since the trans isomer is easily available and provides a high effect. On the other hand, examples of the chain halogenated ester carbonate may include fluoromethyl methyl carbonate, bis(fluoromethyl)carbonate, and difluoromethyl methyl carbonate.

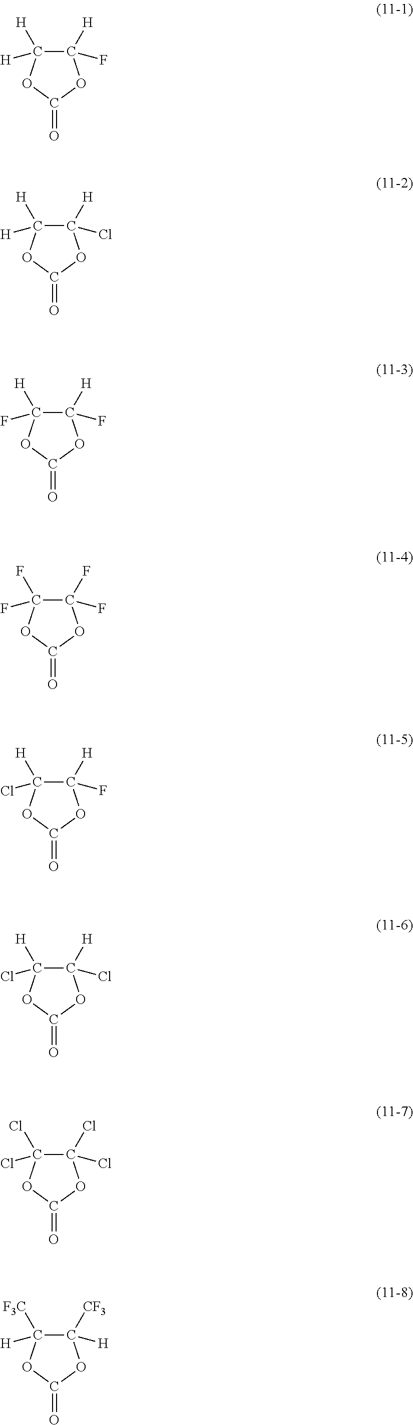

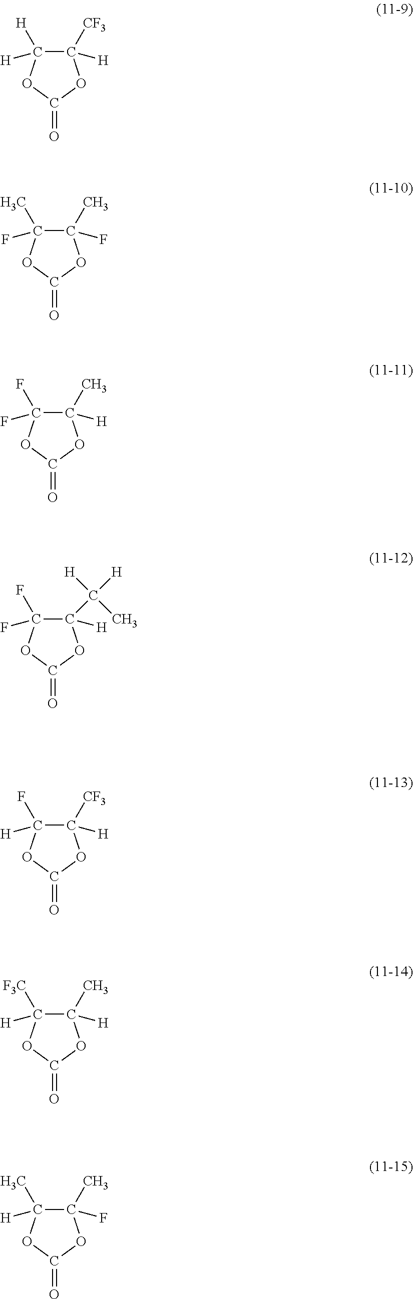

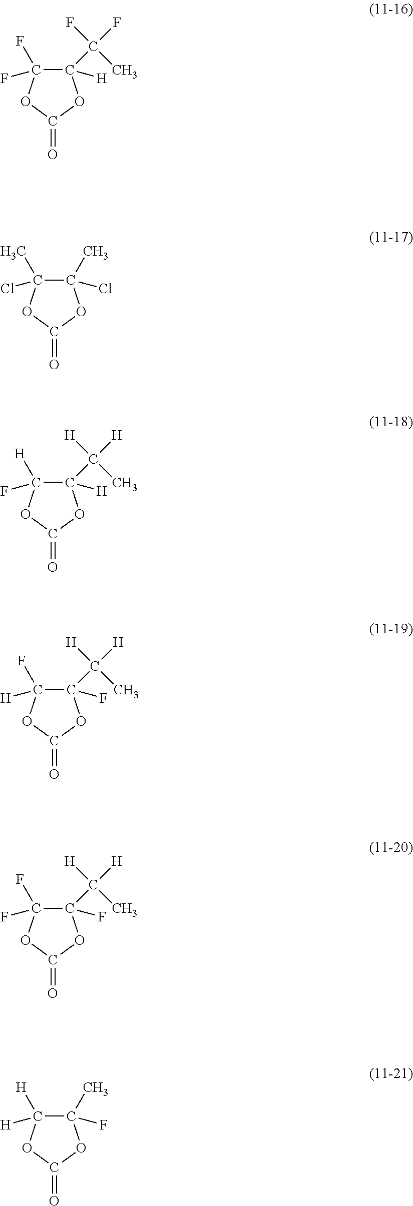

Further, the solvent may preferably contain sultone (cyclic sulfonic ester), since the chemical stability of the electrolytic solution is more improved thereby. Examples of sultone may include propane sultone and propene sultone. Although the sultone content in the solvent is not particularly limited, for example, the sultone content may be from 0.5 wt % to 5 wt % both inclusive. Specific examples of sultone are not limited to the foregoing compounds.

Further, the solvent may preferably contain an acid anhydride since the chemical stability of the electrolytic solution is thereby further improved. Examples of the acid anhydrides may include a carboxylic anhydride, a disulfonic anhydride, and a carboxylic acid sulfonic acid anhydride. Examples of the carboxylic anhydride may include a succinic anhydride, a glutaric anhydride, and a maleic anhydride. Examples of the disulfonic anhydride may include an ethane disulfonic anhydride and a propane disulfonic anhydride. Examples of the carboxylic acid sulfonic acid anhydride may include a sulfobenzoic anhydride, a sulfopropionic anhydride, and a sulfobutyric anhydride. Although the content of the acid anhydride in the solvent is not particularly limited, for example, the content thereof may be from 0.5 wt % to 5 wt % both inclusive. However, specific examples of the acid anhydrides are not limited to the foregoing compounds.

In the case where the solvent contains a halogenated ester carbonate, each content of the halogenated ester carbonate and an unsaturated cyclic carbamate compound and the ratio between them may be preferably appropriate. Specifically, where the content of the halogenated ester carbonate in the electrolytic solution is A (wt %) and the content of the unsaturated cyclic carbamate compound in the electrolytic solution is B (wt %), three conditions that A is from 0.01 wt % to 40 wt % both inclusive, B is from 0.01 wt % to 10 wt % both inclusive, and B/A is from 0.00025 to 1000 both inclusive may be preferably satisfied at the same time. One reason for this is that, in this case, even if a secondary battery is repeatedly charged and discharged under load conditions (such as a high current), lowering of the discharge capacity is suppressed. Such a tendency is particularly significant in the case where a secondary battery is charged and discharged in strict temperature environment such as low temperature environment.

[Electrolyte Salt]

The electrolyte salt may contain, for example, one or more of salts such as a lithium salt. However, the electrolyte salt may contain, for example, a salt other than the lithium salt. Examples of “the salt other than the lithium salt” may include a light metal salt other than the lithium salt.

Examples of the lithium salts may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr). Thereby, a superior battery capacity, superior cycle characteristics, superior conservation characteristics, and the like are obtained. However, specific examples of the lithium salt are not limited to the foregoing compounds.

In particular, one or more of LiPF₆, LiBF₄, LiClO₄, and LiAsF₆ are preferable, and LiPF₆ is more preferable, since the internal resistance is thereby lowered, and therefore, a higher effect is obtained.

In particular, the electrolyte salt may preferably contain one or more of a compound represented by the following Formula (13), a compound represented by Formula (14), and a compound represented by Formula (15), since a higher effect is obtainable thereby. It is to be noted that R41 and R43 may be the same type of group, or may be groups different from each other. The same is applied to R51 to R53, R61, and R62. It is to be noted that specific examples of the compounds represented by Formula (13) to Formula (15) are not limited to the after-mentioned compounds.

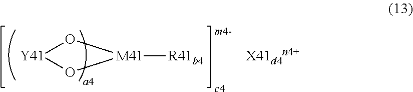

In Formula (13), X41 is one of Group 1 elements, Group 2 elements in the long-period periodic table, and aluminum. M41 is one of transition metals, Group 13 elements, Group 14 elements, and Group 15 elements in the long-period periodic table. R41 is a halogen group. Y41 is one of —C(═O)—R42-C(═O)—, —C(═O)—CR43₂-, and —C(═O)—C(═O)—. R42 is one of an alkylene group, a halogenated alkylene group, an arylene group, and a halogenated arylene group. R43 is one of an alkyl group, a halogenated alkyl group, an aryl group, and a halogenated aryl group. a4 is one of integer numbers 1 to 4 both inclusive. b4 is one of integer numbers 0, 2, and 4. Each of c4, d4, m4, and n4 is one of integer numbers 1 to 3 both inclusive.

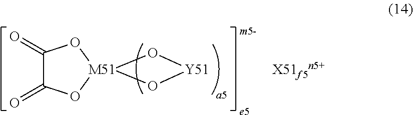

In Formula (14), X51 is one of Group 1 elements and Group 2 elements in the long-period periodic table. M51 is one of transition metals, Group 13 elements, Group 14 elements, and Group 15 elements in the long-period periodic table. Y51 is one of —C(═O)—(CR51₂)_{b5}-C(═O)—, —R53₂C—(CR52₂)_{c5}-C(═O)—, —R53₂C—(CR52₂)_{c5}-CR53₂—, —R53₂C—(CR52₂)_{c5}-S(═O)₂—, —S(═O)₂—(CR52₂)_{d5}-S(═O)₂—, and —C(═O)—(CR52₂)_{d5}-S(═O)₂—. Each of R51 and R53 is one of a hydrogen group, an alkyl group, a halogen group, and a halogenated alkyl group. One or more of R51 and R53 are each the halogen group or the halogenated alkyl group. R52 is one of a hydrogen group, an alkyl group, a halogen group, and a halogenated alkyl group. Each of a5, e5, and n5 is one of integer numbers 1 and 2. Each of b5 and d5 is one of integer numbers 1 to 4 both inclusive. c5 is one of integer numbers 0 to 4 both inclusive. Each of f5 and m5 is one of integer numbers 1 to 3 both inclusive.

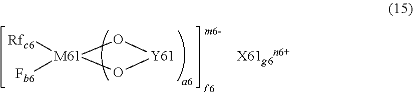

In Formula (15), X61 is one of Group 1 elements and Group 2 elements in the long-period periodic table. M61 is one of transition metals, Group 13 elements, Group 14 elements, and Group 15 elements in the long-period periodic table. Rf is one of a fluorinated alkyl group with carbon number from 1 to 10 both inclusive and a fluorinated aryl group with carbon number from 1 to 10 both inclusive. Y61 is one of —C(═O)—(CR61₂)_{d6}-C(═O)—, —R62₂C—(CR61₂)_{d6}-C(═O)—, —R62₂C—(CR61₂)_{d6}-CR62₂-, —R62₂C—(CR61₂)_{d6}-S(═O)₂—, —S(═O)₂—(CR61₂)ₑ₆-S(═O)₂—, and —C(═O)—(CR61₂)ₑ₆-S(═O)₂—. R61 is one of a hydrogen group, an alkyl group, a halogen group, and a halogenated alkyl group. R62 is one of a hydrogen group, an alkyl group, a halogen group, and a halogenated alkyl group, and one or more thereof are each a halogen group or a halogenated alkyl group. Each of a6, f6, and n6 is one of integer numbers 1 and 2. Each of b6, c6, and e6 is one of integer numbers 1 to 4 both inclusive. d6 is one of integer numbers 0 to 4 both inclusive. Each of g6 and m6 is one of integer numbers 1 to 3 both inclusive.

It is to be noted that Group 1 elements include H, Li, Na, K, Rb, Cs, and Fr. Group 2 elements include Be, Mg, Ca, Sr, Ba, and Ra. Group 13 elements include B, Al, Ga, In, and Tl. Group 14 elements include C, Si, Ge, Sn, and Pb. Group 15 elements include N, P, As, Sb, and Bi.

Examples of the compound represented by Formula (13) may include compounds represented by Formula (13-1) to Formula (13-6). Examples of the compound represented by Formula (14) may include compounds represented by Formula (14-1) to Formula (14-8). Examples of the compound represented by Formula (15) may include a compound represented by Formula (15-1).

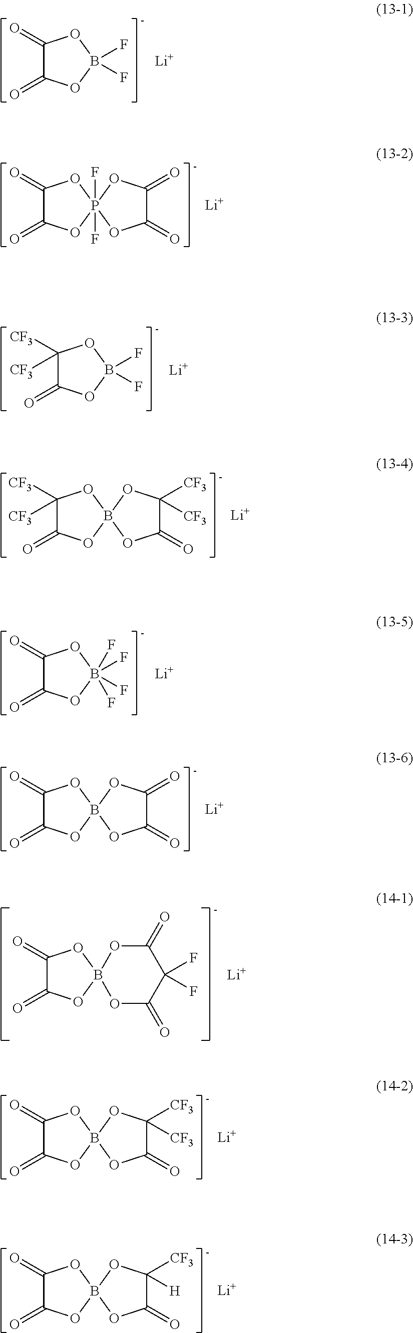

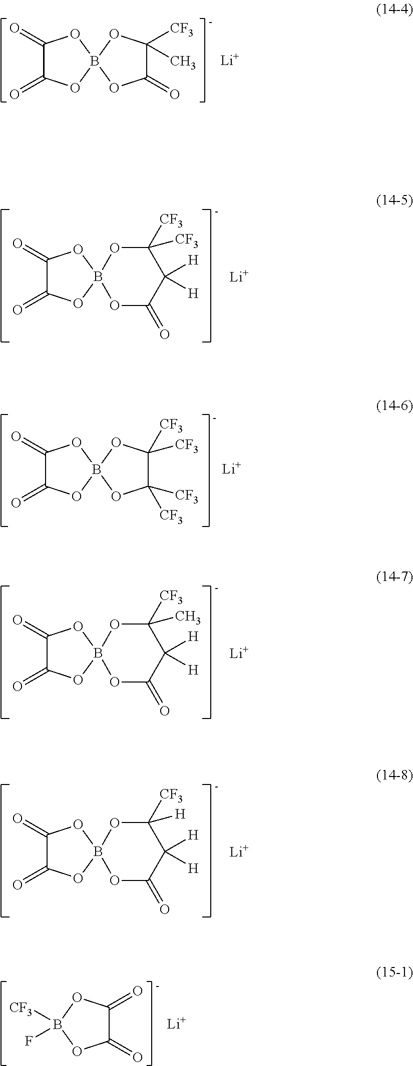

Further, the electrolyte salt may preferably contain one or more of a chain imide compound represented by the following Formula (16), a cyclic imide compound represented by Formula (17), and a chain methyde compound represented by Formula (18), since a higher effect is obtained thereby. It is to be noted that m and n may be the same value or values different from each other. The same is applied to p, q, and r. However, specific examples of the compounds represented by Formula (16) to Formula (18) are not limited to compounds described below.

LiN(CₘF₂ₘ₊₁SO₂)(CₙF₂ₙ₊₁SO₂). (16)

In Formula (16), each of m and n is an integer number equal to or greater than 1.

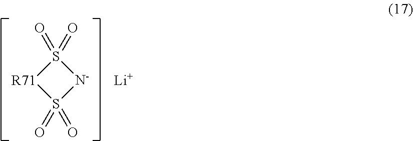

In Formula (17), R71 is a straight-chain or branched perfluoro alkylene group with carbon number from 2 to 4 both inclusive.

LiC(CₚF₂ₚ₊₁SO₂)(C_{q}F_{2q+1}SO₂)(CᵣF₂ᵣ₊₁SO₂). (18)

In Formula (18), each of p, q, and r is an integer number equal to or greater than 1.

Examples of the chain imide compound may include lithium bis(trifluoromethanesulfonyl)imide (LiN(CF₃SO₂)₂), lithium bis(pentafluoroethanesulfonyl)imide (LiN(C₂F₅SO₂)₂)₅ lithium (trifluoromethanesulfonyl)(pentafluoroethanesulfonyl)imide (LiN(CF₃SO₂)(C₂F₅SO₂)), lithium(trifluoromethanesulfonyl)(heptafluoropropanesulfonyl)imide (LiN(CF₃SO₂)(C₃F₇SO₂)), and lithium(trifluoromethanesulfonyl)(nonafluorobutanesulfonyl)imide (LiN(CF₃SO₂)(C₄F₉SO₂)).

Examples of the cyclic imide compound may include compounds represented by Formula (17-1) to Formula (17-4).

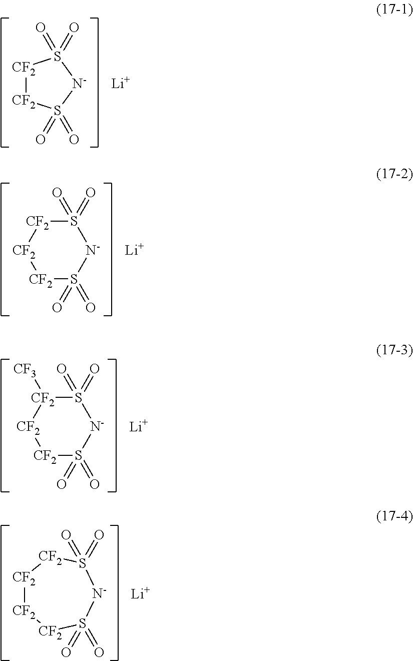

Examples of the chain methyde compound may include lithium tris(trifluoromethanesulfonyl)methyde (LiC(CF₃SO₂)₃).

Although the content of the electrolyte salt is not particularly limited, in particular, the content thereof may be preferably from 0.3 mol/kg to 3.0 mol/kg both inclusive with respect to the solvent, since high ion conductivity is obtained thereby.

[Operation of Secondary Battery]

The secondary battery may operate, for example, as follows. At the time of charge, lithium ions extracted from the cathode 21 are inserted in the anode 22 through the electrolytic solution. Further, at the time of discharge, lithium ions extracted from the anode 22 are inserted in the cathode 21 through the electrolytic solution.

[Method of Manufacturing Secondary Battery]

The secondary battery may be manufactured, for example, by the following procedure.

First, the cathode 21 is fabricated. A cathode active material is mixed with a cathode binder and/or the like as necessary to prepare a cathode mixture. Subsequently, the cathode mixture is dispersed in an organic solvent or the like to obtain paste cathode mixture slurry. Subsequently, both surfaces of the cathode current collector 21A are coated with the cathode mixture slurry, which is dried to form the cathode active material layer 21B. Subsequently, the cathode active material layer 21B is compression-molded by using a roll pressing machine and/or the like as necessary. In this case, compression-molding may be performed while heating the cathode active material layer 21B, or compression-molding may be repeated several times.

Further, the anode 22 is fabricated by a procedure similar to that of the cathode 21 described above. An anode active material is mixed with an anode binder and/or the like as necessary to prepare an anode mixture, which is subsequently dispersed in an organic solvent or the like to form paste anode mixture slurry. Subsequently, both surfaces of the anode current collector 22A are coated with the anode mixture slurry, which is dried to form the anode active material layer 22B. Thereafter, the anode active material layer 22B is compression-molded as necessary.

Further, after an electrolyte salt is dispersed in a solvent, an unsaturated cyclic carbamate compound is added thereto to prepare an electrolytic solution. In this case, a non-carbamate compound may be added to the electrolytic solution as necessary.

Finally, the secondary battery is assembled with the use of the cathode 21 and the anode 22. The cathode lead 25 is attached to the cathode current collector 21A with the use of a welding method and/or the like, and the anode lead 26 is attached to the anode current collector 22A with the use of a welding method and/or the like. Subsequently, the cathode 21 and the anode 22 are layered with the separator 23 in between and are spirally wound, and thereby, the spirally wound electrode body 20 is fabricated. Thereafter, the center pin 24 is inserted in the center of the spirally wound electrode body. Subsequently, the spirally wound electrode body 20 is sandwiched between the pair of insulating plates 12 and 13, and is contained in the battery can 11. In this case, the end tip of the cathode lead 25 is attached to the safety valve mechanism 15 with the use of a welding method and/or the like, and the end tip of the anode lead 26 is attached to the battery can 11 with the use of a welding method and/or the like. Subsequently, the electrolytic solution is injected into the battery can 11, and the separator 23 is impregnated with the electrolytic solution. Subsequently, at the open end of the battery can 11, the battery cover 14, the safety valve mechanism 15, and the PTC device 16 are fixed by being swaged with the gasket 17.

[Function and Effect of Secondary Battery]

According to the cylindrical-type secondary battery, the electrolytic solution contains the unsaturated cyclic carbamate compound. Therefore, as described above, a rigid film due to the unsaturated cyclic carbamate compound is formed mainly on the surface of the anode 22. Thereby, a decomposition reaction of the electrolytic solution is suppressed compared to a case that the electrolytic solution does not contain the unsaturated cyclic carbamate compound, or contains a saturated cyclic carbamate compound. The saturated cyclic carbamate compounds may be, for example, a cyclic (five-membered ring or six-membered ring) compound that has a carbamate bond and does not have an unsaturated bond (carbon-carbon double bond) as shown in the following Formula (19-1) or Formula (19-2). Therefore, even if the secondary battery is charged and discharged, or stored, the discharge capacity is less likely to be lowered, and accordingly, superior battery characteristics are obtainable.

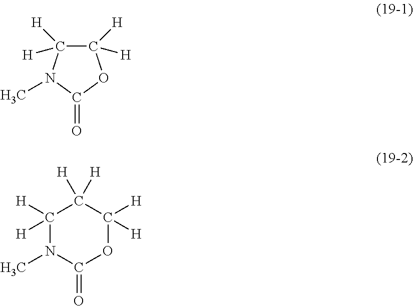

In particular, in the case where the unsaturated cyclic carbamate compound is one of the compounds represented by Formula (2-1) to Formula (2-2), more specifically, is one of the compounds represented by Formula (1-1) to Formula (1-37) or one of the compounds represented by Formula (1-40) to Formula (1-68), higher effects are obtainable. Further, in the case where the content of the unsaturated cyclic carbamate compound in the electrolytic solution is from 0.01 wt % to 20 wt % both inclusive, further higher effects are obtainable.

In addition thereto, in the case where the electrolytic solution contains a non-carbamate compound, higher effects are obtainable. In this case, in the case where the content of the non-carbamate compound in the electrolytic solution is from 0.001 wt % to 2 wt % both inclusive, further higher effects are obtainable.

Further, in the case where the solvent contains a halogenated ester carbonate, and the content A of the halogenated ester carbonate, the content B of the unsaturated cyclic carbamate compound, and the ratio B/A between them satisfy the prescribed conditions, even if the secondary battery is repeatedly charged and discharged under load conditions, the discharge capacity is less likely to be lowered, and accordingly, a higher effect is obtainable.

[1-2. Lithium Ion Secondary Battery (Laminated Film Type)]

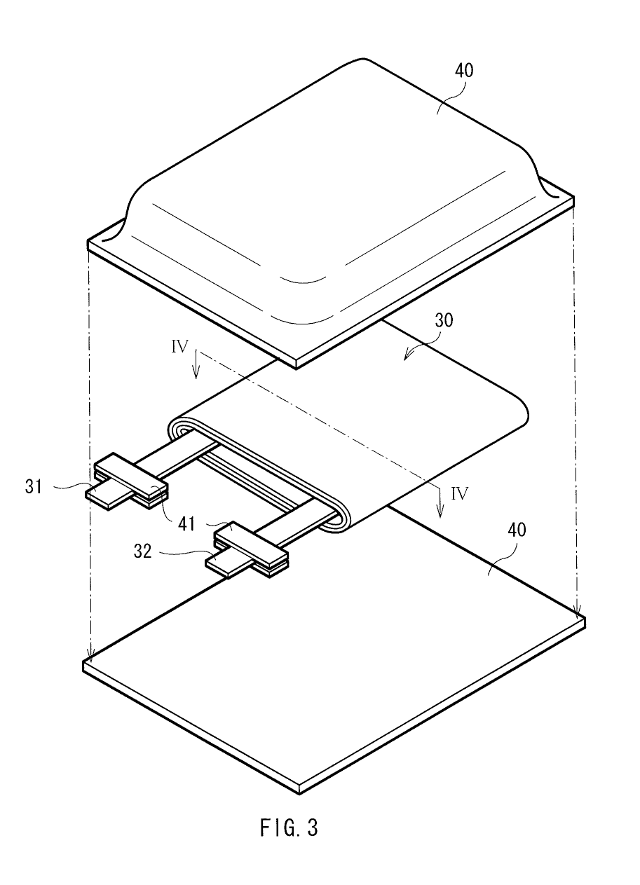

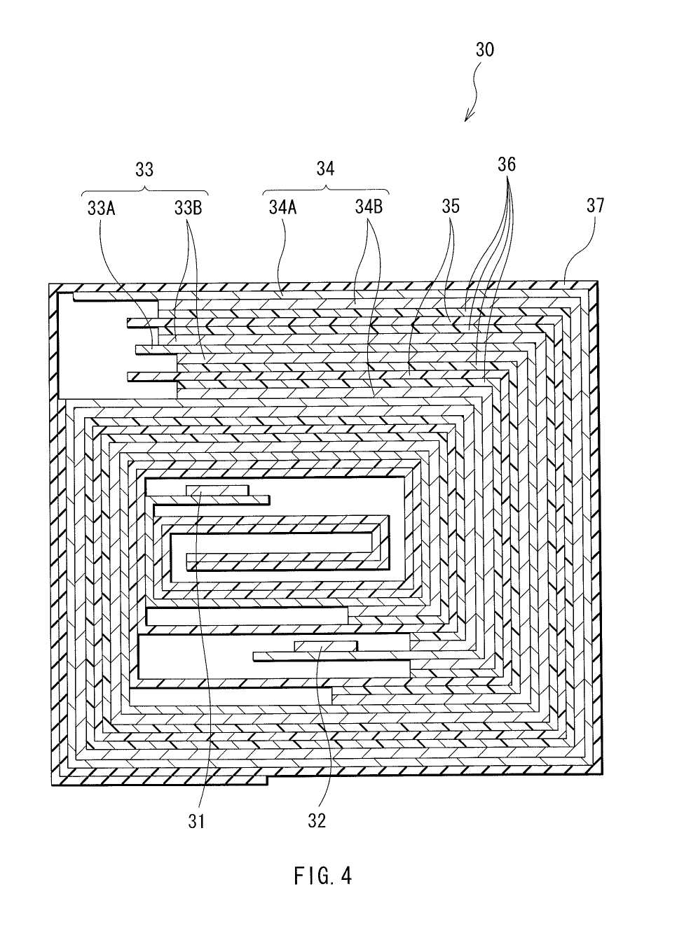

FIG. 3 illustrates an exploded perspective configuration of another secondary battery. FIG. 4 illustrates an enlarged cross-section taken along a line IV-IV of a spirally wound electrode body 30 illustrated in FIG. 3. In the following description, the elements of the cylindrical-type secondary battery described above will be used as necessary.

[Whole Configuration of Secondary Battery]

The secondary battery described here may be, for example, a so-called laminated-film-type lithium ion secondary battery. For example, in the secondary battery, the spirally wound electrode body 30 may be contained in a film-like outer package member 40. The spirally wound electrode body 30 is formed by laminating a cathode 33 and an anode 34 with a separator 35 and an electrolyte layer 36 in between, and subsequently spirally winding the resultant laminated body. A cathode lead 31 is attached to the cathode 33, and an anode lead 32 is attached to the anode 34. The outermost periphery of the spirally wound electrode body 30 is protected by a protective tape 37.

The cathode lead 31 and the anode lead 32 may be, for example, led out from inside to outside of the outer package member 40 in the same direction. The cathode lead 31 may be made of, for example, a conductive material such as aluminum, and the anode lead 32 may be made of, for example, a conducive material such as copper, nickel, and stainless steel. These conductive materials may be in the shape of, for example, a thin plate or mesh.

The outer package member 40 may be a laminated film in which, for example, a fusion bonding layer, a metal layer, and a surface protective layer are laminated in this order. The outer package member 40 may be formed by, for example, layering two laminated films so that the fusion bonding layers and the spirally wound electrode body 30 are opposed to each other, and subsequently fusion-bonding the respective outer edges of the fusion bonding layers to each other. Alternatively, the two laminated films may be attached to each other by an adhesive or the like. Examples of the fusion bonding layer may include a film made of polyethylene, polypropylene, or the like. Examples of the metal layer may include an aluminum foil. Examples of the surface protective layer may include a film made of nylon, polyethylene terephthalate, or the like.

In particular, as the outer package member 40, an aluminum laminated film in which a polyethylene film, an aluminum foil, and a nylon film are laminated in this order may be preferable. However, the outer package member 40 may be made of a laminated film having other laminated structure, a polymer film such as polypropylene, or a metal film.

An adhesive film 41 to protect from outside air intrusion is inserted between the outer package member 40 and the cathode lead 31 and between the outer package member 40 and the anode lead 32. The adhesive film 41 is made of a material having adhesion characteristics with respect to the cathode lead 31 and the anode lead 32. Examples of the material having adhesion characteristics may include a polyolefin resin. More specific examples thereof may include polyethylene, polypropylene, modified polyethylene, and modified polypropylene.

The cathode 33 may have, for example, a cathode active material layer 33B on a single surface or both surfaces of a cathode current collector 33A. The anode 34 may have, for example, an anode active material layer 34B on a single surface or both surfaces of an anode current collector 34A. The configurations of the cathode current collector 33A, the cathode active material layer 33B, the anode current collector 34A, and the anode active material layer 34B are similar to the configurations of the cathode current collector 21A, the cathode active material layer 21B, the anode current collector 22A, and the anode active material layer 22B, respectively. Further, the configuration of the separator 35 is similar to the configuration of the separator 23.

In the electrolyte layer 36, an electrolytic solution is held by a polymer compound. The electrolyte layer 36 is a so-called gel electrolyte, since thereby, high ion conductivity (for example, 1 mS/cm or more at room temperature) is obtained and liquid leakage of the electrolytic solution is prevented. The electrolyte layer 36 may contain other material such as an additive as necessary.

Examples of the polymer compound may include one or more of polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethacrylic acid methyl, polyacrylic acid, polymethacrylic acid, styrene-butadiene rubber, nitrile-butadiene rubber, polystyrene, polycarbonate, and a copolymer of vinylidene fluoride and hexafluoro propylene. In particular, polyvinylidene fluoride or the copolymer of vinylidene fluoride and hexafluoro propylene is preferable, and polyvinylidene fluoride is more preferable, since such a polymer compound is electrochemically stable.

The composition of the electrolytic solution is similar to the composition of the electrolytic solution of the cylindrical-type secondary battery. The electrolytic solution contains the foregoing unsaturated cyclic carbamate compound. However, in the electrolyte layer 36 as a gel electrolyte, the term “solvent” of the electrolytic solution refers to a wide concept including not only a liquid solvent but also a material having ion conductivity capable of dissociating the electrolyte salt. Therefore, in the case where a polymer compound having ion conductivity is used, the polymer compound is also included in the solvent.

It is to be noted that the electrolytic solution may be used as it is instead of the gel electrolyte layer 36. In this case, the separator 35 is impregnated with the electrolytic solution.

[Operation of Secondary Battery]

The secondary battery operates, for example, as follows. At the time of charge, lithium ions extracted from the cathode 33 are inserted in the anode 34 through the electrolyte layer 36. On the other hand, at the time of discharge, lithium ions extracted from the anode 34 are inserted in the cathode 33 through the electrolyte layer 36.

[Method of Manufacturing Secondary Battery]

The secondary battery including the gel electrolyte layer 36 may be manufactured, for example, by the following three types of procedures.

In the first procedure, the cathode 33 and the anode 34 are fabricated by a fabrication procedure similar to that of the cathode 21 and the anode 22. In forming the cathode 33, the cathode active material layer 33B is formed on both surfaces of the cathode current collector 33A. In forming the anode 34, the anode active material layer 34B is formed on both surfaces of the anode current collector 34A. Subsequently, a precursor solution including an electrolytic solution, a polymer compound, and a solvent such as an organic solvent is prepared. Thereafter, the cathode 33 and the anode 34 are coated with the precursor solution to form the gel electrolyte layer 36. Subsequently, the cathode lead 31 is attached to the cathode current collector 33A by using a welding method and/or the like, and the anode lead 32 is attached to the anode current collector 34A by using a welding method and/or the like similarly. Subsequently, the cathode 33 and the anode 34 are layered with the separator 35 in between and are spirally wound to fabricate the spirally wound electrode body 30. Thereafter, the protective tape 37 is adhered to the outermost periphery thereof. Subsequently, after the spirally wound electrode body 30 is sandwiched between two pieces of film-like outer package members 40, the outer edges of the outer package members 40 are bonded with the use of a thermal fusion bonding method and/or the like. Thereby, the spirally wound electrode body 30 is enclosed into the outer package members 40. In this case, the adhesive films 41 are inserted between the cathode lead 31 and the outer package member 40 and between the anode lead 32 and the outer package member 40.

In the second procedure, the cathode lead 31 is attached to the cathode 33, and the anode lead 32 is attached to the anode 34. Subsequently, the cathode 33 and the anode 34 are layered with the separator 35 in between and are spirally wound to fabricate a spirally wound body as a precursor of the spirally wound electrode body 30. Thereafter, the protective tape 37 is adhered to the outermost periphery thereof. Subsequently, after the spirally wound body is sandwiched between two pieces of the film-like outer package members 40, the outermost peripheries except for one side are bonded with the use of a thermal fusion bonding method and/or the like to obtain a pouched state, and the spirally wound body is contained in the pouch-like outer package member 40. Subsequently, an electrolytic solution, a monomer as a raw material for the polymer compound, a polymerization initiator, and other materials such as a polymerization inhibitor as necessary are mixed to prepare a composition for electrolyte. Subsequently, the composition for electrolyte is injected into the pouch-like outer package member 40. Thereafter, the outer package member 40 is hermetically sealed with the use of a thermal fusion bonding method and/or the like. Subsequently, the monomer is thermally polymerized, and thereby, a polymer compound is formed. Accordingly, the polymer compound is impregnated with the electrolytic solution, the polymer compound gelates, and accordingly, the electrolyte layer 36 is formed.

In the third procedure, the spirally wound body is fabricated and contained in the pouch-like outer package member 40 in a manner similar to that of the foregoing second procedure, except that the separator 35 with both surfaces coated with a polymer compound is used. Examples of the polymer compound with which the separator 35 is coated may include a polymer (a homopolymer, a copolymer, or a multicomponent copolymer) containing vinylidene fluoride as a component. Specific examples of the homopolymer may include polyvinylidene fluoride. Specific examples of the copolymer may include a binary copolymer containing vinylidene fluoride and hexafluoro propylene as components. Specific examples of the multicomponent copolymer may include a ternary copolymer containing vinylidene fluoride, hexafluoro propylene, and chlorotrifluoroethylene as components. It is to be noted that, in addition to the polymer containing vinylidene fluoride as a component, other one or more polymer compounds may be used. Subsequently, an electrolytic solution is prepared and injected into the outer package member 40. Thereafter, the opening of the outer package member 40 is hermetically sealed with the use of a thermal fusion bonding method and/or the like. Subsequently, the resultant is heated while a weight is applied to the outer package member 40, and the separator 35 is adhered to the cathode 33 and the anode 34 with the polymer compound in between. Thereby, the polymer compound is impregnated with the electrolytic solution, and accordingly, the polymer compound is gelated to form the electrolyte layer 36.

In the third procedure, swollenness of the secondary battery is suppressed more than in the first procedure. Further, in the third procedure, the monomer as a raw material of the polymer compound, the solvent, and the like are less likely to be left in the electrolyte layer 36 compared to in the second procedure. Therefore, the formation step of the polymer compound is favorably controlled. Therefore, the cathode 33, the anode 34, and the separator 35 sufficiently adhere to the electrolyte layer 36.

[Function and Effect of Secondary Battery]

According to the laminated-film-type secondary battery, the electrolytic solution of the electrolyte layer 36 contains the unsaturated cyclic carbamate compound. Therefore, for a reason similar to that of the cylindrical-type secondary battery described above, superior battery characteristics are obtainable. Other functions and other effects are similar to those of the cylindrical-type secondary battery.

[1-3. Lithium Metal Secondary Battery (Cylindrical Type and Laminated Film Type)]

A secondary battery described here is a lithium secondary battery (lithium metal secondary battery) in which the capacity of the anode 22 is represented by precipitation and dissolution of lithium metal. The secondary battery has a configuration similar to that of the foregoing lithium ion secondary battery (cylindrical-type lithium ion secondary battery), except that the anode active material layer 22B is configured of the lithium metal, and is manufactured by a procedure similar to that of the lithium ion secondary battery (cylindrical-type lithium ion secondary battery).

In the secondary battery, the lithium metal is used as an anode active material, and thereby, higher energy density is obtainable. The anode active material layer 22B may exist at the time of assembling, or the anode active material layer 22B does not necessarily exist at the time of assembling and may be configured of the lithium metal precipitated at the time of charge. Further, the anode active material layer 22B may be used as a current collector, and thereby, the anode current collector 22A may be omitted.

The secondary battery operates, for example, as follows. At the time of charge, lithium ions are discharged from the cathode 21, and are precipitated as the lithium metal on the surface of the anode current collector 22A through the electrolytic solution. On the other hand, at the time of discharge, the lithium metal is eluded as lithium ions from the anode active material layer 22B, and is inserted in the cathode 21 through the electrolytic solution.

According to the lithium metal secondary battery, the electrolytic solution contains the unsaturated cyclic carbamate compound. Therefore, for a reason similar to that of the lithium ion secondary battery, superior battery characteristics are obtainable. Other functions and other effects are similar to those of the lithium ion secondary battery. It is to be noted that the foregoing lithium metal secondary battery is not limited to the cylindrical-type secondary battery, and may be a laminated-film-type secondary battery. In that case, a similar effect is obtainable as well.

[2. Applications of Secondary Battery]

Next, a description will be given of application examples of the foregoing secondary battery.

Applications of the secondary battery are not particularly limited as long as the secondary battery is applied to a machine, a device, an instrument, an apparatus, a system (collective entity of a plurality of devices and the like), or the like that is allowed to use the secondary battery as a driving electric power source, an electric power storage source for electric power storage, or the like. It is to be noted that the secondary battery used as an electric power source may be a main electric power source (electric power source used preferentially), or may be an auxiliary electric power source (electric power source used instead of a main electric power source or used being switched from the main electric power source). In the latter case, the main electric power source type is not limited to the secondary battery.

Examples of applications of the secondary battery may include electronic apparatuses (including portable electronic apparatuses) such as a video camcorder, a digital still camera, a mobile phone, a notebook personal computer, a cordless phone, a headphone stereo, a portable radio, a portable television, and a personal digital assistant. Further examples thereof may include a mobile lifestyle electric appliance such as an electric shaver; a memory device such as a backup electric power source and a memory card; an electric power tool such as an electric drill and an electric saw; a battery pack used for a notebook personal computer or the like as an attachable and detachable electric power source; a medical electronic apparatus such as a pacemaker and a hearing aid; an electric vehicle such as an electric automobile (including a hybrid automobile); and an electric power storage system such as a home battery system for storing electric power for emergency or the like. It goes without saying that an application other than the foregoing applications may be adopted.

In particular, the secondary battery is effectively applicable to the battery pack, the electric vehicle, the electric power storage system, the electric power tool, the electronic apparatus, or the like. One reason for this is that, in these applications, since superior battery characteristics are demanded, performance is effectively improved with the use of the secondary battery according to the embodiment of the present application. It is to be noted that the battery pack is an electric power source using a secondary battery, and is a so-called assembled battery or the like. The electric vehicle is a vehicle that works (runs) with the use of a secondary battery as a driving electric power source. As described above, the electric vehicle may be an automobile (such as a hybrid automobile) including a drive source other than a secondary battery. The electric power storage system is a system using a secondary battery as an electric power storage source. For example, in a home electric power storage system, electric power is stored in the secondary battery as an electric power storage source, and the electric power is consumed as necessary. Thereby, home electric products and the like become usable. The electric power tool is a tool in which a movable section (such as a drill) is moved with the use of a secondary battery as a driving electric power source. The electronic apparatus is an apparatus executing various functions with the use of a secondary battery as a driving electric power source (electric power supply source).

A description will be specifically given of some application examples of the secondary battery. The configurations of the respective application examples explained below are merely examples, and may be changed as appropriate.

[2-1. Battery Pack]

FIG. 5 illustrates a block configuration of a battery pack. For example, the battery pack may include a control section 61, an electric power source 62, a switch section 63, a current measurement section 64, a temperature detection section 65, a voltage detection section 66, a switch control section 67, a memory 68, a temperature detection device 69, a current detection resistance 70, a cathode terminal 71, and an anode terminal 72 in a housing 60 made of a plastic material and/or the like.

The control section 61 controls operation of the whole battery pack (including a used state of the electric power source 62), and may include, for example, a central processing unit (CPU) and/or the like. The electric power source 62 includes one or more secondary batteries (not illustrated). The electric power source 62 may be, for example, an assembled battery including two or more secondary batteries. Connection type of these secondary batteries may be a series-connected type, may be a parallel-connected type, or a mixed type thereof. As an example, the electric power source 62 may include six secondary batteries connected in a manner of dual-parallel and three-series.

The switch section 63 switches the used state of the electric power source 62 (whether or not the electric power source 62 is connectable to an external device) according to an instruction of the control section 61. The switch section 63 may include, for example, a charge control switch, a discharge control switch, a charging diode, a discharging diode, and the like (not illustrated). The charge control switch and the discharge control switch may each be, for example, a semiconductor switch such as a field-effect transistor (MOSFET) using a metal oxide semiconductor.

The current measurement section 64 measures a current with the use of the current detection resistance 70, and outputs the measurement result to the control section 61. The temperature detection section 65 measures temperature with the use of the temperature detection device 69, and outputs the measurement result to the control section 61. The temperature measurement result may be used for, for example, a case in which the control section 61 controls charge and discharge at the time of abnormal heat generation or a case in which the control section 61 performs a correction processing at the time of calculating a remaining capacity. The voltage detection section 66 measures a voltage of the secondary battery in the electric power source 62, performs analog-to-digital conversion (A/D conversion) on the measured voltage, and supplies the resultant to the control section 61.

The switch control section 67 controls operations of the switch section 63 according to signals inputted from the current measurement section 64 and the voltage detection section 66.

The switch control section 67 executes control so that a charging current is prevented from flowing in a current path of the electric power source 62 by disconnecting the switch section 63 (charge control switch) in the case where, for example, a battery voltage reaches an overcharge detection voltage. Thereby, in the electric power source 62, only discharge is allowed to be performed through the discharging diode. It is to be noted that, for example, in the case where a large current flows at the time of charge, the switch control section 67 blocks the charging current.

It is to be noted that, in the secondary battery, for example, the overcharge detection voltage may be 4.20 V±0.05 V, and the over-discharge detection voltage may be 2.4 V±0.1 V.

The memory 68 may be, for example, an EEPROM as a nonvolatile memory. The memory 68 may store, for example, numerical values calculated by the control section 61 and information of the secondary battery measured in a manufacturing step (such as an internal resistance in the initial state). It is to be noted that, in the case where the memory 68 stores a full charge capacity of the secondary battery, the control section 61 is allowed to comprehend information such as a remaining capacity.

The temperature detection device 69 measures temperature of the electric power source 62, and outputs the measurement result to the control section 61. The temperature detection device 69 may be, for example, a thermistor or the like.

The cathode terminal 71 and the anode terminal 72 are terminals connected to an external device (such as a notebook personal computer) driven using the battery pack or an external device (such as a battery charger) used for charging the battery pack. The electric power source 62 is charged and discharged through the cathode terminal 71 and the anode terminal 72.

[2-2. Electric Vehicle]

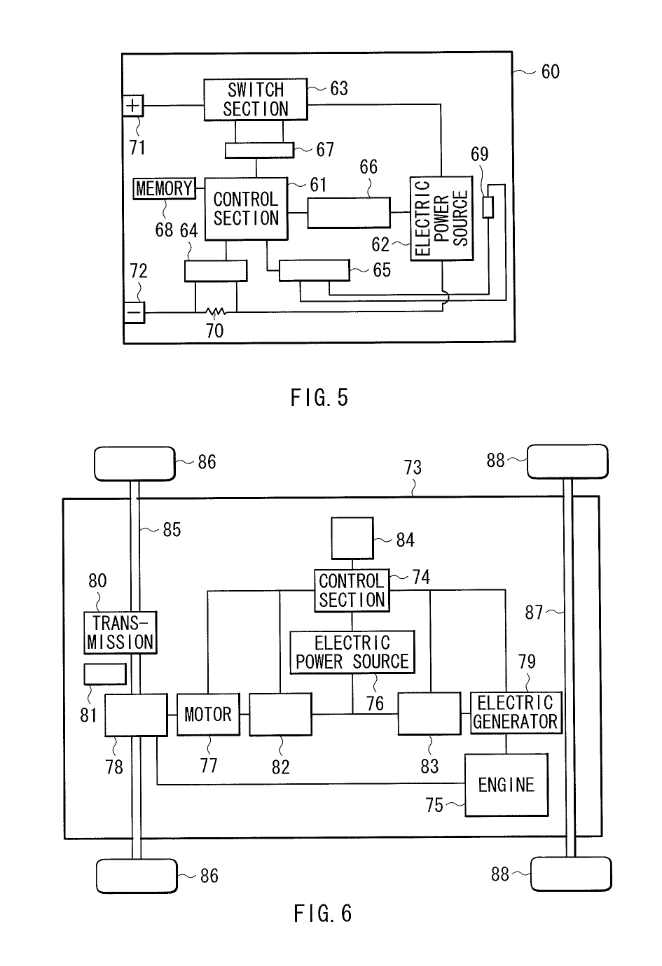

FIG. 6 illustrates a block configuration of a hybrid automobile as an example of electric vehicles. For example, the electric vehicle may include a control section 74, an engine 75, an electric power source 76, a driving motor 77, a differential 78, an electric generator 79, a transmission 80, a clutch 81, inverters 82 and 83, and various sensors 84 in a housing 73 made of metal. In addition thereto, the electric vehicle may include, for example, a front drive shaft 85 and a front tire 86 that are connected to the differential 78 and the transmission 80, a rear drive shaft 87, and a rear tire 88.

The electric vehicle is runnable by using one of the engine 75 and the motor 77 as a drive source. The engine 75 is a main power source, and may be, for example, a petrol engine. In the case where the engine 75 is used as a power source, drive power (torque) of the engine 75 may be transferred to the front tire 86 or the rear tire 88 through the differential 78, the transmission 80, and the clutch 81 as drive sections, for example. The torque of the engine 75 may also be transferred to the electric generator 79. Due to the torque, the electric generator 79 generates alternating-current electric power. The alternating-current electric power is converted into direct-current electric power through the inverter 83, and the converted power is stored in the electric power source 76. On the other hand, in the case where the motor 77 as a conversion section is used as a power source, electric power (direct-current electric power) supplied from the electric power source 76 is converted into alternating-current electric power through the inverter 82. The motor 77 may be driven by the alternating-current electric power. Drive power (torque) obtained by converting the electric power by the motor 77 is transferred to the front tire 86 or the rear tire 88 through the differential 78, the transmission 80, and the clutch 81 as the drive sections, for example.

It is to be noted that, alternatively, the following mechanism may be adopted. In the mechanism, when speed of the electric vehicle is reduced by an unillustrated brake mechanism, the resistance at the time of speed reduction is transferred to the motor 77 as torque, and the motor 77 generates alternating-current electric power by the torque. It is preferable that the alternating-current electric power be converted to direct-current electric power through the inverter 82, and the direct-current regenerative electric power be stored in the electric power source 76.

The control section 74 controls operations of the whole electric vehicle, and, for example, may include a CPU and/or the like. The electric power source 76 includes one or more secondary batteries (not illustrated). Alternatively, the electric power source 76 may be connected to an external electric power source, and electric power may be stored in the electric power source 76 by receiving the electric power from the external electric power source. The various sensors 84 may be used, for example, for controlling the number of revolutions of the engine 75 or for controlling opening level (throttle opening level) of an unillustrated throttle valve. The various sensors 84 may include, for example, a speed sensor, an acceleration sensor, an engine frequency sensor, and/or the like.

The description has been given above of the hybrid automobile as an electric vehicle. However, examples of the electric vehicles may include a vehicle (electric automobile) working with the use of only the electric power source 76 and the motor 77 without using the engine 75.

[2-3. Electric Power Storage System]

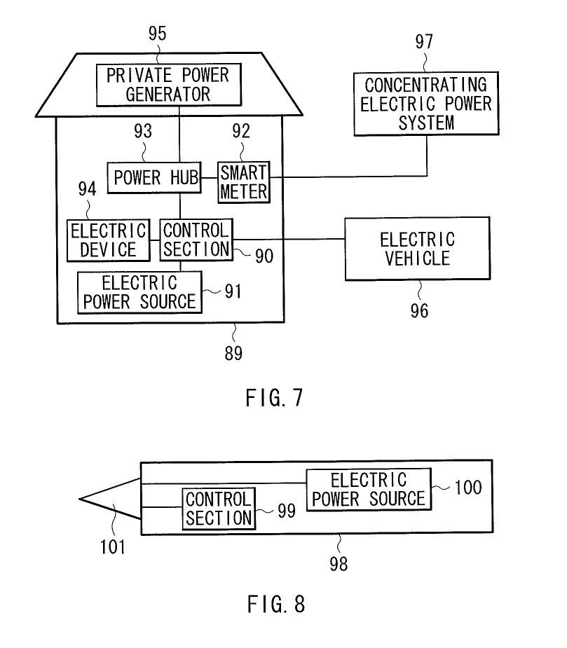

FIG. 7 illustrates a block configuration of an electric power storage system. For example, the electric power storage system may include a control section 90, an electric power source 91, a smart meter 92, and a power hub 93 inside a house 89 such as a general residence and a commercial building.

In this case, the electric power source 91 may be connected to, for example, an electric device 94 arranged inside the house 89, and may be connected to an electric vehicle 96 parked outside the house 89. Further, for example, the electric power source 91 may be connected to a private power generator 95 arranged inside the house 89 through the power hub 93, and may be connected to an external concentrating electric power system 97 thorough the smart meter 92 and the power hub 93.

It is to be noted that the electric device 94 may include, for example, one or more home electric appliances such as a refrigerator, an air conditioner, a television, and a water heater. The private power generator 95 may be, for example, one or more of a solar power generator, a wind-power generator, and the like. The electric vehicle 96 may be, for example, one or more of an electric automobile, an electric motorcycle, a hybrid automobile, and the like. The concentrating electric power system 97 may be, for example, one or more of a thermal power plant, an atomic power plant, a hydraulic power plant, a wind-power plant, and the like.

The control section 90 controls operation of the whole electric power storage system (including a used state of the electric power source 91), and, for example, may include a CPU and/or the like. The electric power source 91 includes one or more secondary batteries (not illustrated). The smart meter 92 may be, for example, an electric power meter compatible with a network arranged in the house 89 demanding electric power, and may be communicable with an electric power supplier. Accordingly, for example, while the smart meter 92 communicates with outside as necessary, the smart meter 92 controls the balance between supply and demand in the house 89 and allows effective and stable energy supply.

In the electric power storage system, for example, electric power may be stored in the electric power source 91 from the concentrating electric power system 97 as an external electric power source through the smart meter 92 and the power hub 93, and electric power may be stored in the electric power source 91 from the private power generator 95 as an independent electric power source through the power hub 93. As necessary, the electric power stored in the electric power source 91 is supplied to the electric device 94 or to the electric vehicle 96 according to an instruction of the control section 90. Therefore, the electric device 94 becomes operable, and the electric vehicle 96 becomes chargeable. That is, the electric power storage system is a system capable of storing and supplying electric power in the house 89 with the use of the electric power source 91.

The electric power stored in the electric power source 91 is arbitrarily usable. Therefore, for example, electric power is allowed to be stored in the electric power source 91 from the concentrating electric power system 97 in the middle of the night when an electric rate is inexpensive, and the electric power stored in the electric power source 91 is allowed to be used during daytime hours when an electric rate is expensive.

The foregoing electric power storage system may be arranged for each household (family unit), or may be arranged for a plurality of households (family units).

[2-4. Electric Power Tool]

FIG. 8 illustrates a block configuration of an electric power tool. For example, the electric power tool may be an electric drill, and may include a control section 99 and an electric power source 100 in a tool body 98 made of a plastic material and/or the like. For example, a drill section 101 as a movable section may be attached to the tool body 98 in an operable (rotatable) manner.

The control section 99 controls operations of the whole electric power tool (including a used state of the electric power source 100), and may include, for example, a CPU and/or the like. The electric power source 100 includes one or more secondary batteries (not illustrated). The control section 99 allows electric power to be supplied from the electric power source 100 to the drill section 101 as necessary according to operation of an unillustrated operation switch to operate the drill section 101.

### EXAMPLES

Specific Examples according to the embodiment of the present application will be described in detail.

### Examples 1-1 to 1-16

The cylindrical-type lithium ion secondary battery illustrated in FIG. 1 and FIG. 2 was fabricated by the following procedure.

Upon fabricating the cathode 21, first, lithium carbonate (Li₂CO₃) and cobalt carbonate (CoCO₃) were mixed at a molar ratio of Li₂CO₃:CoCO₃=0.5:1. Subsequently, the mixture was fired in the air at 900 deg C. for 5 hours. Thereby, lithium-cobalt composite oxide (LiCoO₂) was obtained. Subsequently, 91 parts by mass of a cathode active material (LiCoO₂), 3 parts by mass of a cathode binder (polyvinylidene fluoride: PVDF), and 6 parts by mass of a cathode electric conductor (graphite) were mixed to obtain a cathode mixture. Subsequently, the cathode mixture was dispersed in an organic solvent (N-methyl-2-pyrrolidone: NMP) to obtain paste cathode mixture slurry. Subsequently, both surfaces of the cathode current collector 21A in the shape of a strip (aluminum foil being 20 μm thick) were coated with the cathode mixture slurry uniformly with the use of a coating device, which was dried to form the cathode active material layer 21B. Finally, the cathode active material layer 21B was compression-molded with use of a roll pressing machine.

Upon fabricating the anode 22, first, 90 parts by mass of an anode active material (artificial graphite) and 10 parts by mass of an anode binder (PVDF) were mixed to obtain an anode mixture. Subsequently, the anode mixture was dispersed in an organic solvent (NMP) to obtain paste anode mixture slurry. Subsequently, both surfaces of the anode current collector 22A in the shape of a strip (electrolytic copper foil being 15 μm thick) were coated with the anode mixture slurry uniformly with the use of a coating device, which was dried to form the anode active material layer 22B. Finally, the anode active material layer 22B was compression-molded with the use of a roll pressing machine.

Upon preparing an electrolytic solution, an electrolyte salt (LiPF₆) was dissolved in a solvent (ethylene carbonate (EC) and dimethyl carbonate (DMC)). Thereafter, as illustrated in Table 1, a carbamate compound (unsaturated cyclic carbamate compound) was added thereto. In this case, the composition of the solvent was EC:DMC=50:50 at a weight ratio, and the content of the electrolyte salt with respect to the solvent was 1 mol/kg. It is to be noted that, for comparison, other carbamate compounds (unsaturated cyclic carbamate compounds) represented by Formula (19-1) and Formula (19-2) were used as well.

Upon assembling the secondary battery, first, the cathode lead 25 made of aluminum was welded to the cathode current collector 21A, and the anode lead 26 made of nickel was welded to the anode current collector 22A. Subsequently, the cathode 21 and the anode 22 were layered with the separator 23(microporous polypropylene film being 25 μm thick) in between and were spirally wound. Thereafter, the winding end section of the spirally wound body was fixed with the use of an adhesive tape to fabricate the spirally wound electrode body 20. Subsequently, the center pin 24 was inserted in the center of the spirally wound electrode body 20. Subsequently, while the spirally wound electrode body 20 was sandwiched between the pair of insulating plates 12 and 13, the spirally wound electrode body 20 was contained in the battery can 11 made of iron and plated with nickel. In this case, one end of the cathode lead 25 was welded to the safety valve mechanism 15, and one end of the anode lead 26 was welded to the battery can 11. Subsequently, the electrolytic solution was injected into the battery can 11 by a depressurization method, and the separator 23 was impregnated with the electrolytic solution. Finally, at the open end of the battery can 11, the battery cover 14, the safety valve mechanism 15, and the PTC device 16 were fixed by being swaged with the gasket 17. The cylindrical-type secondary battery was thereby completed. It is to be noted that, upon fabricating the secondary battery, the thickness of the cathode active material layer 21B was adjusted so that lithium metal was not precipitated on the anode 22 at the time of full charge.

Various characteristics (cycle characteristics and conservation characteristics) of the secondary battery were examined. Results illustrated in Table 1 were obtained.

Upon examining the cycle characteristics, one cycle of charge and discharge was performed on the secondary battery in the ambient temperature environment (23 deg C.) in order to stabilize the battery state. Thereafter, another one cycle of charge and discharge was performed on the secondary battery in the same environment, and a discharge capacity was measured. Subsequently, the secondary battery was repeatedly charged and discharged until the total number of cycles reached 300 in the same environment, and a discharge capacity was measured. From these results, cycle retention ratio (%)=(discharge capacity at the 300th cycle/discharge capacity at the second cycle)×100 was calculated. At the time of charge, charge was performed at a current of 0.2 C until the upper limit voltage reached 4.2 V, and further charge was performed at a constant voltage of 4.2 V until the current reached 0.05 C. At the time of discharge, discharge was performed at a constant current of 0.2 C until the voltage reached the final voltage of 2.5 V. “0.2 C” and “0.05 C” are current values at which the respective battery capacities (theoretical capacities) are fully discharged in 5 hours and 20 hours.

Upon examining the conservation characteristics, a secondary battery with the battery state being stabled by a procedure similar to that of the case examining the cycle characteristics was used. One cycle of charge and discharge was performed on the secondary battery in the ambient temperature environment (23 deg C.) to measure the discharge capacity. Subsequently, the secondary battery in a state of being charged again was stored in a constant temperature bath (80 deg C.) for 10 days. Thereafter, the secondary battery was discharged in the ambient temperature environment (23 deg C.) to measure the discharge capacity. From the result, conservation retention ratio (%)=(discharge capacity after storage/discharge capacity before storage)×100 was calculated. Charge and discharge conditions were similar to those in the case of examining the cycle characteristics.

TABLE 1
Anode active material: artificial graphite

| | | | | | | Con- |
|---|---|---|---|---|---|---|
| | | | Carbamate | | Cycle | servation |
| | | | compound | | retention | retention |
| Exam- | Electrolyte | | | Content | ratio | ratio |
| ple | salt | Solvent | Type | (Wt %) | (%) | (%) |
| 1-1 | LiPF₆ | EC + | Formula | 5 | 81 | 82 |
| | | DMC | (1-6) | | | |
| 1-2 | | | Formula | | 82 | 83 |
| | | | (1-9) | | | |
| 1-3 | | | Formula | | 83 | 84 |
| | | | (1-16) | | | |
| 1-4 | | | Formula | 0.01 | 72 | 82 |
| 1-5 | | | (1-26) | 0.1 | 76 | 82 |
| 1-6 | | | | 0.5 | 81 | 84 |
| 1-7 | | | | 1 | 83 | 84 |
| 1-8 | | | | 2 | 83 | 84 |
| 1-9 | | | | 5 | 84 | 84 |
| 1-10 | | | | 10 | 83 | 82 |
| 1-11 | | | | 20 | 82 | 82 |
| 1-12 | | | Formula | 5 | 84 | 84 |
| | | | (1-28) | | | |
| 1-13 | | | Formula | | 81 | 82 |
| | | | (1-40) | | | |
| 1-14 | LiPF₆ | EC + | — | — | 66 | 81 |
| 1-15 | | DMC | Formula | 5 | 60 | 75 |
| | | | (19-1) | | | |
| 1-16 | | | Formula | | 55 | 70 |
| | | | (19-2) | | | |

In the case where the carbon material (artificial graphite) was used as an anode active material, the battery characteristics were largely changed according to presence or absence of the carbamate compound in the electrolytic solution.

More specifically, with reference to the case not using the carbamate compound (Example 1-14), the following tendency was found. In the case where the carbamate compound did not have an unsaturated bond (carbon-carbon double bond) (Examples 1-15 and 1-16), the cycle retention ratio and the conservation retention ratio were decreased. On the other hand, in the case where the carbamate compound had the unsaturated bond (Examples 1-1 to 1-13), the cycle retention ratio and the conservation retention ratio were increased.

The foregoing result shows the following. That is, in the case where the carbamate compound does not have an unsaturated bond, a decomposition reaction of the electrolytic solution is not sufficiently suppressed. Therefore, in this case, if charge and discharge are repeated and the secondary battery is stored, the discharge capacity is easily lowered. One reason for this may be that, in this case, at the time of charge and discharge, a film due to the carbamate compound is less likely to be formed. On the other hand, in the case where the carbamate compound has an unsaturated bond, a decomposition reaction of the electrolytic solution is specifically suppressed. Therefore, in this case, even if charge and discharge are repeated and the secondary battery is stored, the discharge capacity is less likely to be lowered. One reason for this may be that, in this case, at the time of charge and discharge, a film due to the carbamate compound is easily formed. As a result, in order to effectively suppress a decomposition reaction of the electrolytic solution, the unsaturated cyclic carbamate compound should be used instead of the saturated cyclic carbamate compound.

In particular, in the case where the unsaturated cyclic carbamate compound was used, if the content of the unsaturated cyclic carbamate compound in the electrolytic solution was from 0.01 wt % to 20 wt % both inclusive, a high cycle retention ratio and a high conservation retention ratio were obtained.

### Examples 2-1 to 2-17

Secondary batteries were fabricated by a procedure similar to those of Examples 1-1 to 1-14, except that a non-carbamate compound was added to an electrolytic solution as illustrated in Table 2, and the respective characteristics were examined.

In this case, as necessary, as a solvent (halogenated ester carbonate), 4-fluoro-1,3-dioxolane-2-one (FEC), trans-4,5-difluoro-1,3-dioxolane-2-one (t-DFEC), or bis(fluoromethyl)carbonate (DFDMC) was used. The content of FEC, t-DFEC, or DFDMC in the solvent was 5 wt %.

TABLE 2
Anode active material: artificial graphite

| | | | Carbamate | | Non-carbamate | | Cycle | Conservation |
|---|---|---|---|---|---|---|---|---|
| | | | compound | | compound | | retention | retention |
| | Electrolyte | | | Content | | Content | ratio | ratio |
| Example | salt | Solvent | Type | (Wt %) | Type | (Wt %) | (%) | (%) |
| 2-1 | LiPF₆ | EC + DMC | Formula | 2 | Formula | 0.2 | 85 | 89 |
| | | | (1-26) | | (3-1) | | | |
| 2-2 | | | | | Formula | | 85 | 88 |
| | | | | | (4-1) | | | |
| 2-3 | | | | | Formula | | 87 | 90 |
| | | | | | (5-1) | | | |
| 2-4 | | | | | LiPF₂O₂ | 0.001 | 85 | 88 |
| 2-5 | | | | | | 0.1 | 86 | 89 |
| 2-6 | | | | | | 0.2 | 86 | 90 |
| 2-7 | | | | | | 1 | 86 | 88 |
| 2-8 | | | | | | 2 | 85 | 88 |
| 2-9 | | | | | Li₂PFO₃ | 0.2 | 86 | 90 |

| | | | | | | |
|---|---|---|---|---|---|---|
| 2-10 | EC + | FEC | LiPF₂O₂ | 0.2 | 88 | 90 |
| 2-11 | DMC | t-DFEC | | | 88 | 90 |
| 2-12 | | DFDMC | | | 87 | 88 |

| | | | | | | | | |
|---|---|---|---|---|---|---|---|---|
| 2-13 | LiPF₆ | EC + DMC | — | — | Formula | 0.2 | 68 | 82 |
| | | | | | (3-1) | | | |
| 2-14 | | | | | Formula | | 66 | 82 |
| | | | | | (4-1) | | | |
| 2-15 | | | | | Formula | | 68 | 81 |
| | | | | | (5-1) | | | |
| 2-16 | | | | | LiPF₂O₂ | | 68 | 82 |
| 2-17 | | | | | Li₂PFO₃ | | 67 | 82 |

In the case where the electrolytic solution contained the non-carbamate compound together with the unsaturated cyclic carbamate compound, the cycle retention ratio and the conservation retention ratio were further increased. In this case, if the content of the non-carbamate compound in the electrolytic solution was from 0.001 wt % to 2 wt % both inclusive, a high cycle retention ratio and a high conservation retention ratio were obtained.

### Examples 3-1 to 3-18

Secondary batteries were fabricated by a procedure similar to those of Examples 1-1 to 1-14, except that the composition of the solvent was changed as illustrated in Table 3, and the respective characteristics were examined.

In this case, newly used solvents were as follows. As a solvent combined with EC, diethyl carbonate (DEC), ethylmethyl carbonate (EMC), or propyl carbonate (PC) was used. As an unsaturated cyclic ester carbonate, vinylene carbonate (VC) was used. As a halogenated ester carbonate, FEC, t-DFEC, or DFDMC was used. As sultone, propene sultone (PRS) was used. As an acid anhydride, succinic anhydride (SCAH) or sulfopropionic anhydride (PSAH) was used.

The composition of the solvent was EC:PC:DMC=10:20:70 at a weight ratio. Further, the content of VC in the solvent was 2 wt %, the content of FEC, t-DFEC, or DFDMC in the solvent was 5 wt %, and the content of PRS, SCAH, or PSAH in the solvent was 1 wt %.

TABLE 3
Anode active material: artificial graphite

| | | | | Carbamate | | Cycle | Conservation |
|---|---|---|---|---|---|---|---|
| | | | | compound | | retention | retention |
| | Electrolyte | | | | Content | ratio | ratio |
| Example | salt | Solvent | | Type | (Wt %) | (%) | (%) |
| 3-1 | LiPF₆ | EC + DMC | | Formula | 2 | 84 | 87 |
| 3-2 | | EC + EMC | | (1-26) | | 84 | 87 |
| 3-3 | | EC + PC + DMC | | | | 85 | 88 |
| 3-4 | | EC + | VC | | | 86 | 89 |
| 3-5 | | DMC | FEC | | | 88 | 85 |
| 3-6 | | | t-DFEC | | | 87 | 85 |
| 3-7 | | | DFDMC | | | 87 | 85 |
| 3-8 | | | PRS | | | 88 | 93 |
| 3-9 | | | SCAH | | | 87 | 92 |
| 3-10 | | | PSAH | | | 90 | 94 |
| 3-11 | | | VC + FEC | | | 93 | 94 |
| 3-12 | | | FEC + PRS | | | 92 | 94 |
| 3-13 | | | FEC + SCAH | | | 92 | 93 |
| 3-14 | | | FEC + PSAH | | | 94 | 95 |
| 3-15 | LiPF₆ | EC + | VC | — | — | 76 | 84 |
| 3-16 | | DMC | FEC | | | 82 | 81 |
| 3-17 | | | t-DFEC | | | 78 | 80 |
| 3-18 | | | DFDMC | | | 78 | 81 |

Even if the composition of the solvent was changed, in the case where the electrolytic solution contained the unsaturated cyclic carbamate compound, high cycle retention ratios and high conservation retention ratios were obtained. In particular, in the case where the solvent contained the unsaturated cyclic ester carbonate, the halogenated ester carbonate, the sultone, or the acid anhydride, the cycle retention ratio and the conservation retention ratio were further increased. Such further improvement of the cycle retention ratio and the conservation retention ratio according to the composition of the solvent is similarly applicable to the foregoing Table 2.

### Examples 4-1 to 4-3

Secondary batteries were fabricated by a procedure similar to those of Examples 1-1 to 1-13, except that the composition of the electrolyte salt was changed as illustrated in Table 4, and the respective characteristics were examined.

In this case, newly used electrolyte salts were lithium tetrafluoroborate (LiBF₄), bis[oxalato-O,O′]lithium borate (LiBOB) represented by Formula (13-6), and bis(trifluoromethanesulfonyl)imide lithium (LiN(CF₃SO₂)₂: LiTFSI). The content of LiPF₆ with respect to the solvent was 0.9 mol/kg, and the content of LiBF₄ or the like with respect to the solvent was 0.1 mol/kg.

TABLE 4
Anode active material: artificial graphite

| | | | | Carbamate | | Cycle | Conservation |
|---|---|---|---|---|---|---|---|
| | | | | compound | | retention | retention |
| | Electrolyte | | | | Content | ratio | ratio |
| Example | salt | | Solvent | Type | (Wt %) | (%) | (%) |
| 4-1 | LiPF₆ | LiBF₄ | EC + DMC | Formula | 2 | 83 | 90 |
| 4-2 | | LiBOB | | (1-26) | | 84 | 91 |
| 4-3 | | LiTFSI | | | | 84 | 90 |

Even if the composition of the electrolyte salt was changed, in the case where the electrolytic solution contained the unsaturated cyclic carbamate compound, high cycle retention ratios and high conservation retention ratios were obtained. In particular, in the case where the electrolytic solution contained other electrolyte salt such as LiBF₄, the cycle retention ratio and the conservation retention ratio were further increased depending on the type of other electrolyte salts.

### Examples 5-1 to 5-16, 6-1 to 6-18, 7-1 to 7-18, and 8-1 to 8-3

Secondary batteries were fabricated by a procedure similar to those of Examples 1-1 to 1-16, 2-1 to 2-18, 3-1 to 3-18, and 4-1 to 4-3, except that a metal-based material (silicon) was used as an anode active material as illustrated in Table 5 to Table 8, and the respective characteristics were examined.

Upon fabricating the anode 22, silicon was deposited on both surfaces of the anode current collector 22A by an electron beam evaporation method to form the anode active material layer 22B. In this case, 10 times of deposition steps were repeated to obtain the thickness of the anode active material layer 22B on a single surface side of the anode current collector 22A of 6 μm.

TABLE 5
Anode active material: silicon

| | | | Carbamate | | Cycle | Conservation |
|---|---|---|---|---|---|---|
| Ex- | | | compound | | retention | retention |
| am- | Electrolyte | | | Content | ratio | ratio |
| ple | salt | Solvent | Type | (Wt %) | (%) | (%) |
| 5-1 | LiPF₆ | EC + | Formula | 5 | 68 | 83 |
| | | DMC | (1-6) | | | |
| 5-2 | | | Formula | | 68 | 83 |
| | | | (1-9) | | | |
| 5-3 | | | Formula | | 70 | 84 |
| | | | (1-16) | | | |
| 5-4 | | | Formula | 0.01 | 42 | 82 |
| 5-5 | | | (1-26) | 0.1 | 43 | 83 |
| 5-6 | | | | 0.5 | 48 | 83 |
| 5-7 | | | | 1 | 50 | 84 |
| 5-8 | | | | 2 | 55 | 85 |
| 5-9 | | | | 5 | 75 | 85 |
| 5-10 | | | | 10 | 75 | 84 |
| 5-11 | | | | 20 | 70 | 82 |
| 5-12 | | | Formula | 5 | 75 | 82 |
| | | | (1-28) | | | |
| 5-13 | | | Formula | | 70 | 83 |
| | | | (1-40) | | | |
| 5-14 | LiPF₆ | EC + | — | — | 40 | 81 |
| 5-15 | | DMC | Formula | 5 | 35 | 72 |
| | | | (19-1) | | | |
| 5-16 | | | Formula | | 32 | 68 |
| | | | (19-2) | | | |

TABLE 6
Anode active material: silicon

| | | | Carbamate | | Non-carbamate | | Cycle | Conservation |
|---|---|---|---|---|---|---|---|---|
| | | | compound | | compound | | retention | retention |
| | Electrolyte | | | Content | | Content | ratio | ratio |
| Example | salt | Solvent | Type | (Wt %) | Type | (Wt %) | (%) | (%) |
| 6-1 | LiPF₆ | EC + DMC | Formula | 2 | Formula | 0.2 | 76 | 88 |
| | | | (1-26) | | (3-1) | | | |
| 6-2 | | | | | Formula | | 76 | 88 |
| | | | | | (4-1) | | | |
| 6-3 | | | | | Formula | | 77 | 90 |
| | | | | | (5-1) | | | |
| 6-4 | | | | | LiPF₂O₂ | 0.001 | 76 | 86 |
| 6-5 | | | | | | 0.1 | 77 | 88 |
| 6-6 | | | | | | 0.2 | 78 | 88 |
| 6-7 | | | | | | 1 | 77 | 86 |
| 6-8 | | | | | | 2 | 76 | 85 |
| 6-9 | | | | | Li₂PFO₃ | 0.2 | 76 | 88 |

| | | | | | | |
|---|---|---|---|---|---|---|
| 6-10 | EC + | FEC | LiPF₂O₂ | 0.2 | 85 | 88 |
| 6-11 | DMC | t-DFEC | | | 88 | 89 |
| 6-12 | | c-DFEC | | | 89 | 89 |
| 6-13 | | DFDMC | | | 87 | 88 |

| | | | | | | | | |
|---|---|---|---|---|---|---|---|---|
| 6-14 | LiPF₆ | EC + DMC | — | — | Formula | 0.2 | 42 | 82 |
| | | | | | (3-1) | | | |
| 6-15 | | | | | Formula | | 41 | 82 |
| | | | | | (4-1) | | | |
| 6-16 | | | | | Formula | | 44 | 83 |
| | | | | | (5-1) | | | |
| 6-17 | | | | | LiPF₂O₂ | | 42 | 82 |
| 6-18 | | | | | Li₂PFO₃ | | 40 | 82 |

TABLE 7
Anode active material: silicon

| | | | | Carbamate | | Cycle | Conservation |
|---|---|---|---|---|---|---|---|
| | | | | compound | | retention | retention |
| | Electrolyte | | | | Content | ratio | ratio |
| Example | salt | Solvent | | Type | (Wt %) | (%) | (%) |
| 7-1 | LiPF₆ | EC + DEC | | Formula | 2 | 72 | 88 |
| 7-2 | | EC + EMC | | (1-26) | | 73 | 87 |
| 7-3 | | EC + PC + DMC | | | | 72 | 90 |
| 7-4 | | EC + | VC | | | 82 | 90 |
| 7-5 | | DMC | FEC | | | 83 | 86 |
| 7-6 | | | t-DFEC | | | 87 | 86 |
| 7-7 | | | DFDMC | | | 82 | 86 |
| 7-8 | | | PRS | | | 85 | 92 |
| 7-9 | | | SCAH | | | 85 | 90 |
| 7-10 | | | PSAH | | | 88 | 94 |
| 7-11 | | | VC + FEC | | | 88 | 92 |
| 7-12 | | | FEC + PRS | | | 88 | 94 |
| 7-13 | | | FEC + SCAH | | | 88 | 93 |
| 7-14 | | | FEC + PSAH | | | 90 | 95 |
| 7-15 | LiPF₆ | EC + | VC | — | — | 70 | 84 |
| 7-16 | | DMC | FEC | | | 60 | 81 |
| 7-17 | | | t-DFEC | | | 76 | 78 |
| 7-18 | | | DFDMC | | | 68 | 80 |

TABLE 8
Anode active material: silicon

| | | | | Carbamate | | Cycle | Conservation |
|---|---|---|---|---|---|---|---|
| | | | | compound | | retention | retention |
| | | | | | Content | ratio | ratio |
| Example | Electrolyte salt | | Solvent | Type | (Wt %) | (%) | (%) |
| 8-1 | LiPF₆ | LiBF₄ | EC + DMC | Formula | 2 | 73 | 92 |
| 8-2 | | LiBOB | | (1-26) | | 77 | 92 |
| 8-3 | | LiTFSI | | | | 73 | 92 |

In the case where the metal-based material (silicon) was used as an anode active material, a result similar to that of the case in which the non-metal-based material (artificial graphite as a carbon material) was used (Table 1 to Table 4) was obtained. That is, in the case where the electrolytic solution contained the unsaturated cyclic carbamate compound, high cycle retention ratios and high conservation retention ratios were obtained. The other tendencies were similar to those of the case in which the non-metal-based material was used.

### Examples 9-1 to 9-4

Secondary batteries were fabricated by a procedure similar to those of Examples 1-1 to 1-14, except that a metal-based material (SnCoC as an SnCoC-containing material) was used as an anode active material as illustrated in Table 9, and the respective characteristics were examined.

Upon forming the anode 22, cobalt powder and tin powder were alloyed to obtain cobalt tin alloy powder. Thereafter, carbon powder was added thereto, and the resultant was dry-mixed. Subsequently, 10 g of the foregoing mixture and about 400 g of a corundum being 9 mm in diameter were set in a reaction container of a planetary ball mill available from Ito Seisakusho Co. Subsequently, inside of the reaction container was substituted by argon atmosphere. Thereafter, 10 minute operation at 250 rpm and 10 minute break were repeated until the total operation time reached 20 hours. Subsequently, the reaction container was cooled down to room temperature and SnCoC as a reactant was taken out. Thereafter, the resultant was screened through a 280 mesh sieve to remove coarse grain.

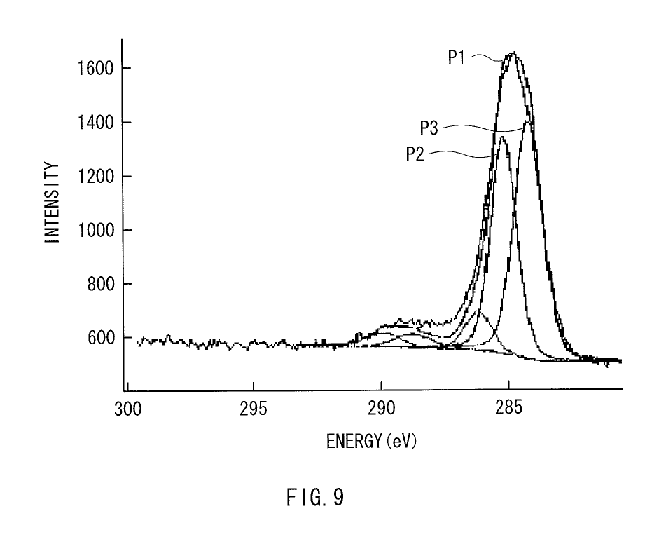

The composition of obtained SnCoC was analyzed. The Sn content was 49.5 mass %, the Co content was 29.7 mass %, the C content was 19.8 mass %, and the ratio of Sn and Co (Co/(Sn+ Co)) was 37.5 mass %. At this time, inductively coupled plasma (ICP) emission analysis was used to measure the Sn content and the Co content, and a carbon sulfur analysis device was used to measure the C content. Further, SnCoC was analyzed with the use of an X-ray diffraction method. A diffraction peak having half bandwidth in the range of 2θ which is 20 to 50 deg both inclusive was observed. Further, after SnCoC was analyzed with the use of XPS, as illustrated in FIG. 9, a peak P1 was obtained. After the peak P1 was analyzed, a peak P2 of the surface contamination carbon and a peak P3 of C1s in SnCoC existing on the lower energy side (region lower than 284.5 eV) were obtained. From the result, it was confirmed that C in SnCoC was bonded to other element.

After SnCoC was obtained, 80 parts by mass of an anode active material (SnCoC), 8 parts by mass of an anode binder (PVDF), 12 parts by mass of an anode electrical conductor (11 parts by mass of graphite and 1 part by mass of acetylene black) were mixed to obtain an anode mixture. Subsequently, the anode mixture was dispersed in NMP to obtain a paste anode mixture slurry. Finally, both surfaces of the anode current collector 22A were coated with the anode mixture slurry with the use of a coating device and the resultant was dried to form the anode active material layer 22B. Thereafter, the anode active material layer 22B was compression-molded by a rolling press machine.

TABLE 9
Anode active material: SnCoC

| | | | Carbamate | | Cycle | Conservation |
|---|---|---|---|---|---|---|
| | | | compound | | retention | retention |
| Exam- | Electrolyte | Sol- | | Content | ratio | ratio |
| ple | salt | vent | Type | (Wt %) | (%) | (%) |
| 9-1 | LiPF₆ | EC + | Formula | 0.5 | 58 | 85 |
| 9-2 | | DMC | (1-26) | 1 | 60 | 87 |
| 9-3 | | | | 5 | 60 | 87 |
| 9-4 | LiPF₆ | EC + | — | — | 55 | 82 |
| | | DMC | | | | |

In the case where SnCoC was used as an anode active material, results similar to those of the case in which silicon was used (Table 5) were obtained. That is, in the case where the electrolytic solution contained the unsaturated cyclic carbamate compound, high cycle retention ratios and high conservation retention ratios were obtained. The other tendencies were similar to those of the case in which the non-metal-based material was used.

### Examples 10-1 to 10-28

Secondary batteries were fabricated by a procedure similar to that of Example 3-5, except that content A (wt %) of the halogenated ester carbonate, content B (wt %) of the unsaturated cyclic carbamate compound, and B/A were changed as illustrated in Table 10 and Table 11, and the respective characteristics were examined.

In this case, not only the cycle characteristics and the conservation characteristics, but also load characteristics were examined. Upon examining the load characteristics, a secondary battery with the battery state being stabled by a procedure similar to that of the case in which the cycle characteristics were examined was used. One cycle of charge and discharge was performed on the secondary battery in the ambient temperature environment (23 deg C.) to measure the discharge capacity. Subsequently, the secondary battery was charged and discharged repeatedly in low temperature environment (−10 deg C.) until the total of the number of cycles became 100 to measure the discharge capacity. From the result, load retention ratio (%)=(discharge capacity at the 100th cycle/discharge capacity at the second cycle)×100 was calculated. Charge conditions were similar to those in the case in which the cycle characteristics were examined. At the time of discharge, discharge was performed at a constant current of 1 C until the voltage reached the final voltage of 2.5 V. The term “1 C” refers to a current value at which the battery capacity (theoretical capacity) is fully discharged in 1 hour.

TABLE 10
Anode active material: artificial graphite

| | Halogenated | | Carbamate | | | Cycle | Conservation | Load |
|---|---|---|---|---|---|---|---|---|
| | ester carbonate | | compound | | | retention | retention | retention |
| | | Content A | | Content B | | ratio | ratio | ratio |
| Example | Type | (Wt %) | Type | (Wt %) | B/A | (%) | (%) | (%) |
| 10-1 | FEC | 50 | Formula | 0.01 | 0.01 | 85 | 83 | 30 |
| 10-2 | | 40 | (1-26) | | 0.00025 | 85 | 83 | 54 |
| 10-3 | | 5 | | | 0.002 | 80 | 84 | 62 |
| 10-4 | | 1 | | | 0.01 | 78 | 84 | 62 |
| 10-5 | | 0.01 | | | 1 | 74 | 83 | 54 |
| 10-6 | | 0.001 | | | 10 | 73 | 83 | 45 |
| 10-7 | FEC | 50 | Formula | 0.1 | 0.002 | 88 | 83 | 40 |
| 10-8 | | 40 | (1-26) | | 0.0025 | 88 | 83 | 55 |
| 10-9 | | 5 | | | 0.02 | 86 | 85 | 62 |
| 10-10 | | 1 | | | 0.1 | 85 | 85 | 62 |
| 10-11 | | 0.01 | | | 10 | 77 | 83 | 54 |
| 10-12 | | 0.001 | | | 100 | 76 | 83 | 40 |
| 10-13 | FEC | 50 | Formula | 2 | 0.04 | 89 | 84 | 40 |
| 10-14 | | 40 | (1-26) | | 0.05 | 89 | 83 | 55 |
| 3-5 | | 5 | | | 0.4 | 88 | 85 | 66 |
| 10-15 | | 1 | | | 2 | 88 | 85 | 67 |
| 10-16 | | 0.01 | | | 200 | 85 | 85 | 48 |
| 10-17 | | 0.002 | | | 1000 | 85 | 85 | 40 |

TABLE 11
Anode active material: artificial graphite

| | Halogenated | | Carbamate | | | Cycle | Conservation | Load |
|---|---|---|---|---|---|---|---|---|
| | ester carbonate | | compound | | | retention | retention | retention |
| | | Content A | | Content B | | ratio | ratio | ratio |
| Example | Type | (Wt %) | Type | (Wt %) | B/A | (%) | (%) | (%) |
| 10-18 | FEC | 50 | Formula | 10 | 0.2 | 88 | 80 | 20 |
| 10-19 | | 40 | (1-26) | | 0.25 | 86 | 83 | 48 |
| 10-20 | | 5 | | | 2 | 85 | 85 | 50 |
| 10-21 | | 1 | | | 10 | 85 | 85 | 50 |
| 10-22 | | 0.01 | | | 1000 | 84 | 83 | 46 |
| 10-23 | | 0.001 | | | 10000 | 84 | 83 | 20 |
| 10-24 | FEC | 50 | Formula | 20 | 0.4 | 84 | 78 | 20 |
| 10-25 | | 40 | (1-26) | | 0.5 | 84 | 82 | 25 |
| 10-26 | | 5 | | | 4 | 83 | 83 | 30 |
| 10-27 | | 1 | | | 20 | 83 | 83 | 30 |
| 10-28 | | 0.01 | | | 2000 | 83 | 83 | 20 |

Even if B/A was changed, in the case where the electrolytic solution contained the unsaturated cyclic carbamate compound, high cycle retention ratios and high conservation retention ratios were obtained. In particular, in the case where the three conditions that A was from 0.01 wt % to 40 wt % both inclusive, B was from 0.01 wt % to 10 wt % both inclusive, and B/A was from 0.00025 to 1000 both inclusive were satisfied at the same time, high load retention ratios were obtained as well.

From the results of Table 1 to Table 11, in the case where the electrolytic solution contained the unsaturated cyclic carbamate compound, superior battery characteristics were obtained.

The present application has been described with reference to the embodiment and Examples. However, the present application is not limited to the examples described in the embodiment and Examples, and various modifications may be made. For example, the description has been given with the specific examples of the case in which the battery structure is the cylindrical type or the laminated film type, and the battery device has the spirally wound structure. However, applicable structures are not limited thereto. The secondary battery of the present application is similarly applicable to a battery having other battery structure such as a square-type battery, a coin-type battery, and a button-type battery or a battery in which the battery device has other structure such as a laminated structure.

Further, the description has been given of the case in which Li is used as an electrode reactant. However, the electrode reactant is not necessarily limited thereto. As an electrode reactant, for example, other Group 1 element such as Na and K, a Group 2 element such as Mg and Ca, or other light metal such as Al may be used. The effect of the present application may be obtained without depending on the electrode reactant type, and therefore, even if the electrode reactant type is changed, a similar effect is obtainable.

Further, with regard to the content of the unsaturated cyclic carbamate compound, the description has been given of the appropriate range derived from the results of Examples. However, the description does not totally deny a possibility that the content is out of the foregoing range. That is, the foregoing appropriate range is a range particularly preferable for obtaining the effects of the present application. Therefore, as long as the effects of the present application are obtained, the content may be out of the foregoing range in some degrees. The same is applicable to the content of the non-carbamate compound.

It is possible to achieve at least the following configurations from the above-described example embodiments of the disclosure.

(1) A secondary battery including:

a cathode;

an anode; and

an electrolytic solution, wherein
the electrolytic solution includes an unsaturated cyclic carbamate compound represented by a following Formula (1),

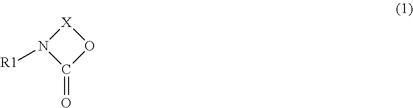

where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.
(2) The secondary battery according to (1), wherein

the monovalent hydrocarbon group includes an alkyl group, an alkenyl group, an alkynyl group, an aryl group, and a cycloalkyl group,

the monovalent oxygen-containing hydrocarbon group includes an alkoxy group,

the halogenated group includes one or more of a fluorine group, a chlorine group, a bromine group, and an iodine group, and

the halogen group includes a fluorine group, a chlorine group, a bromine group, and an iodine group.

(3) The secondary battery according to (2), wherein

carbon numbers of the alkyl group and the alkoxy group are from 1 to 12 both inclusive,

carbon numbers of the alkenyl group and the alkynyl group are from 2 to 12 both inclusive,

a carbon number of the aryl group is from 6 to 18 both inclusive, and

a carbon number of the cycloalkyl group is from 3 to 18 both inclusive.

(4) The secondary battery according to any one of (1) to (3), wherein the unsaturated cyclic carbamate compound is represented by one of a following Formula (2-1) and a following Formula (2-2),

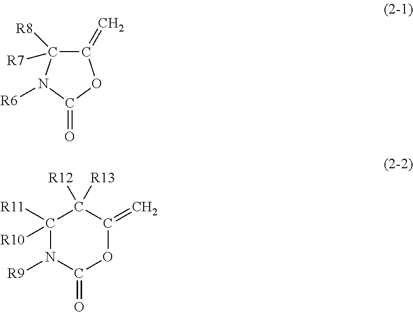

where each of R6 to R13 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R6 to the R8 are allowed to be bonded to one another, and any two or more of the R9 to the R13 are allowed to be bonded to one another.
(5) The secondary battery according to any one of (1) to (4), wherein the unsaturated cyclic carbamate compound is one or more of compounds represented by a following Formula (1-1) to a following Formula (1-74),

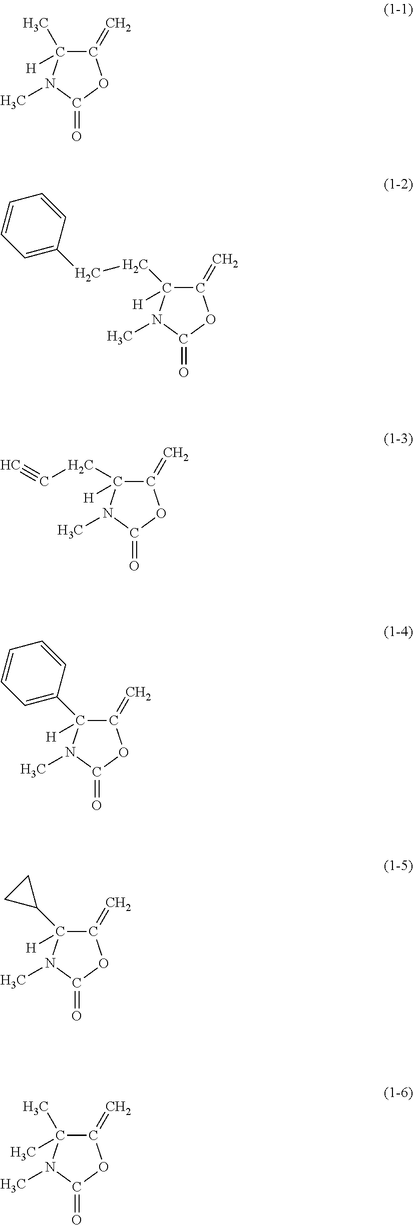

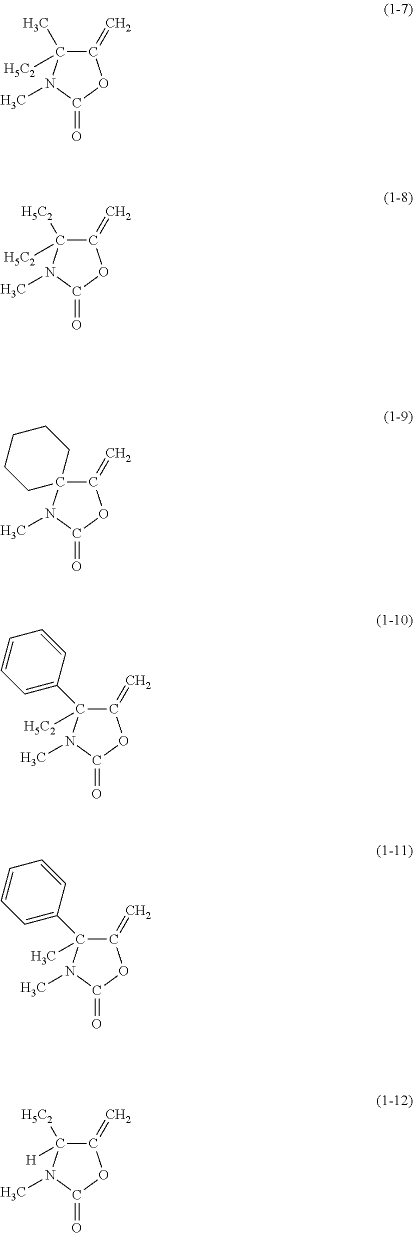

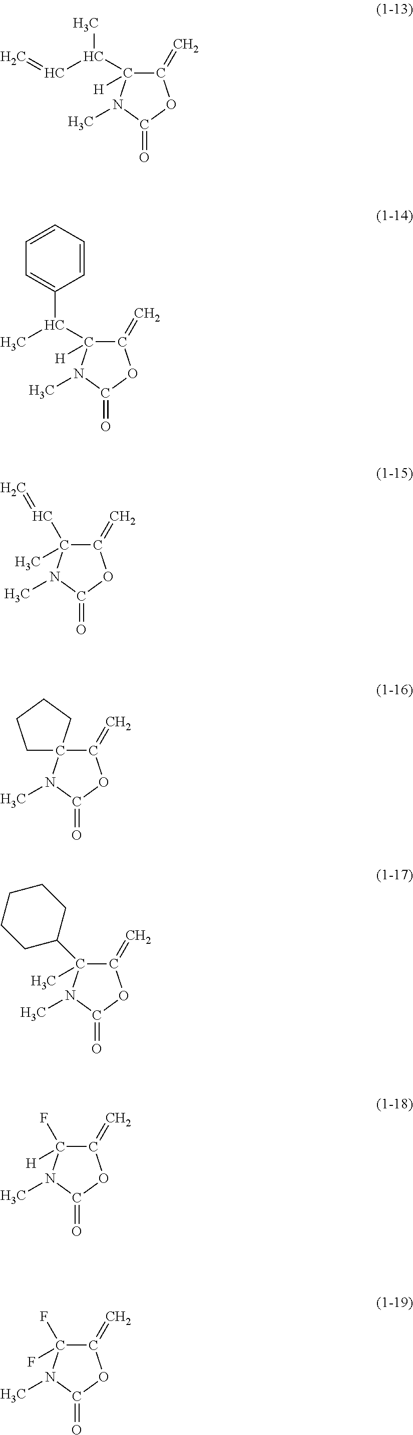

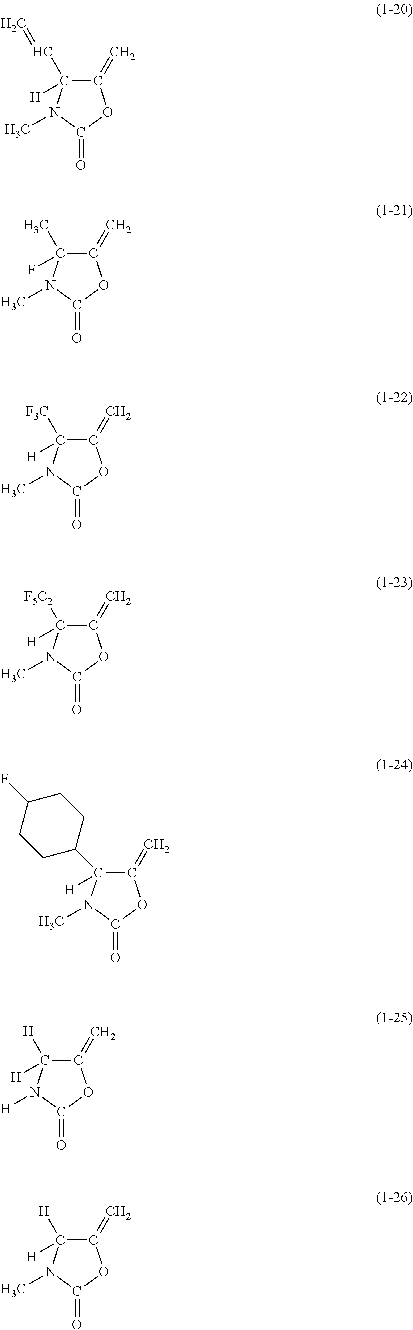

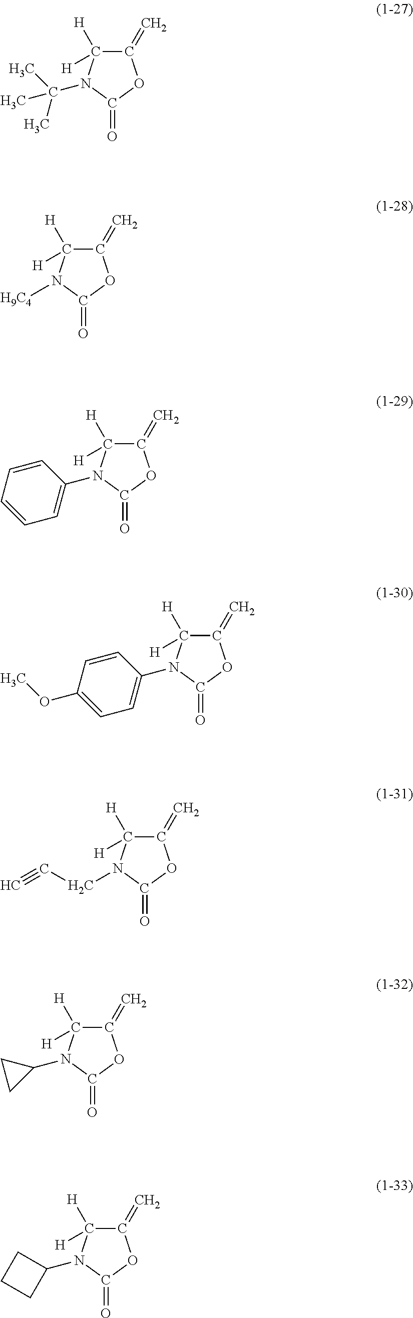

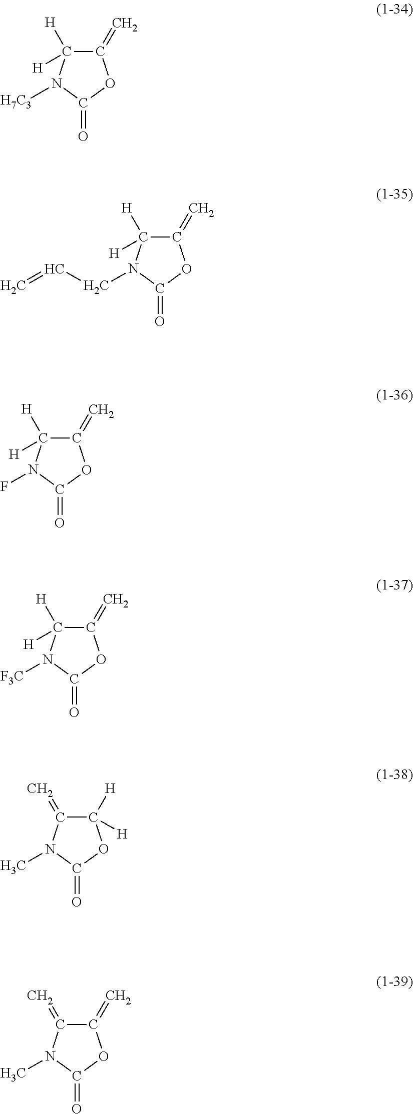

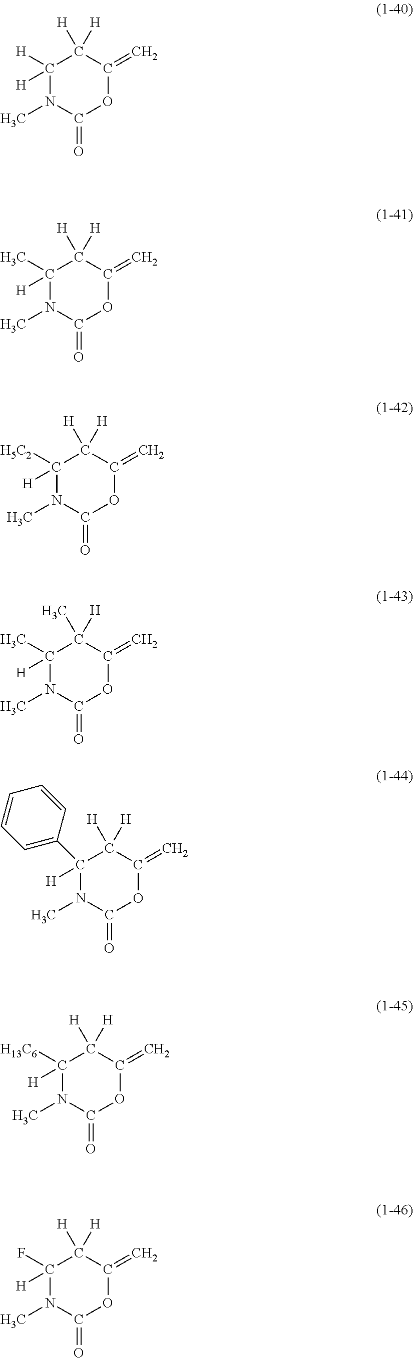

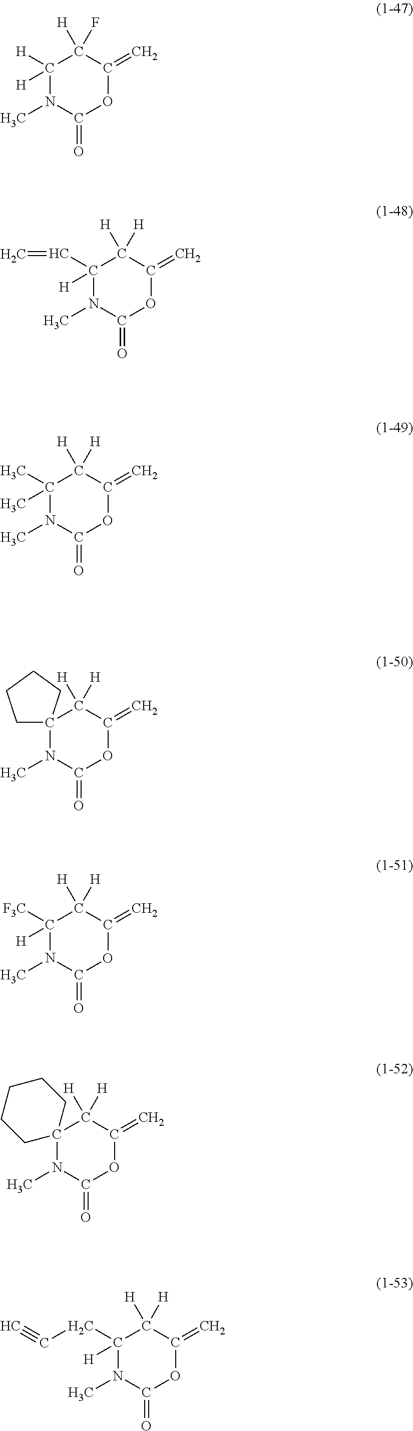

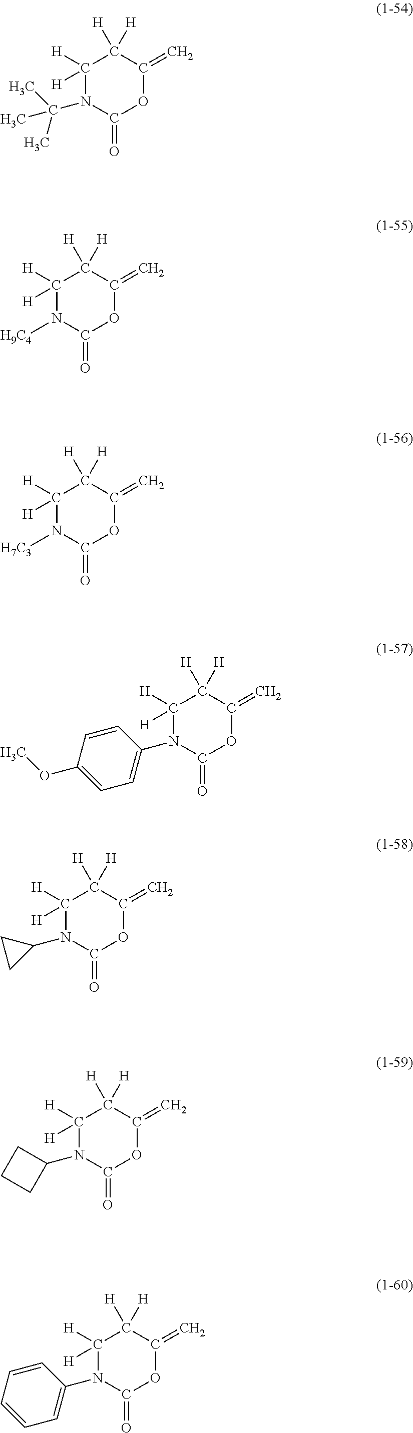

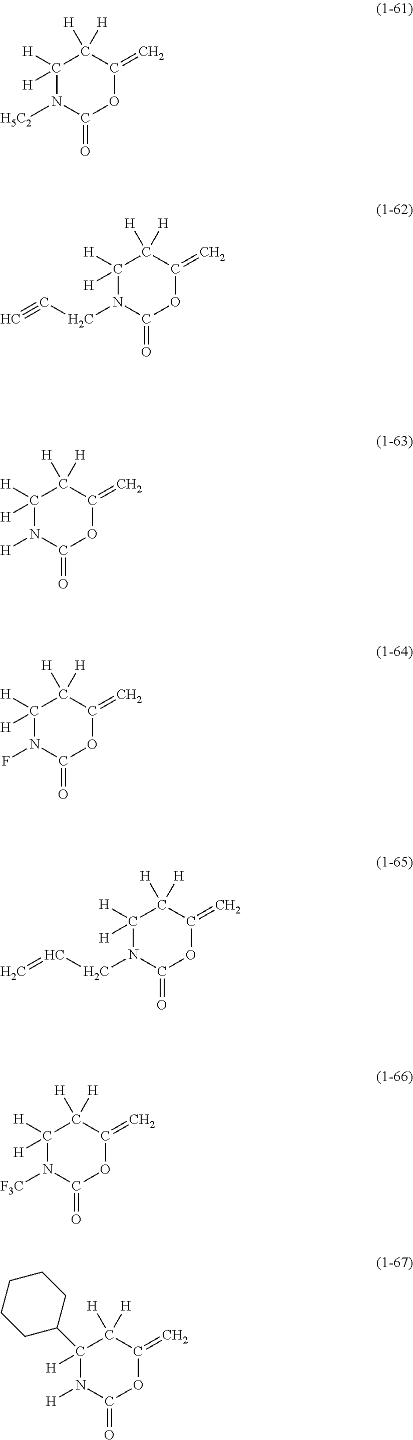

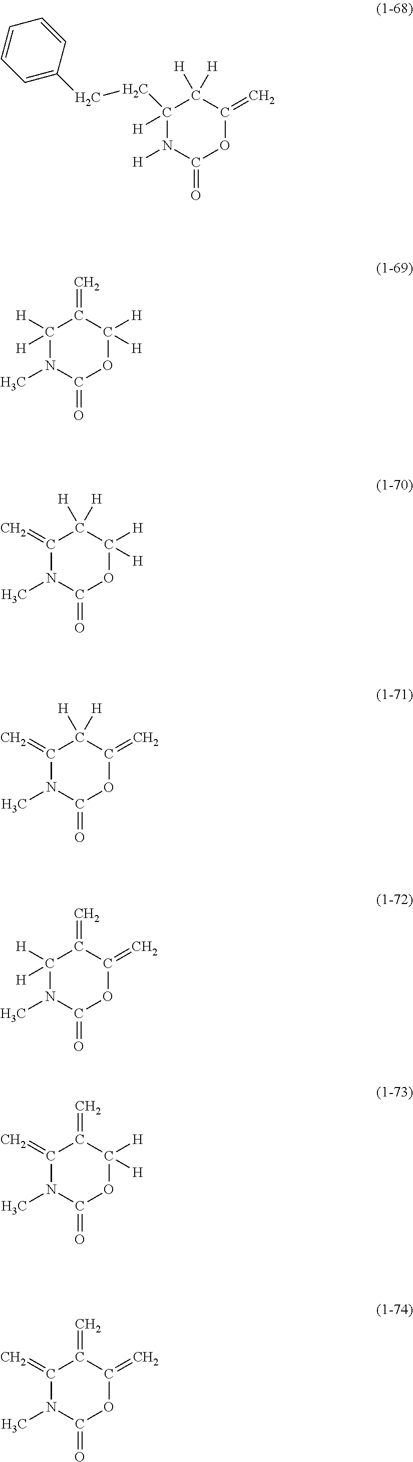

(6) The secondary battery according to any one of (1) to (5), wherein a content of the unsaturated cyclic carbamate compound in the electrolytic solution is from about 0.01 weight percent to about 20 weight percent both inclusive.
(7) The secondary battery according to any one of (1) to (6), wherein

the electrolytic solution includes a non-carbamate compound, and the non-carbamate compound includes one or more of a dicarbonic ester compound represented by a following Formula (3), a dicarboxylic acid compound represented by Formula (4), a disulfonic acid compound represented by Formula (5), a lithium salt represented by Formula (6), and a lithium salt represented by Formula (7),

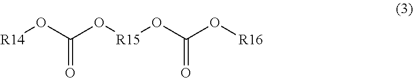

where each of R14 and R16 is one of a monovalent hydrocarbon group, a monovalent oxygen-containing hydrocarbon group, a halogenated group thereof, and a group obtained by bonding two or more thereof to one another; and R15 is one of a divalent hydrocarbon group, a halogenated group thereof, a group obtained by bonding two or more thereof to one another, and a group including one or more of the foregoing groups and an ether bond (—O—),

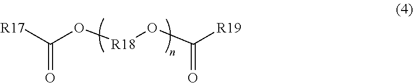

where each of R17 and R19 is one of a monovalent hydrocarbon group, a monovalent oxygen-containing hydrocarbon group, a halogenated group thereof, and a group obtained by bonding two or more thereof to one another; R18 is one of a divalent hydrocarbon group, a halogenated group thereof, a group obtained by bonding two or more thereof to one another, and a group including one or more of the foregoing groups and an ether bond; and n is an integer number equal to or more than 1,

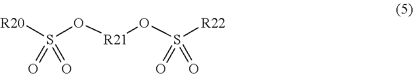

where each of R20 and R22 is one of a monovalent hydrocarbon group, a monovalent oxygen-containing hydrocarbon group, a halogenated group thereof, and a group obtained by bonding two or more thereof to one another; and R21 is one of a divalent hydrocarbon group, a halogenated group thereof, a group obtained by bonding two or more thereof to one another, and a group including one or more of the foregoing groups and an ether bond.

LiPF₂O₂ (6)

Li₂PFO₃ (7)

(8) The secondary battery according to (7), wherein

the monovalent hydrocarbon group and the monovalent oxygen-containing hydrocarbon group include an alkyl group with carbon number from 1 to 12 both inclusive, an alkenyl group with carbon number from 2 to 12 both inclusive, an alkynyl group with carbon number from 2 to 12 both inclusive, an aryl group with carbon number from 6 to 18 both inclusive, a cycloalkyl group with carbon number from 3 to 18 both inclusive, and an alkoxy group with carbon number from 1 to 12 both inclusive,

the divalent hydrocarbon group includes an alkylene group with carbon number from 1 to 12 both inclusive, an alkenylene group with carbon number from 2 to 12 both inclusive, an alkynylene group with carbon number from 2 to 12 both inclusive, an arylene group with carbon number from 6 to 18 both inclusive, and a cycloalkylene group with carbon number from 3 to 18 both inclusive, and

the halogenated group includes one or more of a fluorine group, a chlorine group, a bromine group, and an iodine group.
(9) The secondary battery according to (7) or (8), wherein

the dicarbonic ester compound is one or more of compounds represented by a following Formula (3-1) to a following Formula (3-12),

the dicarboxylic acid compound is one or more of compounds represented by a following Formula (4-1) to a following Formula (4-17), and

the disulfonic acid compound is one or more of compounds represented by a following Formula (5-1) to a following Formula (5-9).

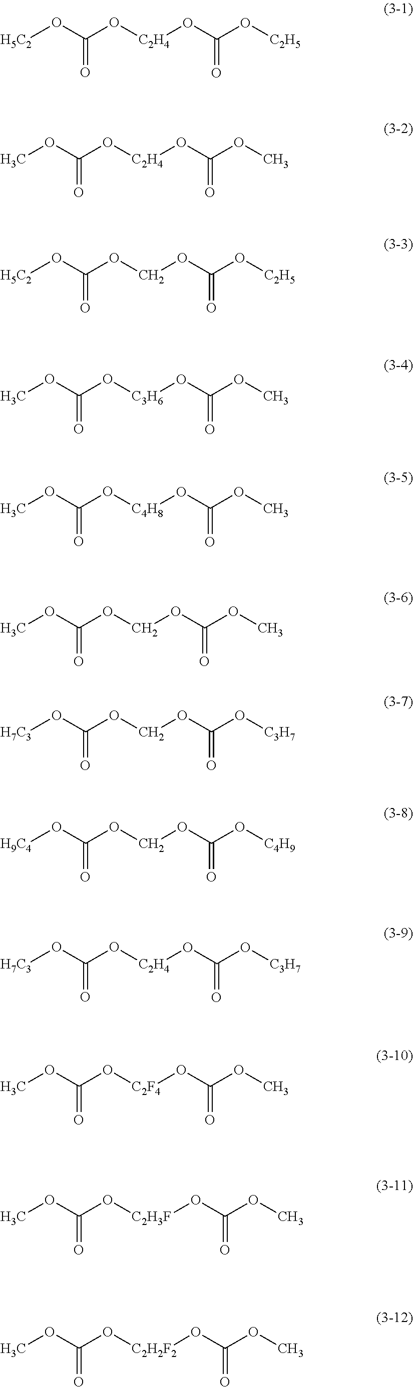

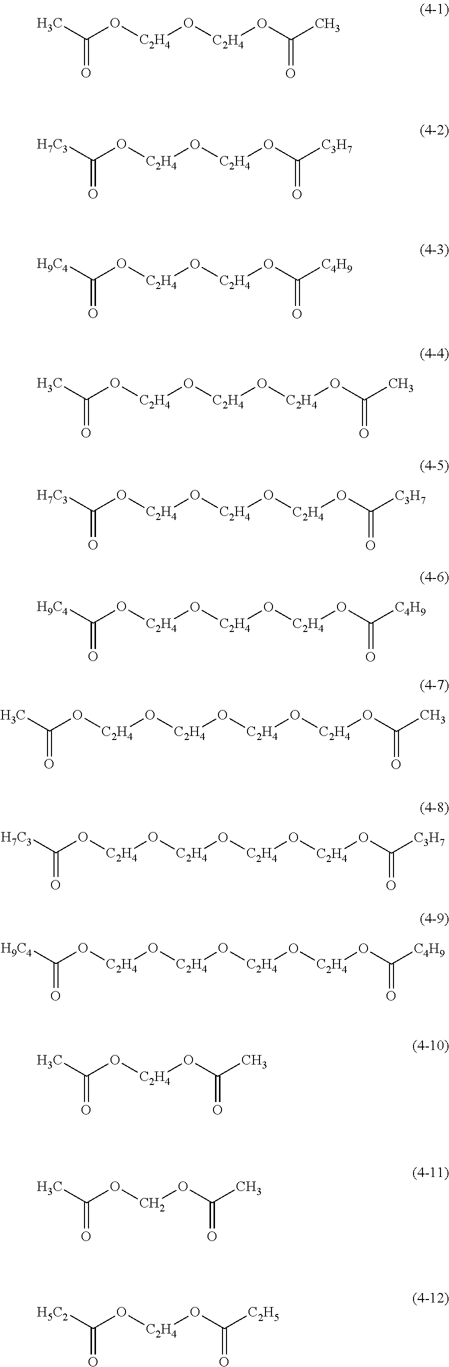

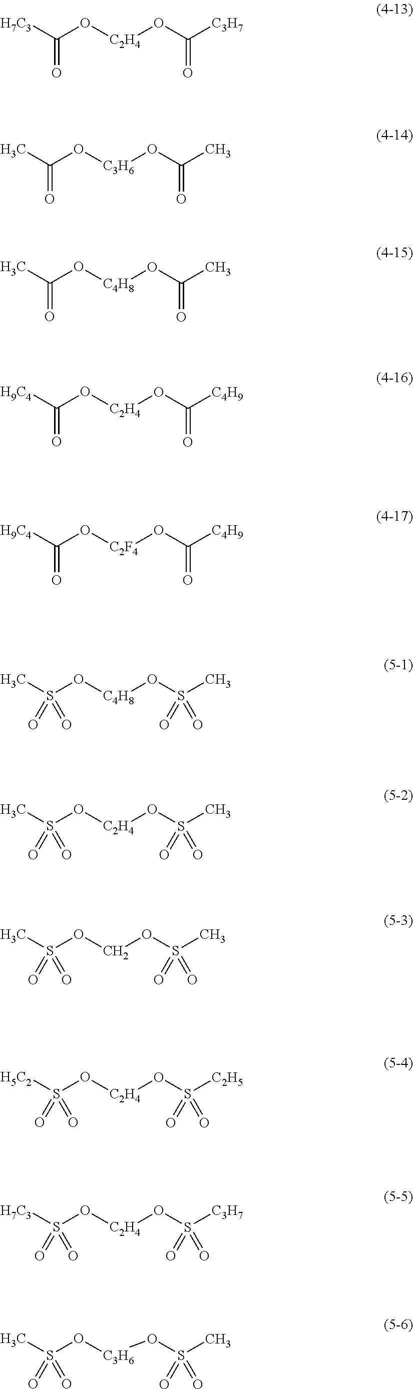

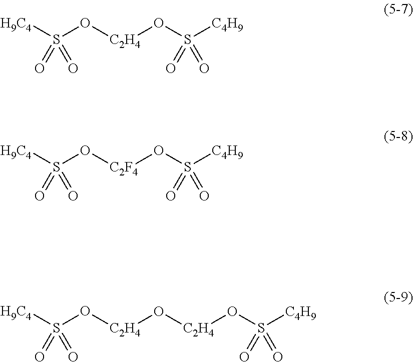

(10) The secondary battery according to any one of (7) to (9), wherein a content of the non-carbamate compound in the electrolytic solution is from about 0.001 weight percent to about 2 weight percent both inclusive.
(11) The secondary battery according to any one of (1) to (10), wherein the secondary battery is a lithium secondary battery.
(12) The secondary battery according to any one of (1) to (11), wherein the electrolytic solution includes a halogenated ester carbonate,

the halogenated ester carbonate includes one or more of a cyclic halogenated ester carbonate represented by a following Formula (11) and a chain halogenated ester carbonate represented by Formula (12), and

where a content of the halogenated ester carbonate in the electrolytic solution is A (weight percent) and a content of the unsaturated cyclic carbamate compound in the electrolytic solution is B (weight percent), A is from about 0.01 weight percent to about 40 weight percent both inclusive, B is from about 0.01 weight percent to about 10 weight percent both inclusive, and B/A is from about 0.00025 to about 1000 both inclusive are satisfied,

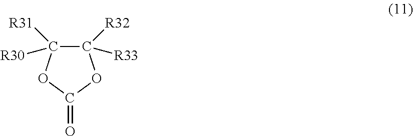

where each of R30 to R33 is one of a hydrogen group, a halogen group, an alkyl group, and a halogenated alkyl group; and one or more of R30 to R33 are each one of a halogen group and a halogenated alkyl group,

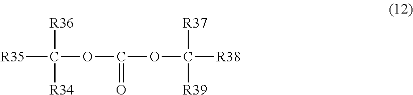

where each of R34 to R39 is one of a hydrogen group, a halogen group, an alkyl group, and a halogenated alkyl group; and one or more of R34 to R39 are each a halogen group or a halogenated alkyl group.
(13) An electrolytic solution including an unsaturated cyclic carbamate compound represented by a following Formula (1),

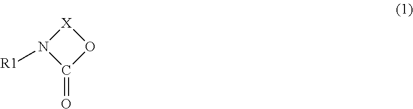

where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.
(14) A battery pack including:

a secondary battery according to any one of (1) to (12);

a control section controlling a used state of the secondary battery; and

a switch section switching the used state of the secondary battery according to an instruction of the control section.

(15) An electric vehicle including:

a secondary battery according to any one of (1) to (12);

a conversion section converting electric power supplied from the secondary battery into drive power;

a drive section operating according to the drive power; and

a control section controlling a used state of the secondary battery.

(16) An electric power storage system including:

a secondary battery according to any one of (1) to (12);

one or more electric devices supplied with electric power from the secondary battery; and

a control section controlling the supplying of the electric power from the secondary battery to the one or more electric devices.

(17) An electric power tool including:

a secondary battery according to any one of (1) to (12); and

a movable section being supplied with electric power from the secondary battery.

(18) An electronic apparatus including a secondary battery according to any one of (1) to (12) as an electric power supply source.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a cathode;
an anode; and
an electrolytic solution, wherein
the electrolytic solution includes an unsaturated cyclic carbamate compound represented by a following Formula (1), 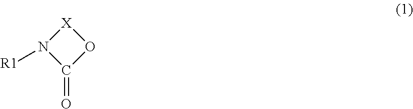
where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

2. The secondary battery according to claim 1, wherein
the monovalent hydrocarbon group includes an alkyl group, an alkenyl group, an alkynyl group, an aryl group, and a cycloalkyl group,
the monovalent oxygen-containing hydrocarbon group includes an alkoxy group,
the halogenated group includes one or more of a fluorine group, a chlorine group, a bromine group, and an iodine group, and
the halogen group includes a fluorine group, a chlorine group, a bromine group, and an iodine group.

3. The secondary battery according to claim 2, wherein
carbon numbers of the alkyl group and the alkoxy group are from 1 to 12 both inclusive,
carbon numbers of the alkenyl group and the alkynyl group are from 2 to 12 both inclusive,
a carbon number of the aryl group is from 6 to 18 both inclusive, and
a carbon number of the cycloalkyl group is from 3 to 18 both inclusive.

4. The secondary battery according to claim 1, wherein the unsaturated cyclic carbamate compound is represented by one of a following Formula (2-1) and a following Formula (2-2), 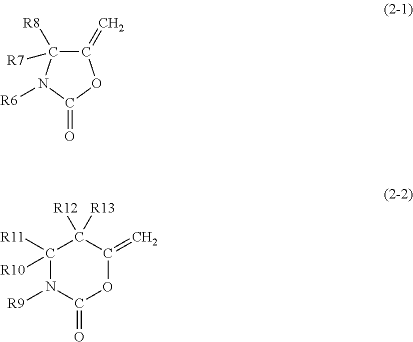
where each of R6 to R13 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R6 to the R8 are allowed to be bonded to one another, and any two or more of the R9 to the R13 are allowed to be bonded to one another.

5. The secondary battery according to claim 1, wherein the unsaturated cyclic carbamate compound is one or more of compounds represented by a following Formula (1-1) to a following Formula (1-74),

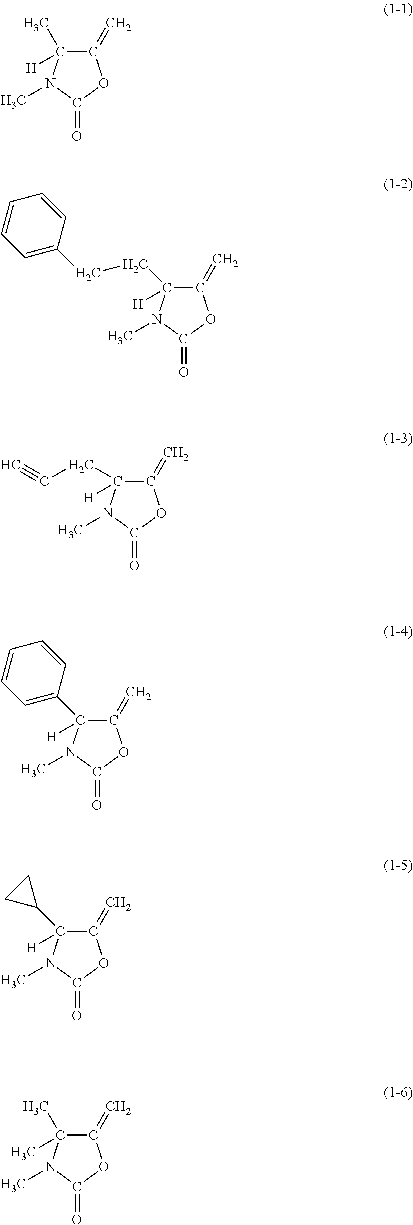

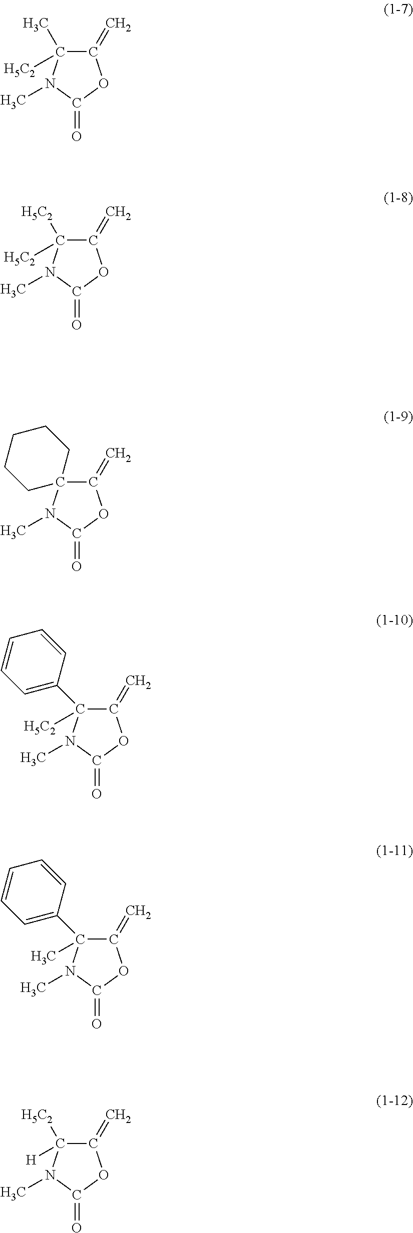

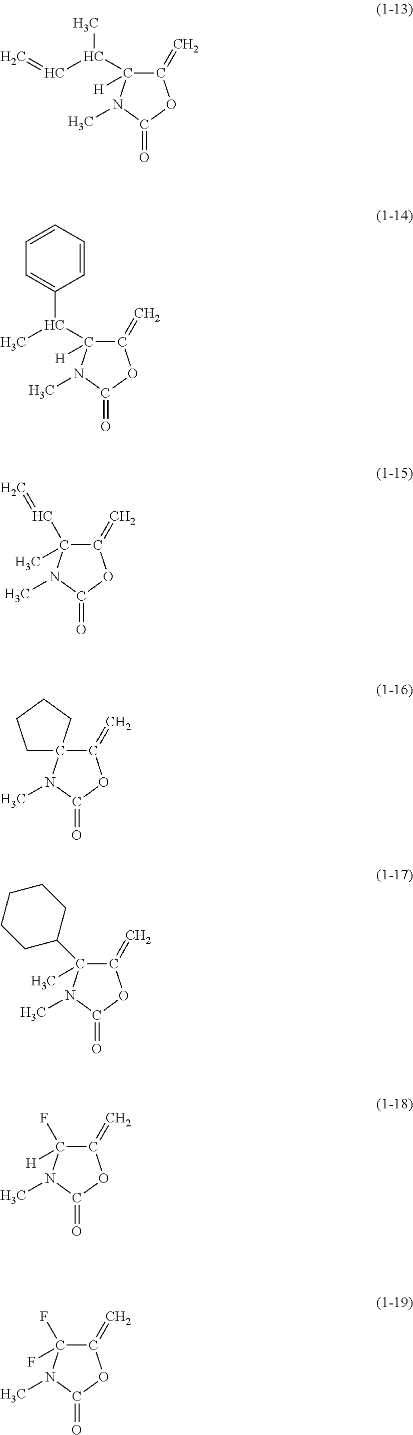

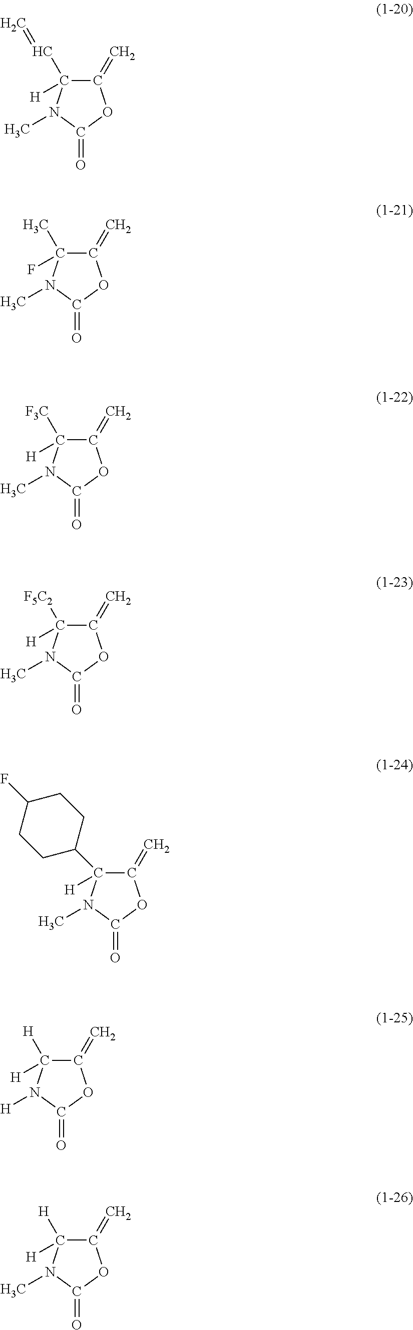

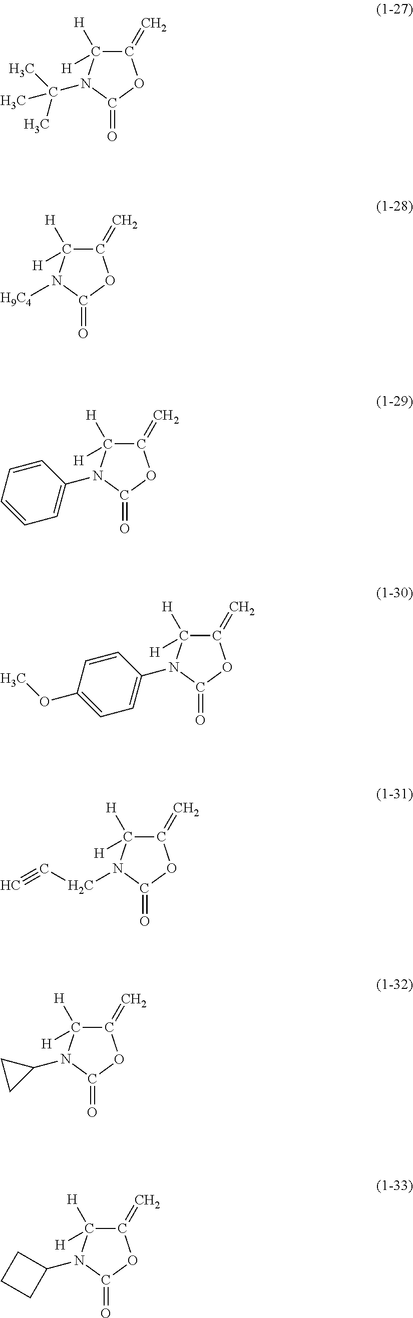

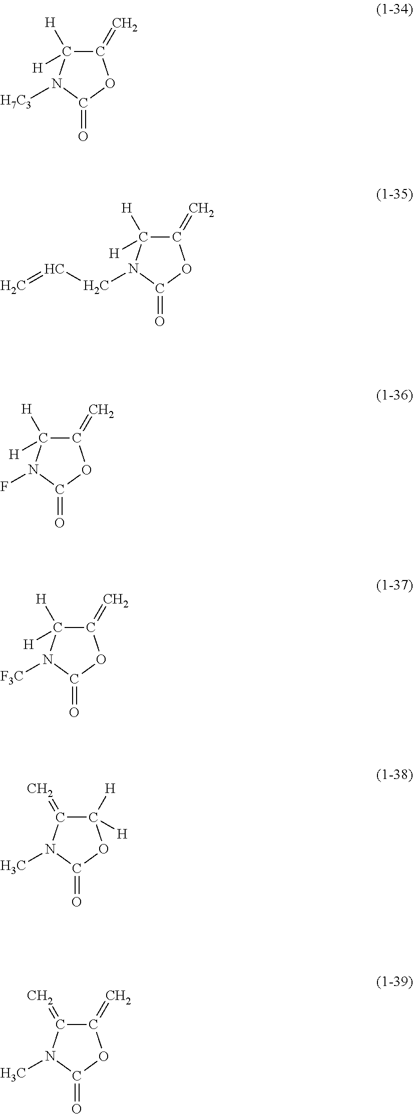

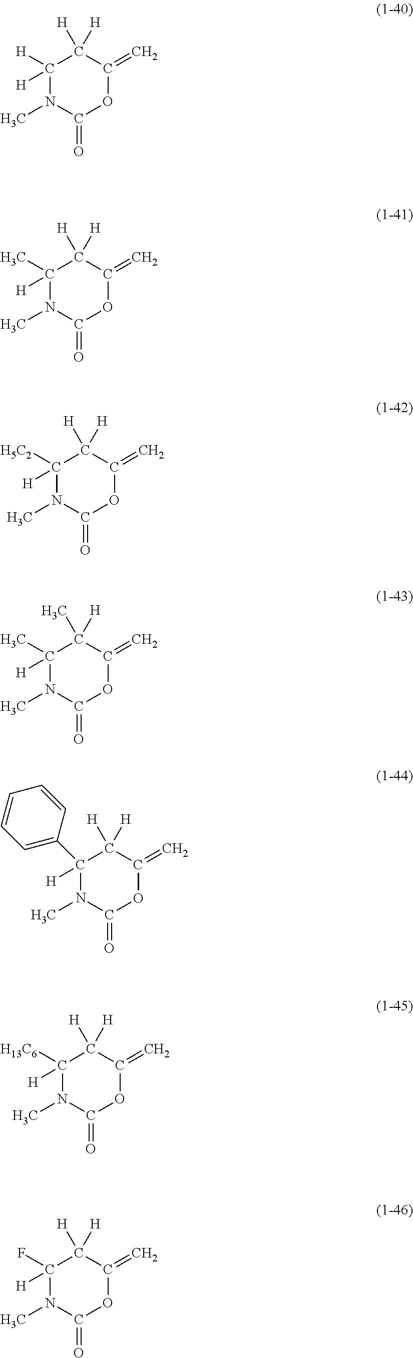

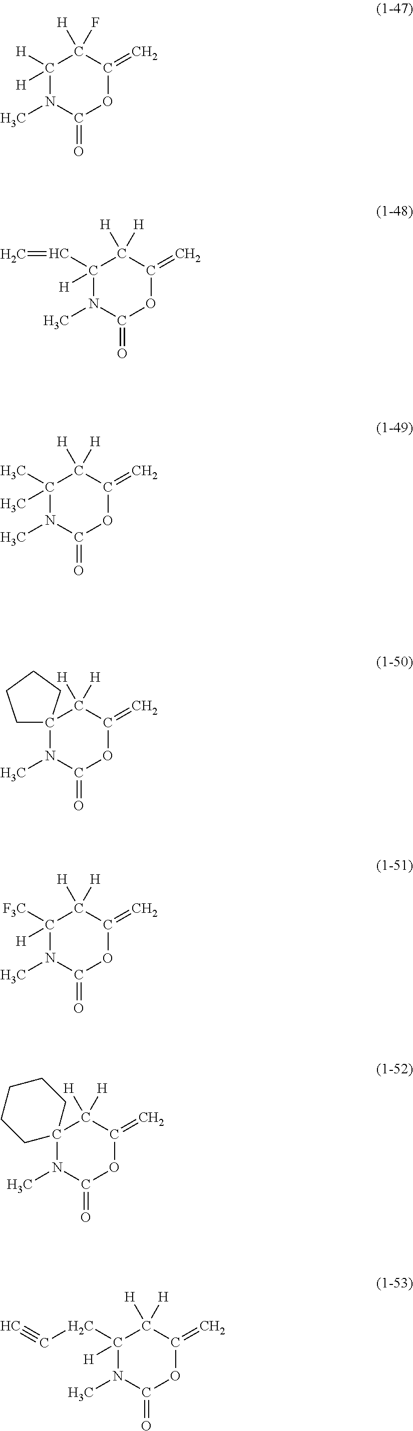

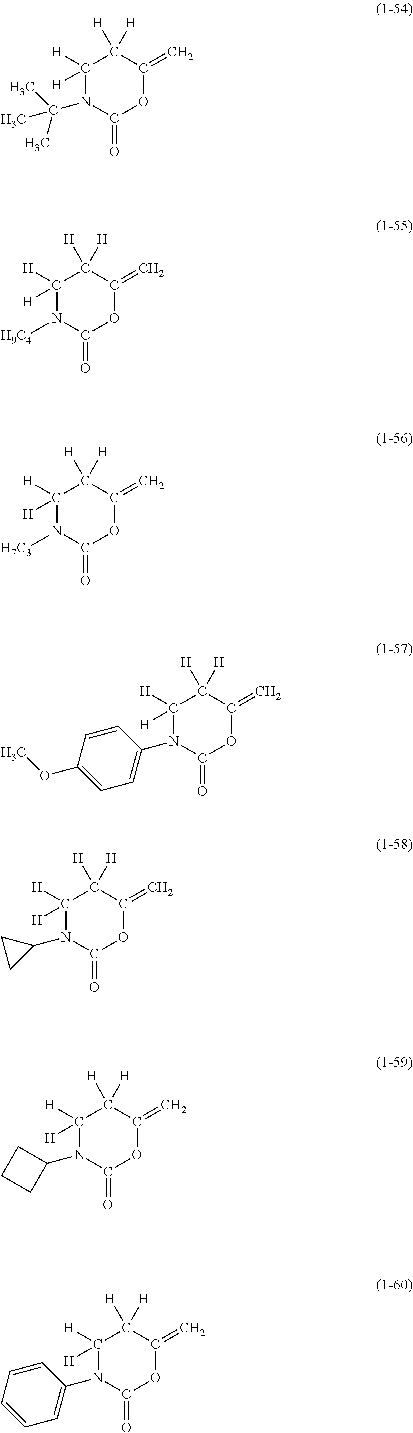

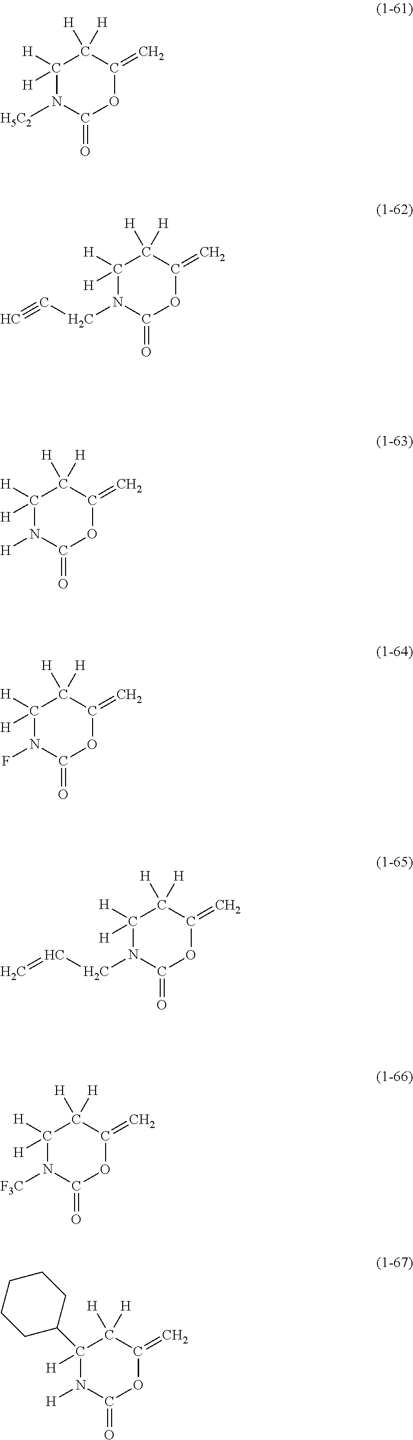

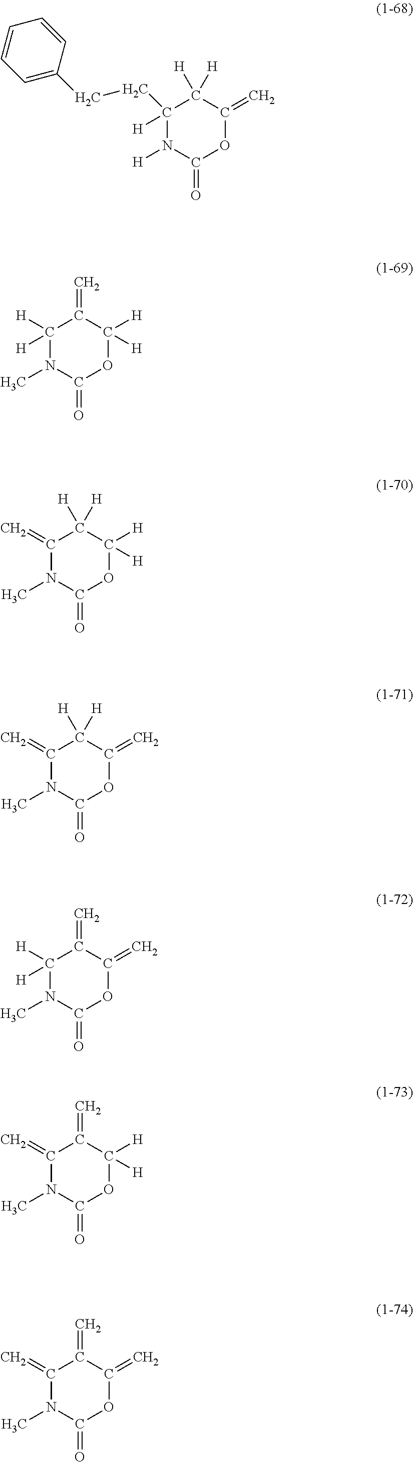

6. The secondary battery according to claim 1, wherein a content of the unsaturated cyclic carbamate compound in the electrolytic solution is from about 0.01 weight percent to about 20 weight percent both inclusive.

7. The secondary battery according to claim 1, wherein
the electrolytic solution includes a non-carbamate compound, and
the non-carbamate compound includes one or more of a dicarbonic ester compound represented by a following Formula (3), a dicarboxylic acid compound represented by Formula (4), a disulfonic acid compound represented by Formula (5), a lithium salt represented by Formula (6), and a lithium salt represented by Formula (7), 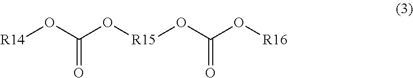
where each of R14 and R16 is one of a monovalent hydrocarbon group, a monovalent oxygen-containing hydrocarbon group, a halogenated group thereof, and a group obtained by bonding two or more thereof to one another; and R15 is one of a divalent hydrocarbon group, a halogenated group thereof, a group obtained by bonding two or more thereof to one another, and a group including one or more of the foregoing groups and an ether bond (—O—), 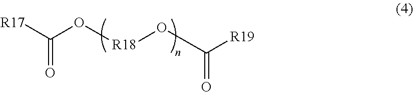
where each of R17 and R19 is one of a monovalent hydrocarbon group, a monovalent oxygen-containing hydrocarbon group, a halogenated group thereof, and a group obtained by bonding two or more thereof to one another; R18 is one of a divalent hydrocarbon group, a halogenated group thereof, a group obtained by bonding two or more thereof to one another, and a group including one or more of the foregoing groups and an ether bond; and n is an integer number equal to or more than 1, 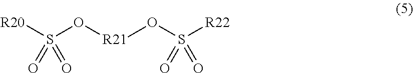
where each of R20 and R22 is one of a monovalent hydrocarbon group, a monovalent oxygen-containing hydrocarbon group, a halogenated group thereof, and a group obtained by bonding two or more thereof to one another; and R21 is one of a divalent hydrocarbon group, a halogenated group thereof, a group obtained by bonding two or more thereof to one another, and a group including one or more of the foregoing groups and an ether bond.
LiPF₂O₂ (6)
Li₂PFO₃ (7)

8. The secondary battery according to claim 7, wherein
the monovalent hydrocarbon group and the monovalent oxygen-containing hydrocarbon group include an alkyl group with carbon number from 1 to 12 both inclusive, an alkenyl group with carbon number from 2 to 12 both inclusive, an alkynyl group with carbon number from 2 to 12 both inclusive, an aryl group with carbon number from 6 to 18 both inclusive, a cycloalkyl group with carbon number from 3 to 18 both inclusive, and an alkoxy group with carbon number from 1 to 12 both inclusive,
the divalent hydrocarbon group includes an alkylene group with carbon number from 1 to 12 both inclusive, an alkenylene group with carbon number from 2 to 12 both inclusive, an alkynylene group with carbon number from 2 to 12 both inclusive, an arylene group with carbon number from 6 to 18 both inclusive, and a cycloalkylene group with carbon number from 3 to 18 both inclusive, and
the halogenated group includes one or more of a fluorine group, a chlorine group, a bromine group, and an iodine group.

9. The secondary battery according to claim 7, wherein
the dicarbonic ester compound is one or more of compounds represented by a following Formula (3-1) to a following Formula (3-12),
the dicarboxylic acid compound is one or more of compounds represented by a following Formula (4-1) to a following Formula (4-17), and
the disulfonic acid compound is one or more of compounds represented by a following Formula (5-1) to a following Formula (5-9).

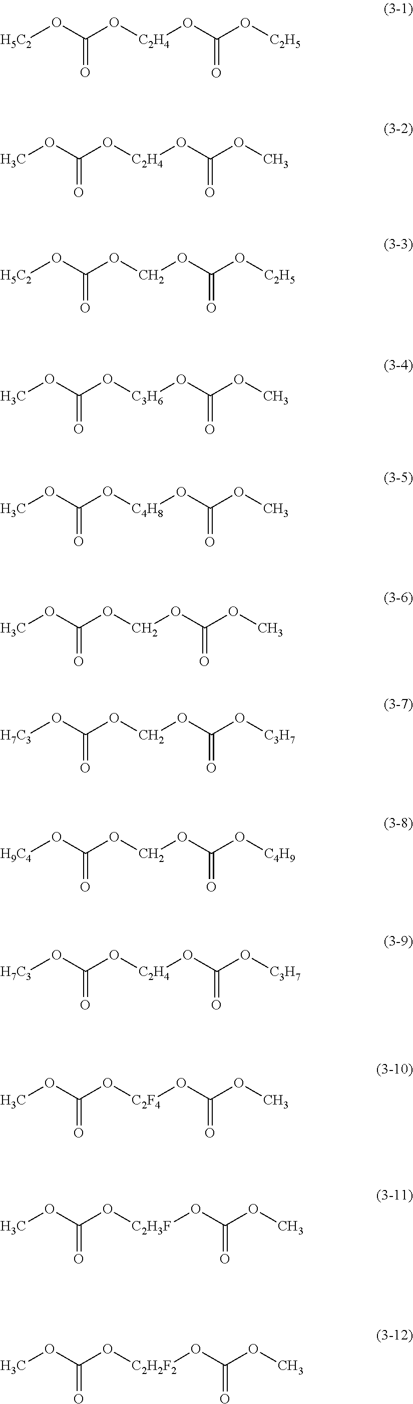

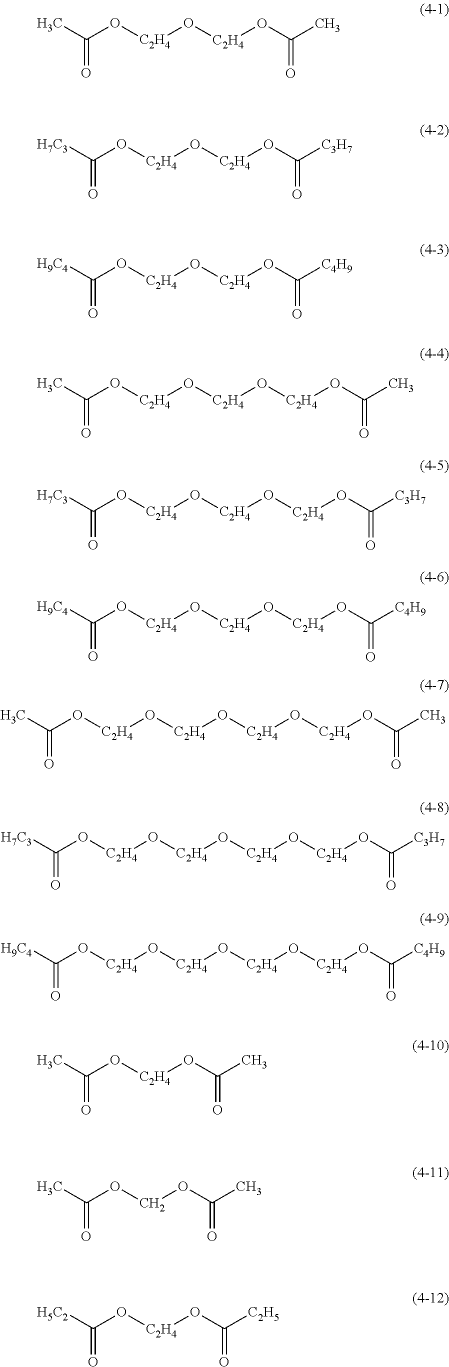

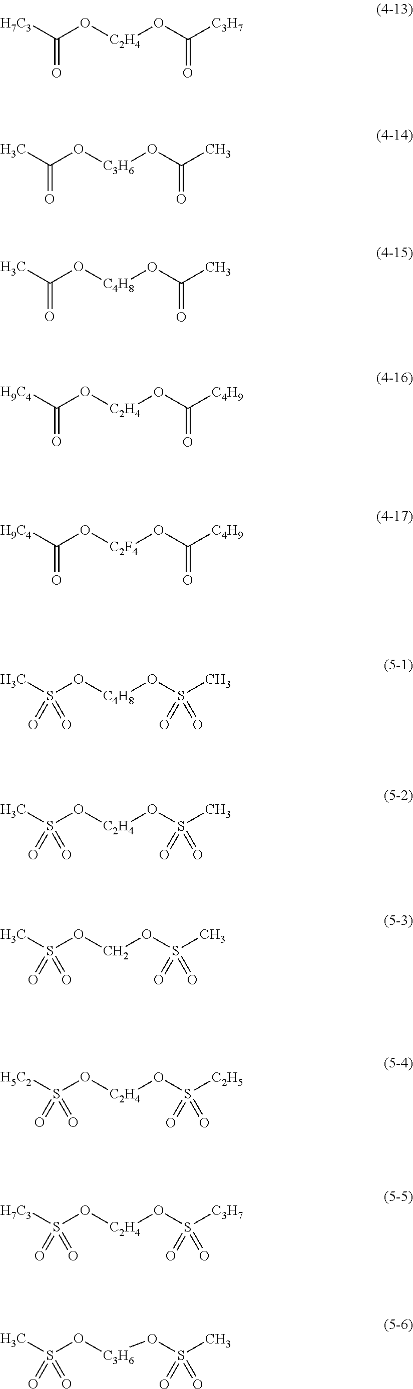

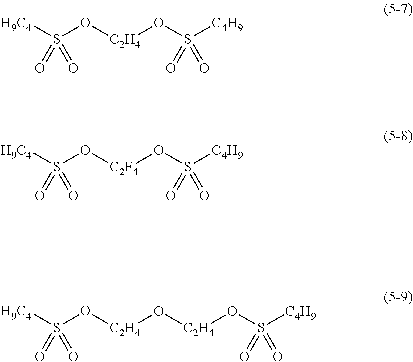

10. The secondary battery according to claim 7, wherein a content of the non-carbamate compound in the electrolytic solution is from about 0.001 weight percent to about 2 weight percent both inclusive.

11. The secondary battery according to claim 1, wherein the secondary battery is a lithium secondary battery.

12. The secondary battery according to claim 1, wherein
the electrolytic solution includes a halogenated ester carbonate,
the halogenated ester carbonate includes one or more of a cyclic halogenated ester carbonate represented by a following Formula (11) and a chain halogenated ester carbonate represented by Formula (12), and
where a content of the halogenated ester carbonate in the electrolytic solution is A (weight percent) and a content of the unsaturated cyclic carbamate compound in the electrolytic solution is B (weight percent), A is from about 0.01 weight percent to about 40 weight percent both inclusive, B is from about 0.01 weight percent to about 10 weight percent both inclusive, and B/A is from about 0.00025 to about 1000 both inclusive are satisfied, 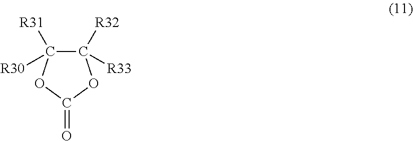
where each of R30 to R33 is one of a hydrogen group, a halogen group, an alkyl group, and a halogenated alkyl group; and one or more of R30 to R33 are each one of a halogen group and a halogenated alkyl group, 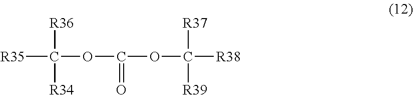
where each of R34 to R39 is one of a hydrogen group, a halogen group, an alkyl group, and a halogenated alkyl group; and one or more of R34 to R39 are each a halogen group or a halogenated alkyl group.

13. An electrolytic solution including an unsaturated cyclic carbamate compound represented by a following Formula (1), 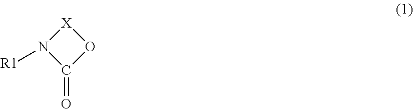
where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

14. A battery pack comprising:
a secondary battery;
a control section controlling a used state of the secondary battery; and
a switch section switching the used state of the secondary battery according to an instruction of the control section, wherein
the secondary battery includes a cathode, an anode, and an electrolytic solution, and
the electrolytic solution includes an unsaturated cyclic carbamate compound represented by a following Formula (1), 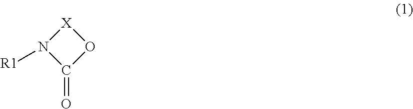
where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

15. An electric vehicle comprising:
a secondary battery;
a conversion section converting electric power supplied from the secondary battery into drive power;
a drive section operating according to the drive power; and
a control section controlling a used state of the secondary battery, wherein
the secondary battery includes a cathode, an anode, and an electrolytic solution, and
the electrolytic solution includes an unsaturated cyclic carbamate compound represented by a following Formula (1), 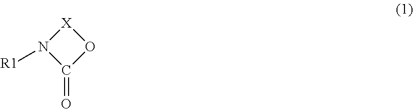
where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

16. An electric power storage system comprising:
a secondary battery;
one or more electric devices supplied with electric power from the secondary battery; and
a control section controlling the supplying of the electric power from the secondary battery to the one or more electric devices, wherein
the secondary battery includes a cathode, an anode, and an electrolytic solution, and
the electrolytic solution includes an unsaturated cyclic carbamate compound represented by a following Formula (1), 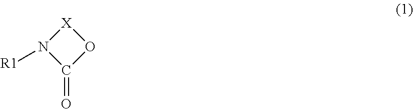
where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

17. An electric power tool comprising:
a secondary battery; and
a movable section being supplied with electric power from the secondary battery, wherein
the secondary battery includes a cathode, an anode, and an electrolytic solution, and
the electrolytic solution includes an unsaturated cyclic carbamate compound represented by a following Formula (1), 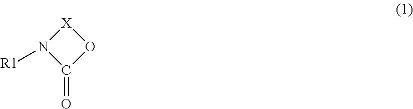
where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.

18. An electronic apparatus comprising a secondary battery as an electric power supply source, wherein
the secondary battery includes a cathode, an anode, and an electrolytic solution, and
the electrolytic solution includes an unsaturated cyclic carbamate compound represented by a following Formula (1), 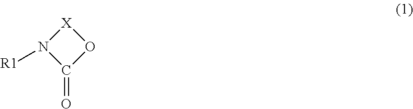
where X is a divalent group in which m-number of >C═CR2R3 and n-number of >CR4R5 are bonded in any order; m and n satisfy m≧1 and n≧0; each of R1 to R5 is one of a monovalent hydrocarbon group, a monovalent oxygen-containing hydrocarbon group, a halogenated group thereof, a monovalent group obtained by bonding two or more thereof to one another, a hydrogen group, and a halogen group; and any two or more of the R1 to the R5 are allowed to be bonded to one another.
